(19) United States
(12) Patent Application Publication
(10) Pub. No.: US 2024/0147541 A1
(43) Pub. Date: May 2, 2024

(54) RANDOM ACCESS PROCEDURES BASED ON PDCCH ORDER

(71) Applicant: Samsung Electronics Co., Ltd., Suwon-si (KR)

(72) Inventors: Emad Nader Farag, Flanders, NJ (US); Kyoungmin Park, Seoul (KR); Dalin Zhu, Allen, TX (US); Eko Onggosanusi, Coppell, TX (US)

(21) Appl. No.: 18/470,308

(22) Filed: Sep. 19, 2023

Related U.S. Application Data
(60) Provisional application No. 63/410,466, filed on Sep. 27, 2022.
(60) Provisional application No. 63/412,183, filed on Sep. 30, 2022.
(60) Provisional application No. 63/419,603, filed on Oct. 26, 2022.
(60) Provisional application No. 63/422,849, filed on Nov. 4, 2022.
(60) Provisional application No. 63/444,486, filed on Feb. 9, 2023.
(60) Provisional application No. 63/468,679, filed on May 24, 2023.
(60) Provisional application No. 63/522,066, filed on Jun. 20, 2023.
(60) Provisional application No. 63/523,842, filed on Jun. 28, 2023.
(60) Provisional application No. 63/531,163, filed on Aug. 7, 2023.

(51) Int. Cl. H04W 74/08; H04L 5/00; H04W 74/00

(52) U.S. Cl. CPC H04W 74/0833; H04L 5/0055; H04W 74/006

(57) ABSTRACT

A method of operating a user equipment includes receiving a physical random access channel (PRACH) configuration for a serving cell, receiving a PRACH configuration for N additional cells, and receiving a physical downlink control channel (PDCCH) order. The PDCCH order includes a field for a cell ID, and a field for a synchronization signal/physical broadcast channel (SS/PBCH) block index corresponding to the cell ID. The method further includes determining a value of the cell ID field in the PDCCH order, determining a PRACH configuration associated with the cell ID, transmitting a PRACH in a PRACH occasion associated with the SS/PBCH block index and the corresponding cell ID, and, if the value of the cell ID field is non-zero, determining a PRACH transmission power based on a SS/PBCH block associated with the SS/PBCH block index and the corresponding cell ID included in the PDCCH order.

### CROSS-REFERENCE TO RELATED APPLICATIONS AND CLAIM OF PRIORITY

This application claims priority under 35 U.S.C. § 119(e) to U.S. Provisional Patent Application No. 63/410,466 filed on Sep. 27, 2022; U.S. Provisional Patent Application No. 63/412,183 filed on Sep. 30, 2022; U.S. Provisional Patent Application No. 63/419,603 filed on Oct. 26, 2022; U.S. Provisional Patent Application No. 63/422,849 filed on Nov. 4, 2022; U.S. Provisional Patent Application No. 63/444,486 filed on Feb. 9, 2023; U.S. Provisional Patent Application No. 63/468,679 filed on May 24, 2023; U.S. Provisional Patent Application No. 63/522,066 filed on Jun. 20, 2023; U.S. Provisional Patent Application No. 63/523,842 filed on Jun. 28, 2023; and U.S. Provisional Patent Application No. 63/531,163 filed on Aug. 7, 2023. The above-identified provisional patent applications are hereby incorporated by reference in their entirety.

### TECHNICAL FIELD

This disclosure relates generally to wireless networks. More specifically, this disclosure relates to random access procedures based on a physical downlink control channel (PDCCH) order.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. 5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides methods and apparatuses for random access procedures based on a physical downlink control channel (PDCCH) order.

In a first embodiment, a user equipment (UE) is provided. The UE includes a transceiver configured to receive a physical random access channel (PRACH) configuration for a serving cell, receive a PRACH configuration for N additional cells, and receive a physical downlink control channel (PDCCH) order. The PDCCH order includes field for a cell identifier (ID), and a field for a synchronization signal/physical broadcast channel (SS/PBCH) block index corresponding to the cell ID. The UE further comprises a processor operably coupled to the transceiver. The processor is configured to determine value of the cell ID field in the PDCCH order and determine a PRACH configuration associated with the cell ID. The transceiver is further configured to transmit a PRACH in a PRACH occasion (RO) associated with the SS/PBCH block index and the cell ID. If the value of the cell ID field is non-zero, the processor is further configured to determine a PRACH transmission power based on a SS/PBCH block associated with the SS/PBCH block index and the corresponding cell ID included in the PDCCH order.

In another embodiment, a base station (BS) is provided. The BS includes a transceiver configured to transmit a PRACH configuration for a serving cell, transmit a PRACH configuration for N additional cells, and transmit a PDCCH order. The PDCCH order includes a field for a cell ID, and a field for a SS/PBCH block index corresponding to the cell ID. The BS further includes a processor operatively coupled to the transceiver. The processor is configured to determine a value of the cell ID field in the PDCCH order, and determine a PRACH configuration associated with the cell ID. The transceiver is further configured to receive a PRACH in a RO associated with a SS/PBCH index and a corresponding cell ID. If the value of the cell ID field is non-zero, a PRACH transmission power is based on a SS/PBCH block associated with the SS/PBCH block index and the corresponding cell ID value included in the PDCCH order.

In yet another embodiment, a method of operating a UE is provided. The method includes receiving a PRACH configuration for a serving cell, receiving a PRACH configuration for N additional cells, and receiving a PDCCH order. The PDCCH order includes field for a cell ID, and a field for a SS/PBCH block index corresponding to the cell ID. The method further includes determining a value of the cell ID field in the PDCCH order, determining a PRACH configuration associated with the cell ID, transmitting a PRACH in a RO associated with the SS/PBCH block index and the corresponding cell ID. If the value of the cell ID field is non-zero, the method further includes determining a PRACH transmission power based on a SS/PBCH block associated with the SS/PBCH block index and the corresponding cell ID included in the PDCCH order.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to this disclosure;

FIG. 3A illustrates an example UE according to embodiments of the present disclosure;

FIG. 3B illustrates an example gNB according to embodiments of the present disclosure;

FIG. 4 illustrates an example an OFDM symbol with a CP appended to the front according to embodiments of the present disclosure;

FIG. 5 illustrates an example of PUSCH or PUCCH arrival aligned to a base station reference timing according to embodiments of the present disclosure;

FIG. 6A-6B illustrate examples of wireless system beams according to embodiments of the present disclosure;

FIG. 7 illustrates an example of antenna blocks or arrays according to embodiments of the present disclosure;

FIG. 8 illustrates an example MAC RAR according to embodiments of the present disclosure;

FIG. 9 illustrates an example success RAR according to embodiments of the present disclosure;

FIG. 10 illustrates an example Timing Advance Command MAC CE according to embodiments of the present disclosure;

FIG. 11 illustrates an example Absolute Timing Advance Command MAC CE according to embodiments of the present disclosure;

FIG. 12 illustrates an example of a Type-1 random access procedure according to embodiments of the present disclosure;

FIG. 13 illustrates an example of a Type-2 random access procedure according to embodiments of the present disclosure;

FIGS. 14A-14B illustrate examples of a UE communicating with a first TRP and a second TRP according to embodiments of the present disclosure;

FIG. 15 illustrates an example a first TRP and a second TRP being synchronized according to embodiments of the present disclosure;

FIG. 16 illustrates an example of a first TRP and a second TRP having asynchronous reference times according to embodiments of the present disclosure;

FIG. 17 illustrates an example of a first TRP and a second TRP having asynchronous reference times according to embodiments of the present disclosure;

FIG. 18 illustrates an example of a UE configured an association of SSBs with TA groups according to embodiments of the present disclosure;

FIG. 19 illustrates an example of a TA group having L entities according to embodiments of the present disclosure;

FIG. 20 illustrates an example of L entities, and K TA groups according to embodiments of the present disclosure;

FIG. 21 illustrates an example of L entities, and K TA groups according to embodiments of the present disclosure;

FIG. 22 illustrates an example of a TA group having L entities according to embodiments of the present disclosure;

FIG. 23 illustrates an example of L entities, and K TA groups according to embodiments of the present disclosure;

FIG. 24 illustrates an example of L entities, and K TA groups according to embodiments of the present disclosure

FIG. 25 illustrates an example of a PDCCH order triggered CFRA procedure according to embodiments of the present disclosure;

FIG. 26 illustrates an example of preamble transmission according to embodiments of the present disclosure;

FIG. 27 illustrates an example of preamble transmission according to embodiments of the present disclosure;

FIG. 28 illustrates an example of preamble transmission according to embodiments of the present disclosure;

FIG. 29 illustrates an example of a DMRS antenna port of a PDCCH of a RAR having the same antenna port quasi co-location properties as the DMRS antenna port of a PDCCH of a PDCCH order according to embodiments of the present disclosure;

FIG. 30 illustrates an example where a DMRS antenna port of a PDCCH of a RAR is quasi-co-located with an SSB according to embodiments of the present disclosure;

FIG. 31 illustrates a higher-layer triggered CFRA procedure according to embodiments of the present disclosure;

FIG. 32 illustrates an example of a PDCCH order triggered CBRA procedure according to embodiments of the present disclosure;

FIG. 33 illustrates a higher-layer triggered CBRA procedure according to embodiments of the present disclosure; and

FIG. 34 illustrates a method performed by a UE according to embodiments of the present disclosure.

### DETAILED DESCRIPTION

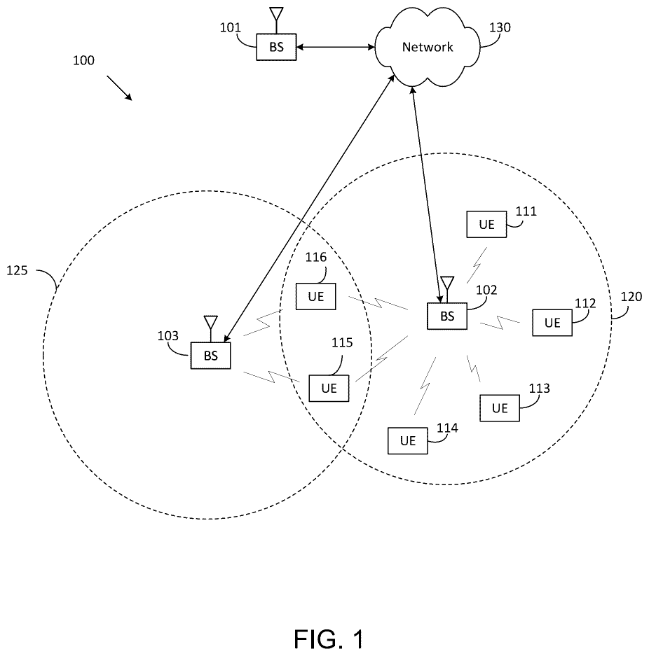

FIGS. 1 through 34, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for random access procedures based on PDCCH order. In certain embodiments, one or more of the gNBs 101-103 includes circuitry, programing, or a combination thereof, to support random access procedures based on PDCCH order.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

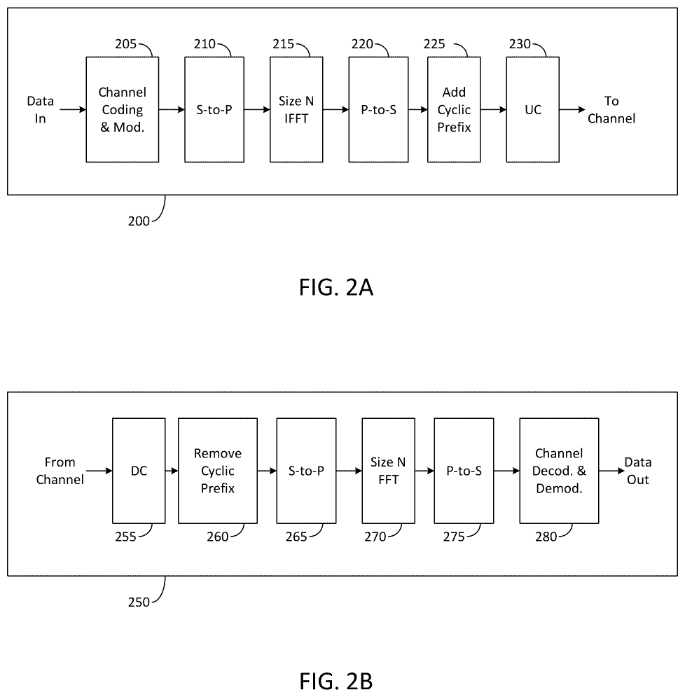

FIGS. 2A and 2B illustrate example wireless transmit and receive paths according to this disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support random access procedures based on PDCCH order as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

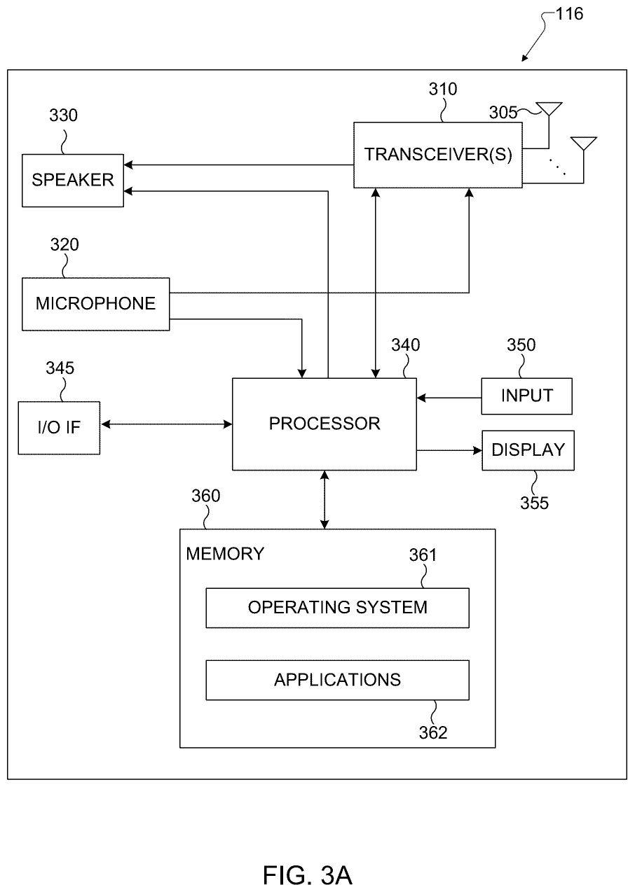

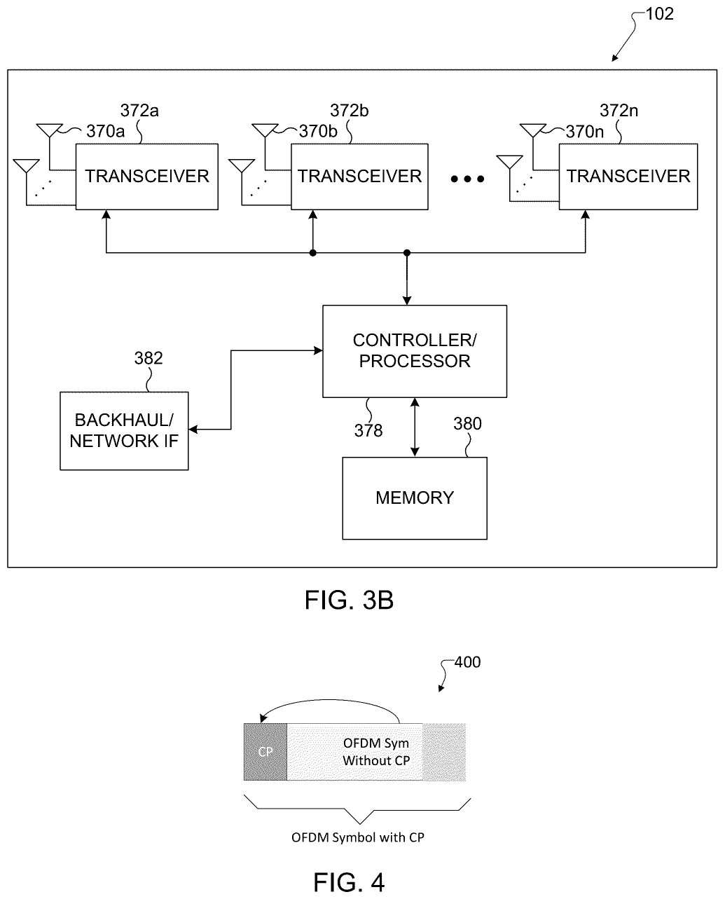

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for random access procedures based on PDCCH order as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of UL channel signals and the transmission of DL channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support random access procedures based on PDCCH order as discussed in greater detail below. The controller/processor 225 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The following documents and standards descriptions are hereby incorporated into the present disclosure as if fully set forth herein:
[1] 3GPP TS 38.211 v17.5.0, “NR; Physical channels and modulation.”
[2] 3GPP TS 38.212 v17.5.0, “NR; Multiplexing and Channel coding.”
[3] 3GPP TS 38.213 v17.6.0, “NR; Physical Layer Procedures for Control.”
[4] 3GPP TS 38.214 v17.6.0, “NR; Physical Layer Procedures for Data.”
[5] 3GPP TS 38.321 v17.5.0, “NR; Medium Access Control (MAC) protocol specification.”
[6] 3GPP TS 38.331 v17.5.0, “NR; Radio Resource Control (RRC) Protocol Specification.”
[7] 3GPP RP-202024, “Revised WID: Further enhancements on MIMO for NR”.
[8] 3GPP RP-213598, “MIMO Evolution for Downlink and Uplink”.

A time unit for DL signaling, for UL signaling, on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems (see also REF 1).

NR uses CP-OFDM and DTF-s-OFDM waveforms for uplink transmissions [1], i.e., for Physical Uplink Shared Channel (PUSCH) and Physical Uplink Control Channel (PUCCH). Both waveforms include a (Cyclic Prefix) CP appended to the front of each symbol as illustrated in FIG. 4.

FIG. 4 illustrates an example 400 an OFDM symbol with a CP appended to the front according to embodiments of the present disclosure. The example OFDM symbol with a CP appended to the front of FIG. 4 is for illustration only. Different embodiments of an OFDM symbol with a CP appended to the front could be used without departing from the scope of this disclosure.

Although FIG. 4 illustrates an example 400 an OFDM symbol with a CP appended to the front, various changes may be made to FIG. 4. For example, various changes to the length of the OFDM symbol and the length of the CP could be made according to particular needs.

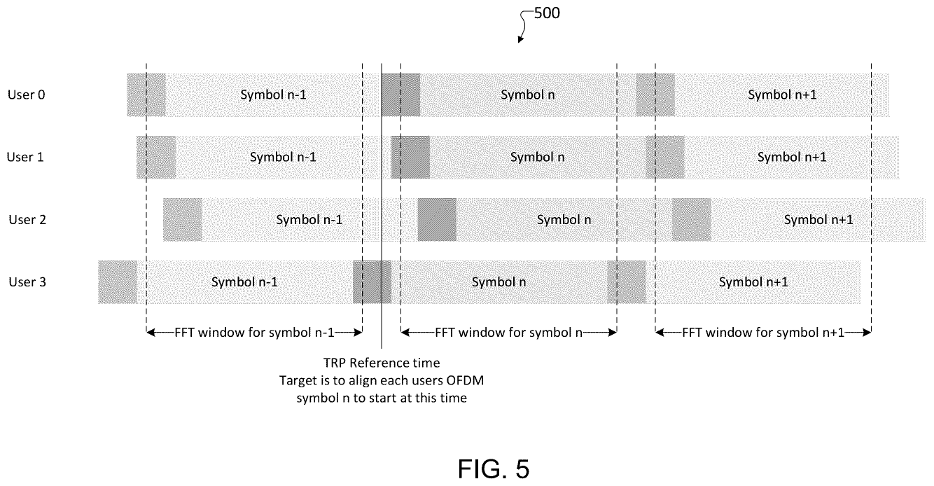

The CP is the last few samples of the OFDM symbol appended to the front of the symbol. The base station estimates the round-trip-time between the UE and the base station, for example this can be initially estimated using the PRACH channel during random access, the base station signals a time advance (TA) command to advance the UE's uplink transmission time by a duration equivalent to the round-trip-delay such that an uplink transmission from the UE, e.g. PUSCH or PUCCH arrives aligned to the base station reference timing as illustrated in FIG. 5.

FIG. 5 illustrates an example 500 of PUSCH or PUCCH arrival aligned to a base station reference timing according to embodiments of the present disclosure. The example of PUSCH or PUCCH arrival aligned to a base station reference timing of FIG. 5 is for illustration only. Different embodiments of PUSCH or PUCCH arrival aligned to a base station reference timing could be used without departing from the scope of this disclosure.

In the example of FIG. 5, all users are synchronized to the same reference time; this retains orthogonality between users. In the example of FIG. 5, user's 0 start time for symbol n, for example symbol n can correspond to symbol zero of a radio frame, is exactly aligned to the reference time of the base station. For user 1, the start time of symbol n is slightly delayed from the base station's reference time. For user 2, the start time of symbol n is delayed even more from the base station's reference time this can be for example due to a time alignment error. For user 3, the start time of symbol n is advanced by a large duration from the base station's reference time, this can for example due to a time alignment error.

The first stage of a NR baseband receiver is the removal of the CP followed by a Fast Fourier Transform (FFT) operator that converts the OFDM symbol from time domain to frequency domain. An example of the FFT window is illustrated in FIG. 5. In this example the FFT window of symbol n starts CP/2 after the base station's reference time, where CP is the duration of the cyclic prefix, the duration of the FFT window is large enough to include all the samples required for FFT operation. Note that in this example, as the FFT window is starting halfway through the CP rather than at the end of the CP, a time adjustment of CP/2 can be done in frequency domain (after the FFT) to compensate the CP/2 offset. If the user's misalignment is within the CP range, i.e., in the range of [−CP/2, CP/2] for the example illustrated in FIG. 5, the signal of user i is cyclically delayed by τᵢ, as long as τᵢ is within the CP range. For example, user 1 is delayed by τ₁<CP/2, hence within the FFT window of symbol n all the samples belong to symbol n, there is no inter-symbol interference in this case. The delay τᵢ when within the CP range is converted into a phasor after the FFT and can be easily estimated and compensated. If τᵢ is greater than the CP range, inter symbol interference can occur, as illustrated in FIG. 5 for users 2 and 3. For user 2, τ₂ exceeds CP/2, hence in the FFT window of symbol n, there are samples from symbol n−1 leading to inter-symbol interference and thus degrading performance. For user 3, τ₃ is less than CP/2, hence in the FFT window of symbol n, there are samples from symbol n+1 leading to inter-symbol interference and thus degrading performance.

Although FIG. 5 illustrates an example 500 of PUSCH or PUCCH arrival aligned to a base station reference timing, various changes may be made to FIG. 5. For example, various changes to the length of the symbols, the number of symbols, the size of the FFT windows, etc. could be made according to particular needs.

In the present disclosure, a beam is determined by either of;
a TCI state, that establishes a quasi-colocation (QCL) relationship between a source reference signal (e.g., SSB and/or CSI-RS) and a target reference signal, or
a spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE; or a spatial Tx filter for transmission of downlink channels from the gNB or a spatial Rx filter for reception of uplink channels at the gNB.

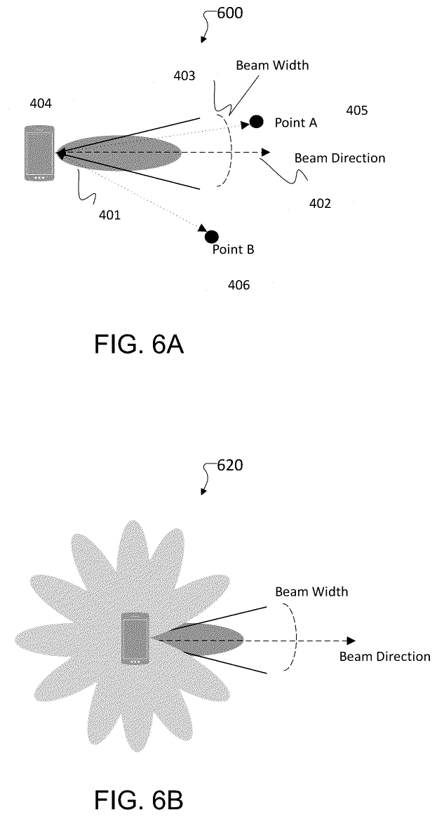

FIGS. 6A-6B illustrate examples 600 and 620 of wireless system beams according to embodiments of the present disclosure. The examples of wireless system beams of FIGS. 6A-6B are for illustration only. Different embodiments of wireless system beams could be used without departing from the scope of this disclosure.

As illustrated in FIG. 6A, in a wireless system a beam (401), for a device (404), can be characterized by a beam direction (402) and a beam width (403). For example, a device (404) transmits radio frequency (RF) energy in a beam direction and within a beam width. A device (404) receives RF energy in a beam direction and within a beam width. As illustrated in FIG. 6A, a device at point A (405) can receive from and transmit to device (404) as Point A is within a beam width and direction of a beam from device (404). As illustrated in FIG. 6A, a device at point B (406) cannot receive from and transmit to device (404) as Point B is outside a beam width and direction of a beam from device (404). While FIG. 6A, for illustrative purposes, shows a beam in 2-dimensions (2D), it should be apparent to those skilled in the art, that a beam can be in 3-dimensions (3D), where the beam direction and beam width are defined in space.

In a wireless system, a device can transmit and/or receive on multiple beams. This is known as “multi-beam operation” and is illustrated in FIG. 6B. While FIG. 6B, for illustrative purposes, a beam is in 2D, it should be apparent to those skilled in the art, that a beam can be 3D, where a beam can be transmitted to or received from any direction in space.

Although FIGS. 6A-6B illustrates examples 600 and 620 of PUSCH or PUCCH arrival aligned to a base station reference timing, various changes may be made to FIGS. 6A-6B. For example, various changes to the dimensions of the beams, the directions of the beams, etc. could be made according to particular needs.

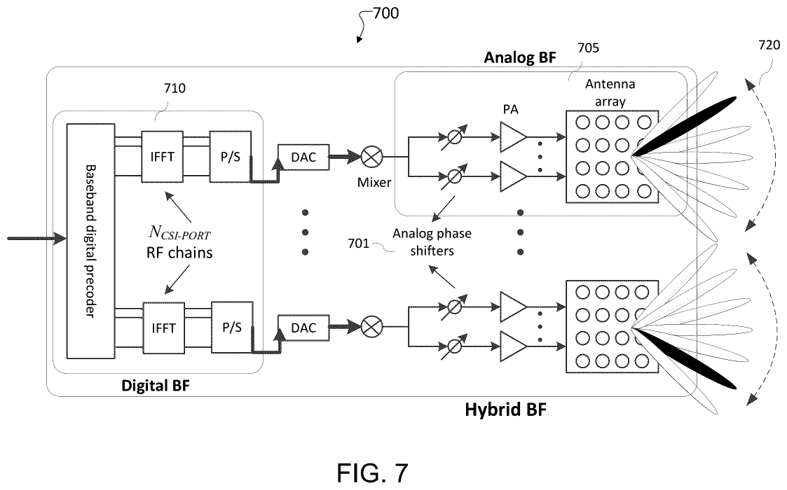

FIG. 7 illustrates an example of antenna blocks or arrays 700 according to embodiments of the present disclosure. The embodiment of the antenna blocks or arrays 700 illustrated in FIG. 7 is for illustration only. Different embodiments of antenna blocks or arrays 700 could be used without departing from the scope of this disclosure.

Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of ADCs/DACs at mmWave frequencies) as illustrated in FIG. 7. Then, one CSI-RS port can be mapped onto a large number of antenna elements that can be controlled by a bank of analog phase shifters 701. One CSI-RS port can then correspond to one sub-array which produces a narrow analog beam through analog beamforming 705. This analog beam can be configured to sweep across a wider range of angles (720) by varying the phase shifter bank across symbols or slots/subframes. The number of sub-arrays (equal to the number of RF chains) is same as the number of CSI-RS ports N_{CSI-PORT}. A digital beamforming unit 710 performs a linear combination across N_{CSI PORT} analog beams to further increase a precoding gain. While analog beams are wideband (hence not frequency-selective), digital precoding can be varied across frequency sub-bands or resource blocks. Receiver operation can be conceived analogously.

Although FIG. 7 illustrates one example of example antenna blocks or arrays 700, various changes may be made to FIG. 7. For example, the example antenna blocks or arrays 700 could include any number of each component shown in FIG. 7. Also, various components in FIG. 7 could be combined, further subdivided, or omitted and additional components could be added according to particular needs.

Since the above system utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence larger number of radiators in the array) are needed to compensate for the additional path loss.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH and CSI-RS, wherein the TCI state provides a reference signal for the quasi co-location for DM-RS of PDSCH and DM-RS of PDCCH in a CC and CSI-RS when following the unified TCI state. The unified (master or main or indicated) TCI state is TCI state of UE-dedicated reception on dynamic-grant/configured-grant based PUSCH and all of PUCCH resources and SRS, wherein the TCI state provides UL TX spatial filter for dynamic-grant and configured-grant based PUSCH and PUCCH resource in a CC, and SRS when following the unified TCI state.

The unified TCI framework applies to intra-cell beam management, wherein, the TCI states have a source RS that is directly or indirectly associated, through a quasi-co-location relation, e.g., spatial relation, with an SSB of a serving cell. The unified TCI state framework also applies to inter-cell beam management, wherein a TCI state can have a source RS that is directly or indirectly associated, through a quasi-co-location relation, e.g., spatial relation, with an SSB of cell that has a PCI different from the PCI of the serving cell.

Quasi-co-location (QCL) relation, can be quasi-location with respect to one or more of the following relations:
Type A, {Doppler shift, Doppler spread, average delay, delay spread}
Type B, {Doppler shift, Doppler spread}
Type C, {Doppler shift, average delay}
Type D, {Spatial Rx parameter}

The unified (master or main or indicated) TCI state applies at least to UE dedicated DL and UL channels. The unified (master or main) TCI can also apply to other DL and/or UL channels and/or signals e.g., non-UE dedicated channel and sounding reference signal (SRS).

In this disclosure we propose schemes to determine the TA (time alignment or time advance) of a cell having a PCI different from the PCI of the serving cell. The TA is used by the UE for an uplink transmission when communicating with the network. The TA is determined in part based on the round-trip-time between the UE and the TRP the UE is communicating with. Therefore, if the UE is at a different distance from each TRP, it can have a different TA when communicating with each TRP.

In addition, quasi-co-location relation can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

A UL or joint TCI state can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main) TCI can also apply to other DL and/or UL channels and/or signals e.g., non-UE dedicated channel, CSI_RS and sounding reference signal (SRS).

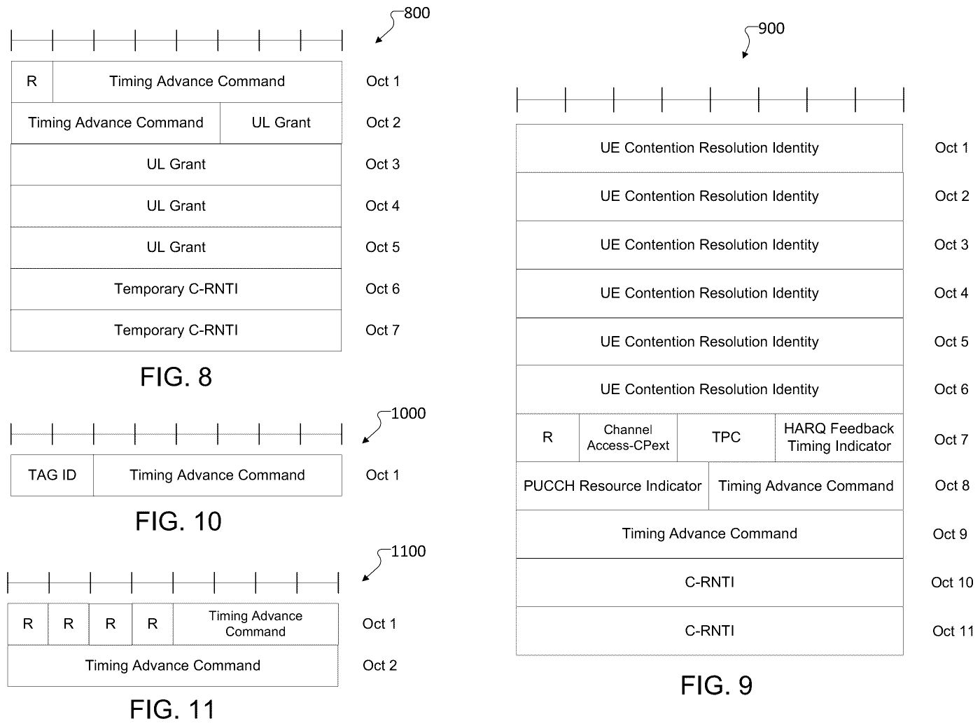

In NR, the round trip time can be indicated by:
A random access response (RAR) of a Type 1 random access procedure or MSGB response of a Type 2 random access procedure, the value signaled is a 12-bit “Timing Advance Command” value in range 0 . . . 3846. The TA offset N_{TA} in units of T_{c} (wherein T_{c}=1/(Δfₘₐₓ−N_{f}), where Δfₘₐₓ=480 kHz and N_{f}=4096) is calculated as

$${N}_{TA} = \frac{{T}_{A} \cdot 16 \cdot 64}{{2}^{μ}}$$

Wherein, μ is the sub-carrier spacing configuration.
The MAC RAR (for Type 1 random access procedure) includes the 12-bit Timing Advance command is as illustrated in FIG. 8.

FIG. 8 illustrates an example 800 of a MAC RAR according to embodiments of the present disclosure. The embodiment of a MAC RAR of FIG. 8 is for illustration only. Different embodiments of a MAC RAR could be used without departing from the scope of this disclosure.

Although FIG. 8 illustrates an example 800 of a MAC RAR, various changes may be made to FIG. 8. For example, various changes to the timing advance command, etc. could be made according to particular needs.

The fallback RAR (for Type 2 random access procedure), which is used when MSGA PRACH is successfully received but MSGA PUSCH is not decoded correctly, includes the 12-bit Timing Advance command is as illustrated in FIG. 8.

The success RAR (for Type 2 random access procedure), which is used when MSGA PRACH is successfully received and MSGA PUSCH is decoded correctly, includes the 12-bit Timing Advance command is as illustrated in FIG. 9.

FIG. 9 illustrates an example 900 of a success RAR according to embodiments of the present disclosure. The embodiment of the success RAR of FIG. 9 is for illustration only. Different embodiments of a success RAR could be used without departing from the scope of this disclosure.

Although FIG. 9 illustrates an example 900 of a success RAR, various changes may be made to FIG. 9. For example, various changes to the timing advance command, etc. could be made according to particular needs.

The Timing Advance Command MAC CE includes the 6-bit Timing Advance Command is as illustrated in FIG. 10, also included is the associated TAG-ID.

FIG. 10 illustrates an example 1000 of a Timing Advance Command MAC CE according to embodiments of the present disclosure. The embodiment of the MAC CE of FIG. 10 is for illustration only. Different embodiments of a MAC CE could be used without departing from the scope of this disclosure.

Although FIG. 10 illustrates an example 1000 of a Timing Advance Command MAC CE, various changes may be made to FIG. 10. For example, various changes to the timing advance command, the TAG ID, etc. could be made according to particular needs.

The absolute timing advance can also be indicated by an absolute timing advance MAC, wherein the value signaled is a 12-bit “Timing Advance Command” (T_{A}). The TA offset N_{TA} in units of T_{c} (wherein T_{c}=1/(Δfₘₐₓ−N_{f}), where Δfₘₐₓ=480 kHz and N_{f}=4096) is calculated as

$${N}_{TA} = \frac{{T}_{A} \cdot 16 \cdot 64}{{2}^{μ}}$$

Wherein, μ is the sub-carrier spacing configuration.

The Absolute Timing Advance Command MAC CE includes the 12-bit Timing Advance Command is as illustrated in FIG. 11, also included is the associated TAG-ID.

FIG. 11 illustrates an example 1100 of an Absolute Timing Advance Command MAC CE according to embodiments of the present disclosure. The embodiment of the MAC CE of FIG. 11 is for illustration only. Different embodiments of a MAC CE could be used without departing from the scope of this disclosure.

Although FIG. 11 illustrates an example 1100 of an Absolute Timing Advance Command MAC CE, various changes may be made to FIG. 11. For example, various changes to the timing advance command, etc. could be made according to particular needs.

NR supports four different sequence length for random access preamble sequence:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in PRACH Occasions (ROs). Each RO determines the time and frequency resources in which a preamble is transmitted, the resources allocated to an RO in the frequency domain (e.g., number of PRBs) and the resource allocated to an RO in the time domain (e.g., number of OFDMA symbols or number of slots), depend or the preamble sequence length, sub-carrier spacing of the preamble, sub-carrier spacing of the PUSCH in the UL BWP, and the preamble format. Multiple PRACH Occasions can be FDMed in one time instance. This is provided by higher layer parameter msg1-FDM. The time instances of the PRACH Occasions are determined by the higher layer parameter prach-ConfigurationIndex.

SSBs are associated with ROs. The number of SSBs associated with one RO can be provided by higher layer parameters such as ssb-perRACH-OccasionAndCB-PreamblesPerSSB and ssb-perRACH-Occasion. The number of SSBs per RO can be {1/8,1/4,1/2,1,2,4,8,16}. When the number of SSBs per RO is less than 1, multiple ROs are associated with the same SSB. SS/PBCH block indexes provided by ssb-PositionsInBurst in SIB1 or in ServingCellConfigCommon are mapped to valid PRACH occasions in the following order:
first, in increasing order of preamble indexes within a single PRACH occasion.
second, in increasing order of frequency resource indexes for frequency multiplexed PRACH occasions.
third, in increasing order of time resource indexes for time multiplexed PRACH occasions within a PRACH slot.
fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, type-1 random access procedure and type-2 random access procedure.

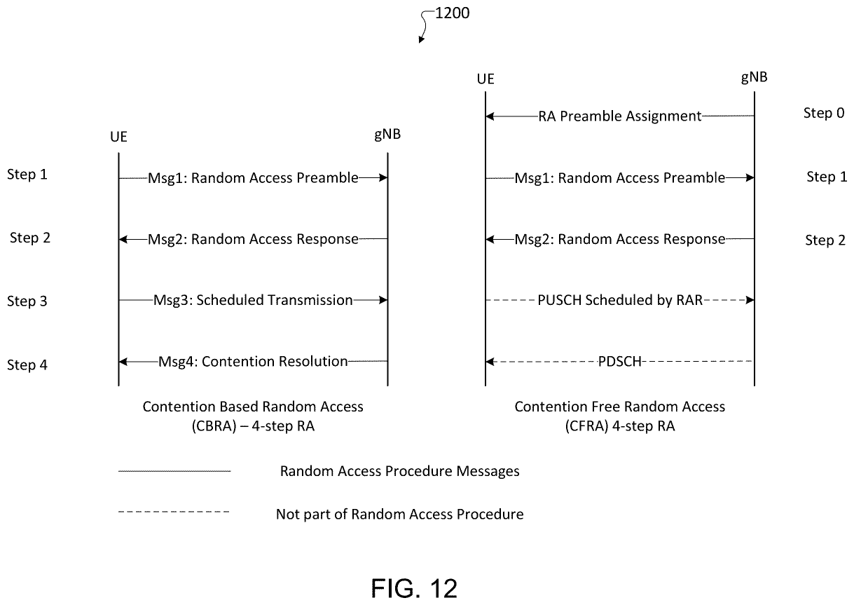

Type-1 random access procedure also known as four-step random access procedure (4-step RACH), is as illustrated in FIG. 12.

FIG. 12 illustrates an example 1200 of a Type-1 random access procedure according to embodiments of the present disclosure. The embodiment of the random access procedure of FIG. 12 is for illustration only. Different embodiments of a random access procedure could be used without departing from the scope of this disclosure.

As illustrated in the example of FIG. 12, the random access procedure beings at step 1. At step 1, the UE transmits a random access preamble, also known as Msg1, to the gNB. The gNB attempts to receive and detect the preamble. At step 2, the gNB upon receiving the preamble transmits a random access response (RAR), also known as Msg2, to the UE including, among other fields, a time adjustment (TA) command and an uplink grant for a subsequent PUSCH transmission. At step 3, the UE after receiving the RAR, transmits a PUSCH transmission scheduled by the grant of the RAR, and time adjusted according to the TA received in the RAR. Msg3 or the PUSCH scheduled by the RAR UL grant can include the RRC reconfiguration complete message. At step 4, the gNB upon receiving the RRC reconfiguration complete message, allocates downlink and uplink resources that are transmitted in a downlink PDSCH transmission to the UE. After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

Although FIG. 12 illustrates one example 1200 of a Type-1 random access procedure, various changes may be made to FIG. 12. For example, while shown as a series of steps, various steps in FIG. 12 could overlap, occur in parallel, occur in a different order, or occur any number of times.

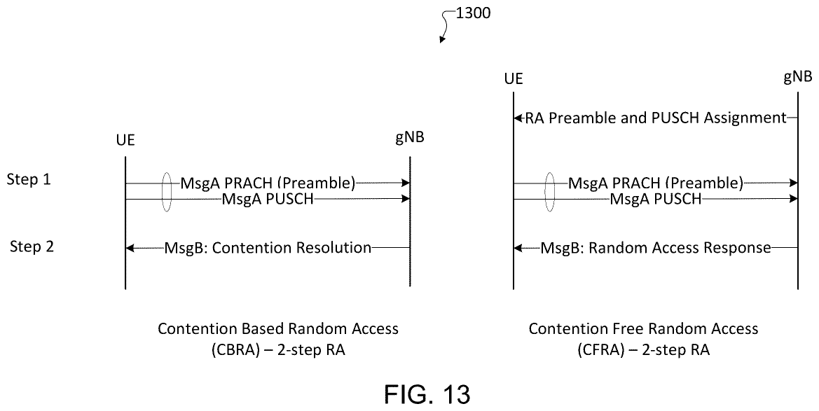

Release 16 introduced a new random access procedure; Type-2 random access procedure, also known as 2-step random access procedure (2-step RACH), as illustrated in FIG. 13.

FIG. 13 illustrates an example 1300 of a Type-2 random access procedure according to embodiments of the present disclosure. The embodiment of the random access procedure of FIG. 13 is for illustration only. Different embodiments of a random access procedure could be used without departing from the scope of this disclosure.

In the example of FIG. 13, the Type-2 random access procedure combines the preamble and PUSCH transmission into a single transmission from the UE to the gNB, which is known as MsgA. Similarly, the RAR and the PDSCH transmission (e.g., Msg4) are combined into a single downlink transmission from the gNB to the UE, which is known as MsgB.

Although FIG. 13 illustrates one example 1300 of a Type-2 random access procedure, various changes may be made to FIG. 13. For example, while shown as a series of steps, various steps in FIG. 13 could overlap, occur in parallel, occur in a different order, or occur any number of times.

A random access procedure can be triggered by a PDCCH order. The PDCCH order is triggered by DCI Format 1_0 with CRC scrambled by C-RNTI and the “Frequency domain resource assignment” field is set to all ones. The fields of DCI format 10 carrying the PDCCH order are interrupted as follows in TABLE 1:

TABLE 1

| Field | Size | | Description |
|---|---|---|---|
| Identifier for DCI formats | 1 | | The value of this bit field is |
| | | | always set to 1, indicating a DL |
| | | | DCI format |
| Frequency domain resource | ┌log₂(N_{RB}^{DL, BWP}(N_{RB}^{DL, BWP} + | | Set to all ones |
| assignment | 1)/2)┐ | | |
| Random Access Preamble index | 6 | bits | |
| UL/SUL indicator | 1 | bit | |
| SS/PBCH index | 6 | bits | If “Random Access Preamble index” |
| | | | is not zero indicates SSB index of RO |
| | | | used, else this field is reserved |
| PRACH Mask index | 4 | bits | If “Random Access Preamble index” |
| | | | is not zero indicates RO used, else |
| | | | this field is reserved |

| | |
|---|---|
| Reserved bits | 12 bits or 10 bits |

If “Random Access Preamble index” is not zero, the PDCCH order triggers a contention free random access preamble, wherein the PRACH Occasion is determined based on the “SS/PBCH index” indicated in the PDCCH order and the “PRACH Mask index” indicated in the PRACH Occasion associated with the SS/PBCH indicated by “SS/PBCH index”. The “Random Access Preamble index” indicates the preamble index to use in the PRACH Occasion.

If a PRACH transmission from a UE is in response to a detection of a PDCCH order by the UE that triggers a contention-free random access procedure, the preamble can be transmitted based on the SSB that the DL RS that the DM-RS of the PDCCH order is quasi-collocated with.

If the UE attempts to detect the DCI format 1_0 with CRC scrambled by the corresponding RA-RNTI in response to a PRACH transmission initiated by a PDCCH order that triggers a contention-free random access procedure for the SpCell, the UE may assume that the PDCCH that includes the DCI format 1_0 and the PDCCH order have same DM-RS antenna port quasi co-location properties. When receiving a PDSCH scheduled with RA-RNTI in response to a random access procedure triggered by a PDCCH order which triggers contention-free random access procedure for the SpCell, the UE may assume that the DM-RS port of the received PDCCH order and the DM-RS ports of the corresponding PDSCH scheduled with RA-RNTI are quasi co-located with the same SS/PBCH block or CSI-RS with respect to Doppler shift, Doppler spread, average delay, delay spread, spatial RX parameters when applicable.

If the UE attempts to detect the DCI format 1_0 with CRC scrambled by the corresponding RA-RNTI in response to a PRACH transmission initiated by a PDCCH order that triggers a contention-free random access procedure for a secondary cell, the UE may assume the DM-RS antenna port quasi co-location properties of the CORESET associated with the Type1-PDCCH CSS set for receiving the PDCCH that includes the DCI format 1_0.

If “Random Access Preamble index” is zero, the PDCCH order triggers a contention based random access procedure. If a PRACH transmission from a UE is in response to a detection of a PDCCH order by the UE that triggers a contention-based random access procedure, the UE can determine a SSB for the preamble transmission and select a preamble in a PRACH occasion corresponding to the SSB. If the UE attempts to detect the DCI format 1_0 with CRC scrambled by the corresponding RA-RNTI in response to a PRACH transmission initiated by a PDCCH order that triggers a contention-free random access procedure, the UE may assume same DM-RS antenna port quasi co-location properties for PDCCH and PDSCH, as for a SS/PBCH block or a CSI-RS resource the UE used for PRACH association.

In this disclosure we consider schemes to determine multiple TAs (e.g., 2 TAs) using a random access procedure for inter-cell multi-TRP scenario. The random access procedure can be:
Contention-free random access (CFRA) procedure triggered by a PDCCH order.
Contention-free random access (CFRA) procedure triggered by higher layers (e.g., UE triggered).
Contention-based random access (CBRA) procedure triggered by a PDCCH order.
Contention-based random access (CBRA) procedure triggered by higher layers (e.g., UE triggered).

A UE may be communicating with the network through two or more spatial relation filters for transmission and receptions, which in this disclosure are referred to as beams. The beams are determined by a TCI state, for example, a joint TCI state for UL and DL beams, or a DL TCI state for DL beams or a UL TCI state UL beams. The beams can be associated with a single TRP, alternatively, the beams can be associated with multiple (two or more) TRPs, wherein the TRPs can have a same physical cell identity (PCI) (i.e., transmitting SSBs associated with the same PCI), or can have different PCIs (i.e., transmitting SSBs associated with different PCIs). The round trip propagation delay, or round trip propagation time (RTT) on each beam can be different. For example, this can be due to different propagation paths due to different reflections and/or due to different distances between the UE and the TRPs. As described earlier, the UL signal from the UE should arrive at each TRP as its reference time, as a result the transmission on each beam (e.g., to a corresponding TRP) would have a different transmission time, and hence a different TA value to arrive at the corresponding TRP at that TRP's reference time.

Aspects covered in this disclosure include:
UE indication of the timing difference between RS of serving and non-serving cells.
   This allows network to trigger RACH PDCCH order towards non-serving cell
   The RS used can be (source RS in configured TCI states, source RS in activated TCI state, configured measurement RS, measurement RS in measurement report).
UE triggered RACH procedure towards non-serving cell based on measurement of time difference between RS of serving and non-serving cells
   The RS used can be (source RS in configured TCI states, source RS in activated TCI state, configured measurement RS, measurement RS in measurement report).

This can lead to early measurement of the TA of the non-serving cell, and hence will help to reduce the handover latency. In this disclosure, a non-serving cell can refer to a cell with a physical cell identity (PCI) different from the PCI of the serving cell for example a non-serving cell can have a PCI determined based on additionalPCIIndex. In this disclosure, a non-serving cell can refer to a target cell or a candidate cell (e.g., a target cell or a candidate cell for cell switch or handover).

The present disclosure also considers schemes to determine multiple TAs (e.g., 2 TAs) using a random access procedure for inter-cell multi-TRP scenario. The random access procedure can be:
Contention-free random access (CFRA) procedure triggered by a PDCCH order.
Contention-free random access (CFRA) procedure triggered by higher layers (e.g., UE triggered).
Contention-based random access (CBRA) procedure triggered by a PDCCH order.
Contention-based random access (CBRA) procedure triggered by higher layers (e.g., UE triggered).

In the following, both FDD and TDD are considered as a duplex method for DL and UL signaling.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

The present disclosure considers several components that can be used in conjunction or in combination with one another, or can operate as standalone schemes.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” corresponds to a set of characteristics of a DL beam or an UL TX beam, such as a direction, a precoding/beamforming, a number of ports, and so on.

In the following components, a TCI state is used for beam indication. It can refer to a DL TCI state for downlink channels (e.g., PDCCH and PDSCH), an uplink TCI state for uplink channels (e.g., PUSCH or PUCCH), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

In the examples of this disclosure, a UE can communicate with the network using different beams. The different beams can be used at different times (e.g., switching from one beam to another beam), or can be used simultaneously, (e.g., simultaneously receiving from network on multiple beams or simultaneously transmitting to the network on multiple beams). The TRPs can belong to different cells. For example, a first TRP (e.g., TRP A) can belong to a first cell (e.g., a serving cell), while a second TRP (e.g., TRP B) can belong to s second cell (e.g., a cell having a PCI different from the PCI of the serving cell). The UE can switch for communicating to the network through TRP A to communicating to the network through TRP B, by performing a handover from the first cell to the second cell or without performing handover.

In the examples of this disclosure, a UE can communicate with the network using different beams for example associated with TRPs. The different beams can be used at different times (e.g., switching from one beam to another beam), or can be used simultaneously, (e.g., simultaneously receiving from network on multiple beams or simultaneously transmitting to the network on multiple beams). In the former, example, two or more TA can be active in the UE, but only one TA is used at a time depending on the beam used for UL transmission. In the latter, two or more TAs can be active in the UE, more than one TA are simultaneously used, when the UE transmits on multiple UL beams simultaneously.

In one example, the UE communicates to the same TRP on two or more different beams. The different beams have different round trip delays. For example, the different round trip delays can be due to different reflections.

In another example, the UE communicates with two or more different TRPs with same physical cell identity (PCI). The UE uses at least one beam to communicate with each TRP. The round delay to each TRP can be different. The TRPs can be synchronized or unsynchronized. This is an example of intra-cell multi-TA (e.g., 2 TA in case of 2 TRPs).

In another example, the UE communicates with two or more different TRPs with same or different physical cell identity (PCI). The UE uses at least one beam to communicate with each TRP. The round delay to each TRP can be different. The TRPs can be synchronized or unsynchronized. When at least one of the TRPs has a different PCI from the other TRP(s), this is an example of inter-cell multi-TA (e.g., 2 TA in case of 2 TRPs).

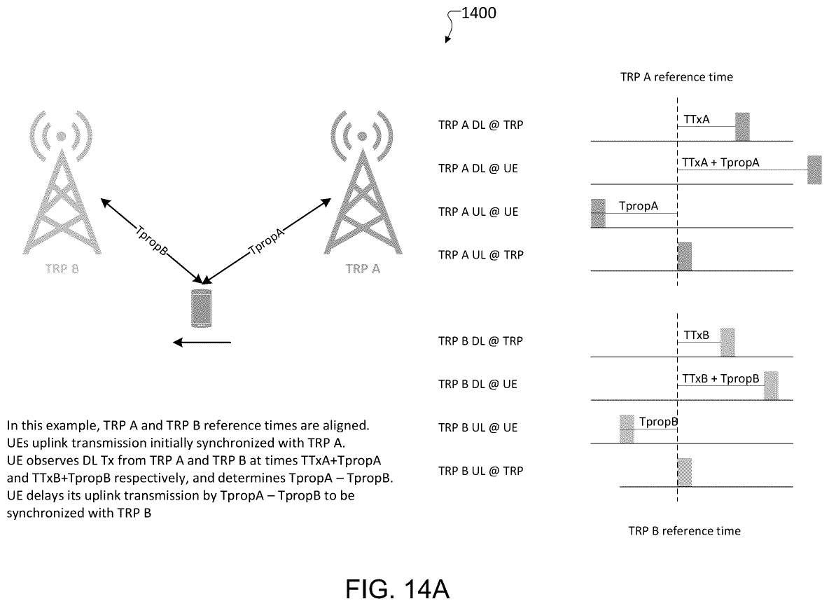

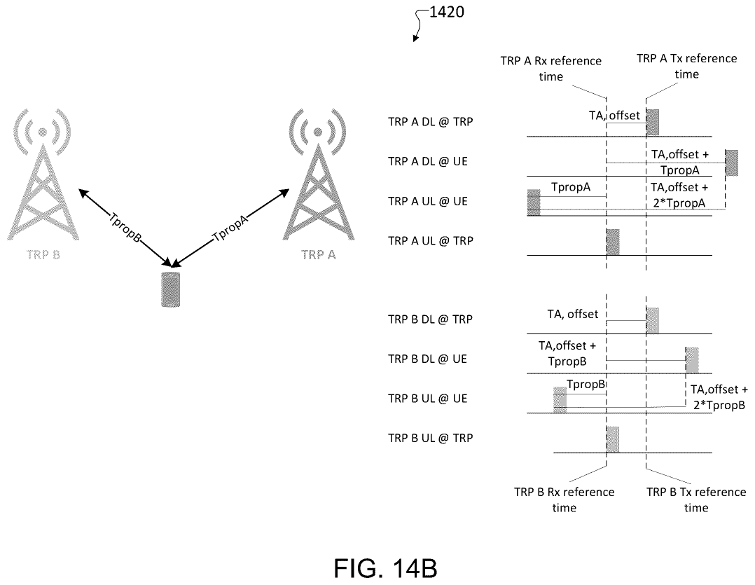

FIGS. 14A-14B illustrate examples of a UE communicating with a first TRP, TRP A, and a second TRP, TRP B according to embodiments of the present disclosure. The examples of a UE communicating of FIGS. 14A-14B are for illustration only. Different embodiments of wireless system beams could be used without departing from the scope of this disclosure.

FIG. 14A illustrates an example 1400 of a UE communicating with a first TRP, TRP A, and a second TRP, TRP B. When communicating with TRP A, the uplink PUSCH transmission is synchronized such that it arrives at TRP A at its reference time, within the CP range as described previously.

FIG. 14B illustrates a further example 1420 of a UE communicating with a first TRP, TRP A, and a second TRP, TRP B. At each TRB the DL transmissions are synchronized a transmission (Tx) reference time and the UL receptions are synchronized to receive reference time. The difference between Tx reference time and the Rx reference time is TA,offset. For example, TA,offset can correspond to the time in units of time (s, ms or sec) of n-TimingAdvanceOffset (N_{TA,Offset}), wherein N_{TA,Offset} can be in units of T_{c}, wherein T_{c}=1/(Δfₘₐₓ−N_{f}), where Δfₘₐₓ=480 kHz. In one example N_{TA,Offset}=0. In one example N_{TA,Offset}=25600. In one example N_{TA,Offset}=39936. In one example, N_{TA,Offset}=13792. In FIG. 14B, the gNB transmits the DL signal at the TRP's Tx reference time, which can be after the TRP's Rx reference by TA,offset. The DL signal undergoes a DL propagation delay of Tprop, wherein Tprop is the one-way propagation delay between the UE and the TRP. The DL signal arrives at the UE, at Tprop after the TRP's Tx reference time, or at TA,offset+Tprop after the TRP's Rx reference. The UE advances the UL transmission time relative to the DL reception time by TA,offset+round-trip-time (RTT), wherein the round-trip-time is the sum of the DL propagation delay and UL propagation delay which is 2*Tprop. Hence the UL transmission at the UE is TA,offset+Tprop before the TRP's Tx reference time or Tprop before the TRP's Rx reference time. The UL transmission undergoes an UL propagation delay of Tprop, wherein Tprop is the one-way propagation delay between the UE and the TRP. The UL reception at the base station arrives at the TRP's Rx reference time, or TA,offset before the TRP's Tx reference time.

As described above, the UE advances the UL transmission time relative to the DL reception time by TA,offset+round-trip-time (RTT) which can be expressed by T_{TA}=(N_{TA}+N_{TA,Offset})·T_{c} [TS 38.211].

In one example, N_{TA} can be indicated in the random access response (RAR) of a Type 1 random access procedure or MSGB response of a Type 2 random access procedure. In which case, the timing advance command can signal an absolute value, T_{A}, which is 12-bits.

$${N}_{TA} = \frac{{T}_{A} \cdot 16 \cdot 64}{{2}^{μ}}$$

Wherein, μ is the sub-carrier spacing configuration.

In one example, the change in value of N_{TA} can be indicated in a Timing Advance MAC CE command [TS 38.321]. For example, the Timing Advance MAC CE indicates a T_{A} values in the range of 0, 1, . . . , 63 (e.g., a 6-bit value). The updated (new) N_{TA} value relative to the previous (old) N_{TA} value is given by:

$${N}_{TA , new} = {N}_{TA , old} + \frac{( {T}_{A} - 31 ) \cdot 16 \cdot 64}{{2}^{μ}}$$

Wherein, μ is the sub-carrier spacing configuration.

In one example, N_{TA} can be indicated in an absolute timing advance MAC CE command. In which case, the timing advance command can signal an absolute value, T_{A}, which is 12-bits.

$${N}_{TA} = \frac{{T}_{A} \cdot 16 \cdot 64}{{2}^{μ}}$$

Wherein, μ is the sub-carrier spacing configuration.

Although FIGS. 14A-14B illustrate examples 1400 and 1420 of a UE communicating with a first TRP, TRP A, and a second TRP, TRP B according, various changes may be made to FIGS. 14A-14B. For example, various changes to the reference times, the offsets, etc. could be made according to particular needs.

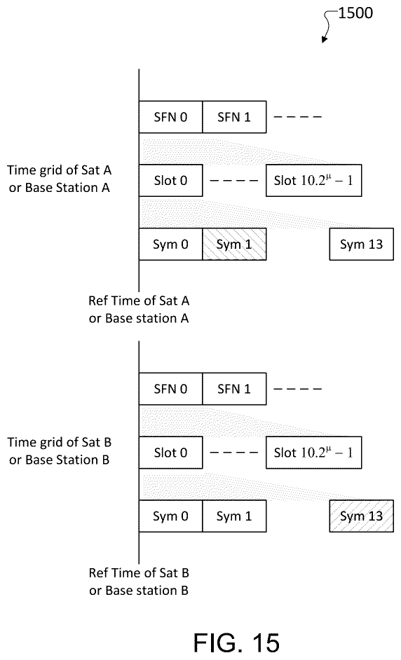

In one example, TRP A and TRP B are synchronized such that TRP A has the same reference time as TRP B as illustrated in FIG. 14A. For example, the reference time within each TRP can be the start of System Frame Number 0 (SEN 0) as shown in FIG. 15.

FIG. 15 illustrates an example 1500 of a first TRP, TRP A, and a second TRP, TRP B being synchronized according to embodiments of the present disclosure. The embodiment of the TRP synchronization of FIG. 15 is for illustration only. Different embodiments of TRP synchronization could be used without departing from the scope of this disclosure.

The TRP establishes its time grid which determines the transmission time of each SFN, each slot within the SFN and each symbol within each slot within each SFN relative to this reference time. In FIG. 14A and in FIG. 15, the reference time of TRP A is the same as the reference time of TRP B. In FIG. 15, μ is the Sub-Carrier Spacing Configuration, which determines the sub-carrier spacing (SCS). For example, μ=0 is for SCS 15 kHz, μ=1 is for SCS=30 kHz, . . . in general for SCS configuration μ the SCS is 2^{μ}·15 kHz. TRP A transmits a downlink signal at time T_{TxA} relative to its reference time. In the example of FIG. 15, the reference signal from TRP A is in Symbol 1 of Slot 0 of SFN 0, in this case, T_{TxA} is the start of Symbol 1 of Slot 0 of SEN 0. For example, the reference signal can be an SS/PBCH block. In another example, the reference signal can be a NZP CSI-RS. In another example, the reference signal can be PDCCH DM-RS or PDSCH DM-RS. The signal from TRPA undergoes a propagation delay T_{PropA}. The signal is received at the UE at a time (relative to the reference time):

T_{DL_UE_A}=T_{TxA}+T_{PropA}

TRP B transmits a downlink signal at time T_{TxB} relative to its reference time. In the example of FIG. 15, the reference signal from TRP B is in Symbol 13 of Slot 0 of SFN 0, in this case, T_{TxB} is the start of Symbol 13 of Slot 0 of SFN 0. For example, the reference signal can be an SS/PBCH block. In another example, the reference signal can be a NZP CSI-RS. In another example, the reference signal can be PDCCH DM-RS or PDSCH DM-RS. The signal from TRB B undergoes a propagation delay T_{propB}. The signal is received at the UE at time (relative to the reference time):

T_{DL_UE_B}=T_{TxB}+T_{PropB}

The UE can determine the difference in propagation delay from the two TRPs, i.e.:

T_{PropA}−T_{PropB}=(T_{DL_UE_A}−T_{TxA})−(T_{DL_UE_B}−T_{TxB})

Although FIG. 15 illustrates one example 1500 of TRP synchronization, various changes may be made to FIG. 15. For example, various changes to the time grids, the reference times, etc. could be made according to particular needs.

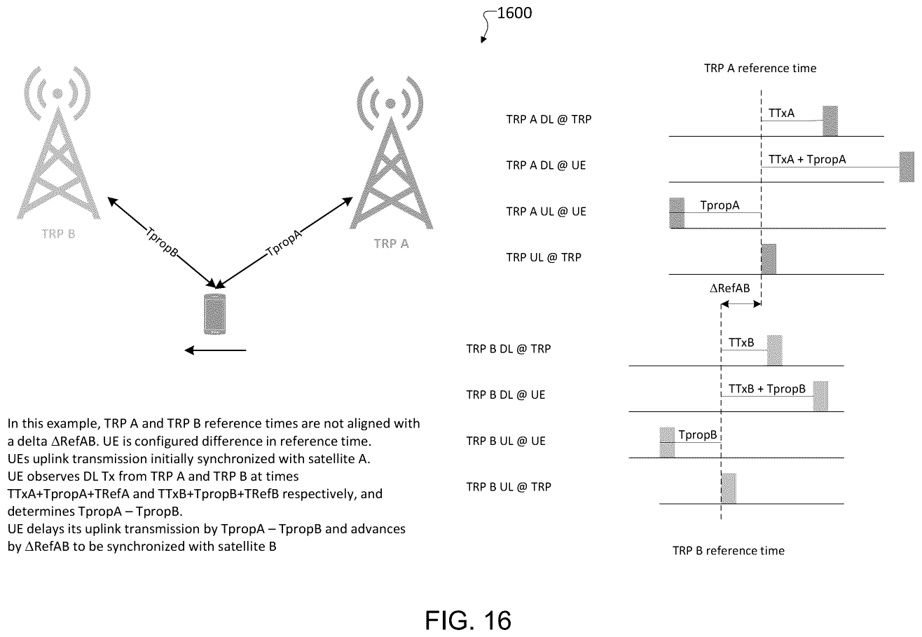

In another example, TRP A and TRB B have different reference times as illustrated in FIG. 16.

FIG. 16 illustrates an example of 1600 of a first TRP, TRP A, and a second TRP, TRP B having asynchronous reference times according to embodiments of the present disclosure. The embodiment of TRP asynchronization of FIG. 16 is for illustration only. Different embodiments of TRP asynchronization could be used without departing from the scope of this disclosure.

A variant of FIG. 16 is to have a different reference time for DL transmit and UL receive for each TRP similar to the illustration in FIG. 14B. Let TRP A's reference time be T_{RefA} and TRP B's reference time be T_{RefB}, the difference in reference time is;

Δ_{RefAB}=T_{RefA}−T_{RefB}

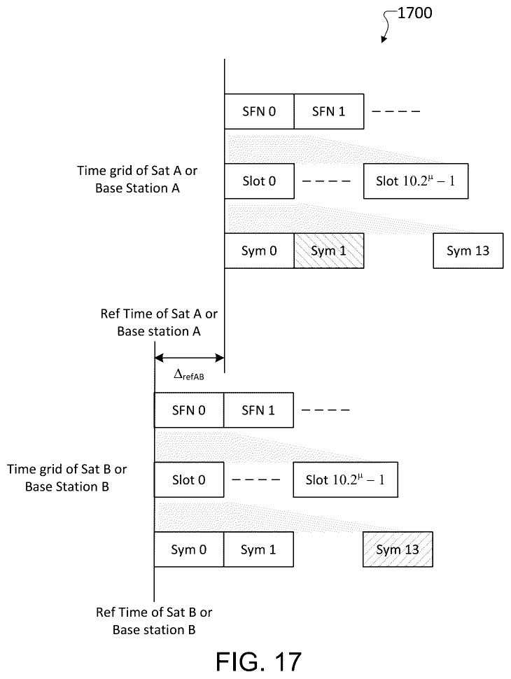

For example, the reference time within each TRP can be the start of System Frame Number 0 (SFN 0) as shown in FIG. 17.

Although FIG. 16 illustrates one example 1600 of TRP asynchronization, various changes may be made to FIG. 16. For example, various changes to the time grids, the reference times, etc. could be made according to particular needs.

The TRP establishes its time grid which determines the transmission time of each SFN, each slot within the SEN and each symbol within each slot within each SEN relative to this reference time. In FIG. 17, the reference time of TRP A is after the reference time of TRP B by Δ_{RefAB}.

FIG. 17 illustrates an example 1700 of a first TRP, TRP A, and a second TRP, TRP B having asynchronous reference times according to embodiments of the present disclosure. The embodiment of TRP asynchronization of FIG. 17 is for illustration only. Different embodiments of TRP asynchronization could be used without departing from the scope of this disclosure.

In FIG. 17, μ is the Sub-Carrier Spacing Configuration, which determines the sub-carrier spacing (SCS). For example, μ=0 is for SCS 15 kHz, μ=1 is for SCS=30 kHz, . . . in general for SCS configuration μ the SCS is 2^{μ}·15 kHz.

TRP A transmits a downlink signal at time T_{TxA} relative to its reference time. In the example of FIG. 17, the reference signal from TRP A is in Symbol 1 of Slot 0 of SFN 0, in this case, T_{TxA} is the start of Symbol 1 of Slot 0 of SFN 0. For example, the reference signal can be an SS/PBCH block. In another example, the reference signal can be a CSI-RS. In another example, the reference signal can be PDCCH DM-RS or PDSCH DM-RS. The signal from TRP A undergoes a propagation delay T_{PropA}. The signal is received at the UE at time:

T_{DL_UE_A}=T_{RefA}+T_{TxA}+T_{PropA}

TRP B transmits a downlink signal at time T_{TxB} relative to its reference time. In the example of FIG. 17, the reference signal from TRP B is in Symbol 13 of Slot 0 of SFN 0, in this case, T_{TxB} is the start of Symbol 13 of Slot 0 of SFN 0. For example, the reference signal can be an SS/PBCH block. In another example, the reference signal can be a CSI-RS. In another example, the reference signal can be PDCCH DM-RS or PDSCH DM-RS. The signal from TRP B undergoes a propagation delay T_{PropB}. The signal is received at the UE at time:

T_{DL_UE_B}=T_{RefB}+T_{TxB}+T_{PropB}
The UE can determine the difference in propagation delay with the two TRPs, i.e.:

$$\begin{matrix}{T}_{PropA} - {T}_{PropB} = ( {T}_{DL\_UE \_A} - {T}_{TxA} - {T}_{RefA} ) - ( {T}_{DL\_UE \_B} - {T}_{TxB} - {T}_{RefB} ) \\ = ( {T}_{DL\_UE \_A} - {T}_{TxA} ) - ( {T}_{DL\_UE \_B} - {T}_{TxB} ) - {Δ}_{RefAB}\end{matrix}$$

Although FIG. 17 illustrates one example 1700 of TRP asynchronization, various changes may be made to FIG. 17. For example, various changes to the time grids, the reference times, etc. could be made according to particular needs.

In another example, the UE communicates with two or more different TRPs with same physical cell identity (PCI). The UE uses at least one beam to communicate with each TRP. The round delay to each TRP can be different. The TRPs can be synchronized or unsynchronized.

In this disclosure, a TA group or TA_grp can refer to a TAG, for example there can be more than one TAG and each TAG can have one TA value. A TA group or TA_grp can also refer a TA index within a TAG, for example, a TAG can have more than one TA value, each associated with a TA index. In one example, when the first TRP (e.g., TRP A) is in a first cell, and the second TRP (e.g., TRP B) is in a second cell. The first TA group is associated with the first cell, and the second TA group is associated with the second cell.

A UE is configured to measure the DL delta propagation delay of DL reference signals.

The UE is configured or determines a reference signal (RS1) to use for DL reference timing. For example, the reference signal can be a reference associated with a source RS (e.g., QCL Type D or spatial relation source RS) of an indicated TCI state. The indicated TCI state can be a joint TCI state or an UL TCI state.

The UE detects a reference signal (RS2) with a signal quality (e.g., RSRP or SINR) that exceeds a threshold X, wherein X is configured/updated by RRC signaling and/or MAC CE signaling and/or L1 control (DCI) signaling.

The UE measures the “DL delta propagation delay” between RS1 and RS2. If the “DL delta propagation delay” exceeds a threshold Y, wherein Y is configured/updated by RRC signaling and/or MAC CE signaling and/or L1 control (DCI) signaling, the UE triggers a random access procedure. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. The random access procedure determines the round trip delay associated with a RS2.

In one example, the first reference signal is associated with a first entity (e.g., TRP or cell or panel or CORESETPOOLIndex). The second reference signal is associated with a second entity (e.g., TRP or cell or panel or CORESETPOOLIndex).

In one example, a first TA group is associated with a first entity (e.g., TRP or cell or panel or CORESETPOOLIndex). A second TA group is associated with a second entity (e.g., TRP or cell or panel or CORESETPOOLIndex).

In one example, UE measures the time of arrival of the first-in-time received or detected RS in the first set associated with a first entity or associated with a first TA group (or TA index within a TA group) and the UE measures the time of arrival of the first-in-time received or detected RS in the second set associated with a second entity or associated with a second TA group (or TA index within a TA group) and calculates the “DL delta propagation delay” between the two measurements based on the first-in-time received or detected RS of each group. In one example the RSes can be SSBs. In one example the RSes can be CSI-RS resources. In one example the RSes can be SSBs or CSI-RS resources.

In one example, UE measures the time of arrival of the first-in-time received or detected RS that exceeds an RSRP threshold in the first set associated with a first entity or associated with a first TA group (or TA index within a TA group) and the UE measures the time of arrival of the first-in-time received or detected RS that exceeds an RSRP threshold in the second set associated with a second entity or associated with a second TA group (or TA index within a TA group) and calculates the “DL delta propagation delay” between the two measurements based on the first-in-time received or detected RS that exceeds the RSRP threshold of each group. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling.

In one example, UE measures the time of arrival of the last-in-time received or detected RS in the first set associated with a first entity or associated with a first TA group (or TA index within a TA group) and the UE measures the time of arrival of the last-in-time received or detected RS in the second set associated with a second entity or associated with a second TA group (or TA index within a TA group) and calculates the “DL delta propagation delay” between the two measurements based on the last-in-time received or detected RS of each group. In one example the RSes can be SSBs. In one example the RSes can be CSI-RS resources. In one example the RSes can be SSBs or CSI-RS resources.

In one example, UE measures the time of arrival of the last-in-time received or detected RS that exceeds an RSRP threshold in the first set associated with a first entity or associated with a first TA group (or TA index within a TA group) and the UE measures the time of arrival of the last-in-time received or detected RS that exceeds an RSRP threshold in the second set associated with a second entity or associated with a second TA group (or TA index within a TA group) and calculates the “DL delta propagation delay” between the two measurements based on the last-in-time received or detected RS that exceeds the RSRP threshold of each group. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling.

In one example, UE measures the time of arrival of the strongest (e.g., largest RSRP or largest SINR or best signal quality) received or detected RS in the first set associated with a first entity or associated with a first TA group (or TA index within a TA group) and the UE measures the time of arrival of the strongest (e.g., largest RSRP or largest SINR or best signal quality) received or detected RS in the second set associated with a second entity or associated with a second TA group (or TA index within a TA group) and calculates the “DL delta propagation delay” between the two measurements based on the strongest (e.g., largest RSRP or largest SINR or best signal quality) received or detected RS of each group. In one example the RSes can be SSBs. In one example the RSes can be CSI-RS resources. In one example the RSes can be SSBs or CSI-RS resources.

In one example, UE measures the average time of arrival of received or detected RSes in the first set associated with a first entity or associated with a first TA group (or TA index within a TA group) and the UE measures the average time of arrival of the received or detected RSes in the second set associated with a second entity or associated with a second TA group (or TA index within a TA group) and calculates the “DL delta propagation delay” between the two measurements based on the last-in-time received or detected RS of each group. In one example the RSes can be SSBs. In one example the RSes can be CSI-RS resources. In one example the RSes can be SSBs or CSI-RS resources. In one example, the averaging of the time of arrival of the RSes can be weighted with the RSRP or SINR of each RS. In one example, the averaging of the time of arrival of the RSes is not weighted.

In one example, UE measures the average time of arrival of the last-in-time received or detected RSes that exceeds an RSRP threshold in the first set associated with a first entity or associated with a first TA group (or TA index within a TA group) and the UE measures the average time of arrival of the received or detected RSes that exceeds an RSRP threshold in the second set associated with a second entity or associated with a second TA group (or TA index within a TA group) and calculates the “DL delta propagation delay” between the two measurements based on the last-in-time received or detected RS that exceeds the RSRP threshold of each group. In one example the RSes can be SSBs. In one example the RSes can be CSI-RS resources. In one example the RSes can be SSBs or CSI-RS resources. In one example, the RSRP threshold can be configured and/or updated by RRC signaling and/or MAC CE signaling and/or L1 control signaling. In one example, the averaging of the time of arrival of the RSes can be weighted with the RSRP or SINR of each RS. In one example, the averaging of the time of arrival of the RSes is not weighted.

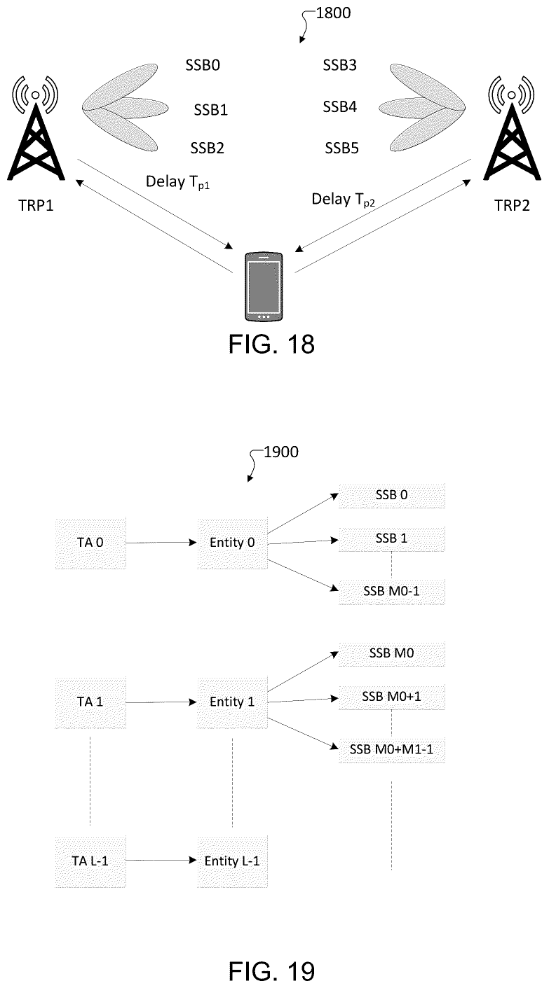

In one example, e.g., as illustrated in FIG. 18, the UE is configured an association of SSBs with TA groups.

FIG. 18 illustrates an example 1800 of a UE configured an association of SSBs with TA groups according to embodiments of the present disclosure. The embodiment of a UE configured an association of SSBs with TA groups of FIG. 18 is for illustration only. Different embodiments of a UE configured an association of SSBs with TA groups could be used without departing from the scope of this disclosure.

In one example, the configuration of the association or grouping can be by higher layer signaling, e.g., the configuration can be included in RACH-ConfigCommon or RACH-ConfigCommonTwoStepRA. For example, there is a first TA group associated with SSB₀, SSB₁, SSB₂, . . . . SSB_{M-1}. There is a second TA group associated with SSB_{M}, SSB_{M+1}, SSB_{M+2}, . . . . SSB_{N-1}. Where, N is the total number of SSBs. M is the number of SSBs associated with the first TA group. N−M is the number of SSBs associated with the second TA group. In one example, the number of SSBs in each TA group is equal, i.e., M=N−M. In another example, there are more than 2 TA groups, the SSBs are partitioned among the more than 2 TA groups. In one example, the number SSBs per TA group can be the same. In another example, the number SSBs per TA group can be different.

In one example, if a RACH procedure is triggered using a preamble and a PRACH Occasion (RO) associated with an SSB and the SSB is associated with a TA group, the TA in the RAR response is for the corresponding TA group.

Although FIG. 18 illustrates one example 1800 of a UE configured an association of SSBs with TA groups, various changes may be made to FIG. 18. For example, various changes to the SSBs, the delay times, etc. could be made according to particular needs.

In a further example, illustrated in FIG. 19, there can be L entities.

FIG. 19 illustrates an example of a TA group having L entities according to embodiments of the present disclosure. The embodiment of a TA group of FIG. 19 is for illustration only. Different embodiments of a TA group having L entities could be used without departing from the scope of this disclosure.

For example, an entity can be a TRP or a cell or panel on a TRP or CORESETPOOLIndex.
An entity 0 is associated with a TA group 0 (or TA index 0 within a TA group) and is associated with a set 0 of SSBs, e.g., SSB₀, SSB₁, . . . SSB_{M}_{ₒ}₋₁, where M₀ is the number of SSBs associated with the entity 0 and the TA group 0 (or TA index 0 within a TA group).
An entity 1 is associated with a TA group 1 (or TA index 1 within a TA group) and is associated with a set 1 of SSBs, e.g., SSB_{M}_{ₒ}, SSB_{M}_{ₒ}₊₁, . . . SSB_{M}_{ₒ}_{+M}_{₁}₋₁, where M₁ is the number of SSBs associated with the entity 1 and the TA group 1 (or TA index 1 within a TA group).
An entity L−1 is associated with a group L−1 (or TA index L−1 within a TA group L−1) and is associated with a set L−1 of SSBs, e.g.,

$${SSB}_{{\sum }_{i = 0}^{L - 2} {M}_{i}} , {SSB}_{{\sum }_{i = 0}^{L - 2} {M}_{i} + 1} , … {SSB}_{{\sum }_{i = 0}^{L - 1} {M}_{i} - 1} ,$$

where Mᵢ is the number of SSBs associated with the entity i and the TA group i (or TA index i within a TA group), wherein i=0, . . . , L−1. Σᵢ₌₀^{L-1}Mᵢ=N, where N is the number of SSBs.

In one example, Mᵢ can be different for each entity.

In one example, M₀=M₁= . . . =M_{L-1}=M.

Although FIG. 19 illustrates one example 1900 of a TA group having L entities, various changes may be made to FIG. 19. For example, various changes to the TAs, the entities, etc. could be made according to particular needs.

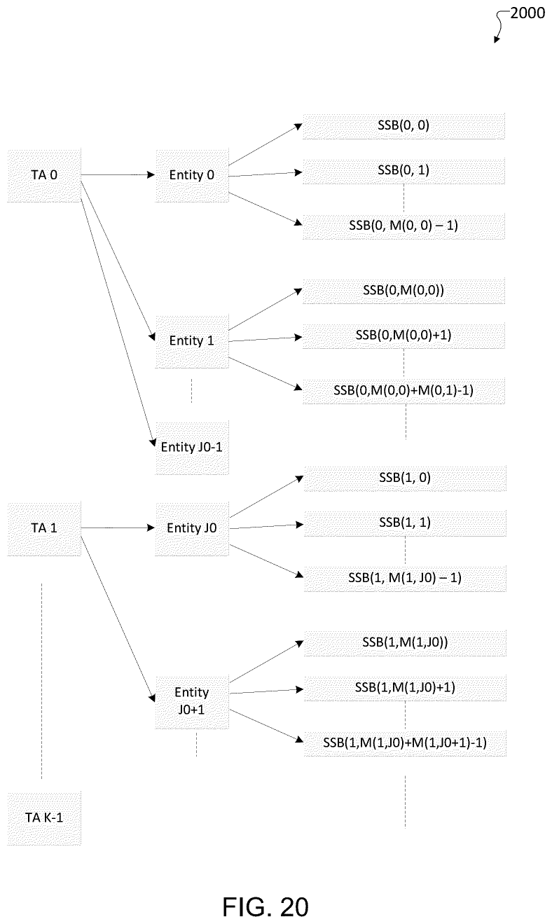

In a further example, illustrated in FIG. 20, there can be L entities, and K TA groups.

FIG. 20 illustrates an example 2000 of L entities, and K TA groups according to embodiments of the present disclosure. The embodiment of L entities, and K TA groups of FIG. 20 is for illustration only. Different embodiments of L entities, and K TA groups could be used without departing from the scope of this disclosure.

For example, an entity can be a TRP or a cell or panel on a TRP or a CORESETPOOLIndex.
TA group 0 (or TA index 0 within a TA group) is associated with a set 0 of entities, e.g., entity 0, entity 1, . . . entity J₀−1, where J₀ is the number of entities associated with TA group 0 (or TA index 0 within a TA group).
   Entity 0 is associated with a set (0,0) of SSBs, e.g.,

$${SSB}_{0 , 0} , {SSB}_{0 , 1} , … {SSB}_{0 , {M}_{0 , 0} - 1} ,$$

where M_{0,0} is the number of SSBs associated with the entity 0 and the TA group 0 (or TA index 0 within a TA group).
Entity 1 is associated with a set (0,1) of SSBs, e.g.,

$${SSB}_{0 , {M}_{0 , 0}} , {SSB}_{0 , {M}_{0 , 0} + 1} , … {SSB}_{0 , {M}_{0 , 0} + {M}_{0 , 1} - 1} ,$$

where M_{0,1} is the number of SSBs associated with the entity 1 and the TA group 0 (or TA index 0 within a TA group).
Entity J₀−1 is associated with a set (0,J₀−1) of SSBs, e.g.,

$${SSB}_{0 , {\sum }_{i = 0}^{{J}_{0} - 2} {M}_{0 , i}} , {SSB}_{0 , {\sum }_{i = 0}^{{J}_{0} - 2} {M}_{0 , i} + 1} , … {SSB}_{0 , {\sum }_{i = 0}^{{J}_{0} - 1} {M}_{0 , i} - 1} ,$$

where M_{0,i} is the number of SSBs associated with the entity i and the TA group 0 (or TA index 0 within a TA group).
TA group 1 (or TA index 1 within a TA group) is associated with a set 1 of entities, e.g., entity J₀, entity J₀+1, . . . entity J₀+J₁−1, where J₁ is the number of entities associated with TA group 1 (or TA index 1 within a TA group).
   Entity J₀ is associated with a set (1,J₀) of SSBs, e.g.,

$${SSB}_{1 , 0} , {SSB}_{1 , 1} , … {SSB}_{1 , {M}_{1 , {J}_{0}} - 1} ,$$

where M_{1,J}_{₀} is the number of SSBs associated with the entity J₀ and the TA group 1 (or TA index 1 within a TA group).
   Entity J₀₊₁ is associated with a set (1,J₀+1) of SSBs, e.g.,

$${SSB}_{1 , {M}_{1 , {J}_{0}}} , {SSB}_{1 , {M}_{1 , {J}_{0}} + 1 ,} … {SSB}_{1 , {M}_{1 , {J}_{0}} + {M}_{1 , {J}_{0} + 1} - 1} ,$$

where M_{1,Jo+1}+1 is the number of SSBs associated with the entity J₀+1 and the TA group 1 (or TA index 1 within a TA group).
   Entity J₀+J₁−1 is associated with a set (1,J₀+J₁−1) of SSBs, e.g.,

$${SSB}_{1 , {\sum }_{i = {J}_{0}}^{{J}_{0} + {J}_{1} - 2} {M}_{1 , i}} , {SSB}_{1 , {\sum }_{i = {J}_{0}}^{{J}_{0} + {J}_{1} - 2} {M}_{1 , i} + 1} , … {SSB}_{1 , {\sum }_{i = {J}_{0}}^{{J}_{0} + {J}_{1} - 1} {M}_{1 , i} - 1} ,$$

where M_{1,i} is the number of SSBs associated with the entity i and the TA group 1 (or TA index 1 within a TA group).
TA group K−1 (or TA index K−1 within a TA group) is associated with a set K−1 of entities, e.g., entity Σⱼ₌₀^{K-2}Jⱼ, entity Σᵢ₌₀^{K-2}Jⱼ+1, . . . entity Σⱼ₌₀^{K-1} Jⱼ−1, where Jⱼ is the number of entities associated with TA group j (or TA index j within a TA group).
   Entity Σᵢ₌₀^{K-2}Jⱼ is associated with a set (K−1,Σᵢ₌₀^{K-1}Jⱼ) of SSBs, e.g.,

$${SSB}_{K - 1 , 0} , {SSB}_{K - 1 , 1} , … {SSB}_{K - 1 , {M}_{K - 1 , {\sum }_{j = 0}^{K - 2} {J}_{j}} - 1} ,$$

where

$${M}_{K - 1 , {\sum }_{j = 0}^{K - 2} {J}_{j}}$$

is the number of SSBs associated with the entity Σⱼ₌₀^{K-2}Jⱼ and the TA group K−1 (or TA index K−1 within a TA group).
   Entity Σⱼ₌₀^{K-2} is associated with a set (K−1,Σⱼ₌₀^{K-2}Jⱼ) of SSBs, e.g.,

$${SSB}_{K - 1 , {M}_{K - 1 , {J}_{0}}} , {SSB}_{K - 1 , {M}_{K - 1 , {\sum }_{j = 0}^{K - 2} {J}_{j}} + 1} , … {SSB}_{K - 1 , {M}_{K - 1 , {\sum }_{j = 0}^{K - 2} {J}_{j}} + {M}_{K - 1 , {\sum }_{j = 0}^{K - 2} {J}_{j} + 1} - 1} .$$

where

$${M}_{K - 1 , {\sum }_{j = 0}^{K - 2} {J}_{j} + 1}$$

is the number of SSBs associated with the entity Σⱼ₌₀^{K-2}+1 and the TA group K−1 (or TA index K−1 within a TA group).

In one example, Σⱼ₌₀^{K-2}Jⱼ=L, where L is the number of entities across all TA groups (or TA indexes within a TA group). Jⱼ is the number of entities associated with TA group j or (TA index j with a TA group).

In one example, M_{i,j} can be different for each entity j and each TA group i (or TA index i within a TA group).

In one example, M_{i,j}=Mᵢ is the same value Mᵢ for any entity j associated with TA group i (or TA index i within a TA group). Where, Mᵢ is the number of SSB associated with any entity j associated with TA group i (or TA index i within a TA group).

In one example, M_{i,j}=M is the same value M for any entity j associated with any TA group i (or TA index i within a TA group). Where, M is the number of SSB associated with any entity j associated with any TA group i (or TA index i within a TA group).

Although FIG. 20 illustrates one example 2000 of L entities, and K TA groups, various changes may be made to FIG. 20. For example, various changes to the TAs, the entities, etc. could be made according to particular needs.

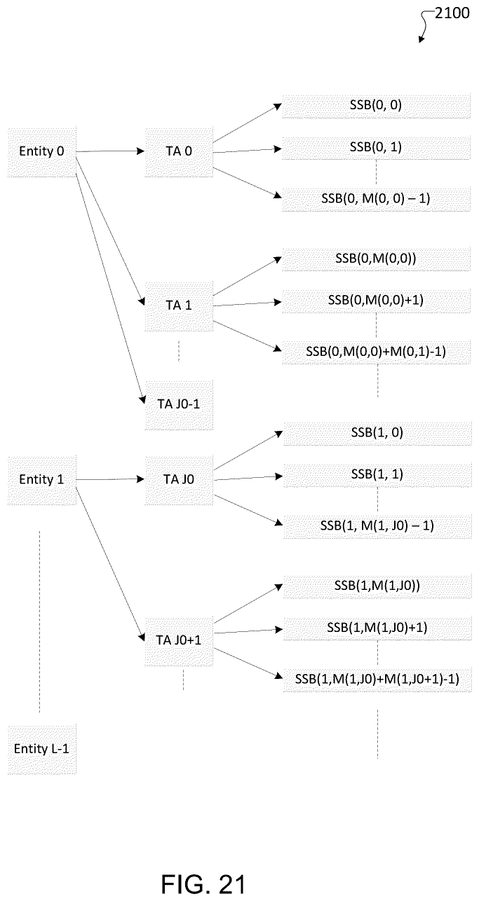

In a further example, illustrated in FIG. 21, there can be L entities, and K TA groups (TA indexes within a TA group).

FIG. 21 illustrates an example 2100 of L entities, and K TA groups according to embodiments of the present disclosure. The embodiment of L entities, and K TA groups of FIG. 21 is for illustration only. Different embodiments of L entities, and K TA groups could be used without departing from the scope of this disclosure.

For example, an entity can be a TRP or a cell or panel on a TRP or a CORESETPOOLIndex.
An entity 0 is associated with a set 0 TA groups (or TA indexes within a TA group), e.g., TA 0, TA 1, . . . TA J₀−1, TA J₀ is the number of TA groups (or TA indexes within a TA group) associated with entity 0.
   TA 0 is associated with a set (0,0) of SSBs, e.g., SSB_{0,0}, SSB_{0,1}, . . . SSB_{0,M}_{_{0,0}}₋₁, where M_{0,0} is the number of SSBs associated with the TA 0 and the entity 0.
   TA 1 is associated with a set (0,1) of SSBs, e.g., SSB_{0,M0,0},SSB_{0,M}_{_{0,0}}₊₁, . . . SSB_{0,M}_{_{0,0}}_{+M}_{_{0,1}}₋₁, where M_{0,1} is the number of SSBs associated with the TA 1 and entity 0.
   TA J₀−1 is associated with a set (0,J₀−1) of SSBs, e.g.,

$${SSB}_{0 , {\sum }_{i = 0}^{{J}_{0} - 2} {M}_{0 , i}} , {SSB}_{0 , {\sum }_{i = 0}^{{J}_{0} - 2} {M}_{0 , i} + 1} , … {SSB}_{0 , {\sum }_{i = 0}^{{J}_{0} - 1} {M}_{0 , i} - 1} ,$$

where M_{0,i} is the number of SSBs associated with the TA i and the entity 0.
An entity 1 is associated with a set 1 of TA groups (or TA indexes within a TA group), e.g., TA J₀, TA J₀+1, . . . TA J₀+J₁−1, where J₁ is the number of TA groups (or TA indexes within a TA group) associated with entity 1.
   TA J₀ is associated with a set (1, J₀) of SSBs, e.g., SSB_{1,0}, SSB_{1,1}, . . . SSB_{1,M}_{₁}₋₁, where M_{1,J}_{₀} is the number of SSBs associated with the TA J₀ and the entity 1.
   TA J₀+1 is associated with a set (1,J₀+1) of SSBs, e.g.,

$${SSB}_{1 , {M}_{1 , {J}_{0}}} , {SSB}_{1 , {M}_{1 , {J}_{0}} + 1} , … {SSB}_{1 , {M}_{1 , {J}_{0}} + {M}_{1 , {J}_{0} + 1} - 1} ,$$

where M_{1,J}_{₀}₊₁ is the number of SSBs associated with the TA J₀+1 and entity 1.
TA J₀+J₁−1 is associated with a set (1,J₀+J₁−1) of SSBs, e.g.,

$${SSB}_{1 , {\sum }_{i = {J}_{0}}^{{J}_{0} + {J}_{1} - 2} {M}_{1 , i}} , {SSB}_{1 , {\sum }_{i = {J}_{0}}^{{J}_{0} + {J}_{1} - 2} {M}_{1 , i} + 1} , … {SSB}_{1 , {\sum }_{i = {J}_{0}}^{{J}_{0} + {J}_{1} - 1} {M}_{1 , i} - 1} ,$$

where M_{1,i} is the number of SSBs associated with the TA i and entity 1.
An entity K−1 is associated with a set K−1 of TA groups (or TA indexes within a TA group), e.g., TA Σⱼ₌₀^{K-2}Jⱼ, Σⱼ₌₀^{K-2}Jⱼ+1, . . . TA Jⱼ−1, where Jⱼ is the number of TA groups (or TA indexes within a TA group) associated with entity j.
   TA Σⱼ₌₀^{K-2} is associated with a set (K−1,Σⱼ₌₀^{K-2}Jⱼ) of SSBs, e.g.,

$${SSB}_{K - 1 , 0} , {SSB}_{K - 1 , 1} , … {SSB}_{K - 1 , {M}_{K - 1 , {\sum }_{j = 0}^{K - 2} {J}_{j}} - 1} , where {M}_{K - 1 , {\sum }_{j = 0}^{K - 2} {J}_{j}}$$

is the number of SSBs associated with TA Σⱼ₌₀^{K-2}Jⱼ and entity K−1.
TA Σⱼ₌₀^{K-2}J_{J}+1 is associated with a set (K−1,Σⱼ₌₀^{K-2}Jⱼ+1) of SSBs, e.g.,

$${SSB}_{K - 1 , {M}_{K - 1 , {J}_{0}}} , {SSB}_{K - 1 , {M}_{K - 1 , {\sum }_{j = 0}^{K - 2} {J}_{j}} + 1} , … {SSB}_{K - 1 , {M}_{K - 1 , {\sum }_{j = 0}^{K - 2} {J}_{j}} + {M}_{K - 1 , {\sum }_{j = 0}^{K - 2} {J}_{j} + 1} - 1 ,}$$

where

$${M}_{K - 1 , {\sum }_{j = 0}^{K - 2} {J}_{j} + 1}$$

is the number of SSBs associated with TA Σⱼ₌₀^{K-2}Jⱼ+1 and entity K−1.

In one example, Σⱼ₌₀^{L-1}Jⱼ=K, where K is the number of TA groups (or TA indexes in a TA group) across all entities. Jⱼ is the number of TA groups (or TA indexes within a TA group) associated with entity j.

In one example, M_{i,j} can be different for each TA group j (or TA index j within a TA group) and each entity i.

In one example, M_{i,j}=ML is the same value ML for any TA group j (or TA index j within a TA group) associated with entity i. Where, ML is the number of SSB associated with any TA group j (or TA index j within a TA group) associated with entity i.

In one example, M_{i,j}=M is the same value M for any TA group j (or TA index j within a TA group) associated with any entity i. Where, M is the number of SSB associated with any TA group j (or TA index j within a TA group) associated with any entity i.

Although FIG. 21 illustrates one example 2100 of L entities, and K TA groups, various changes may be made to FIG. 21. For example, various changes to the TAs, the entities, etc. could be made according to particular needs.

In one example, the UE is configured an association of CSI-RS resources with TA groups. In one example, the configuration of the association or grouping can be by higher layer signaling. For example, there is a first TA group associated with CSIRS₀, CSIRS₁, CSIRS₂, . . . CSIR_{M-1}. There is a second TA group associated with CSIRS_{M}, CSIRS_{M+1}, CSIRS_{M+2}, . . . CSIRS_{N-1}. Where, N is the total number of CSI-RS resources. M is the number of CSI-RS resources associated with the first TA group. N−M is the number of CSI-RS resources associated with the second TA group. In one example, the number of CSI-RS resources in each TA group is equal, i.e., M=N−M. In another example, there are more than 2 TA groups, the CSI-RS resources are partitioned among the more than 2 TA groups. In one example, the number CSI-RS resources per TA group can be the same. In another example, the number CSI-RS resources per TA group can be different.

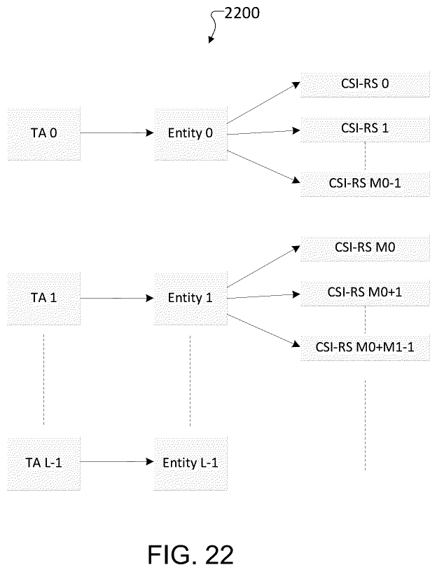

In a further example, illustrated in FIG. 22, there can be L entities. For example, an entity can be a TRP or a cell or panel on a TRP or a CORESETPOOLIndex.

FIG. 22 illustrates an example 2200 of a TA group having L entities according to embodiments of the present disclosure. The embodiment of a TA group of FIG. 22 is for illustration only. Different embodiments of a TA group having L entities could be used without departing from the scope of this disclosure.

Entity i is associated with TA group i (or TA index i within a TA group). A set of ML CSI-RS resources are associated entity i and TA group i (or TA index i within a TA group).

In one example, Mᵢ can be different for each entity.

In one example, M₀=M₁= . . . =M_{L-1}=M.

Although FIG. 22 illustrates one example 2200 of a TA group having L entities, various changes may be made to FIG. 22. For example, various changes to the TAs, the entities, etc. could be made according to particular needs.

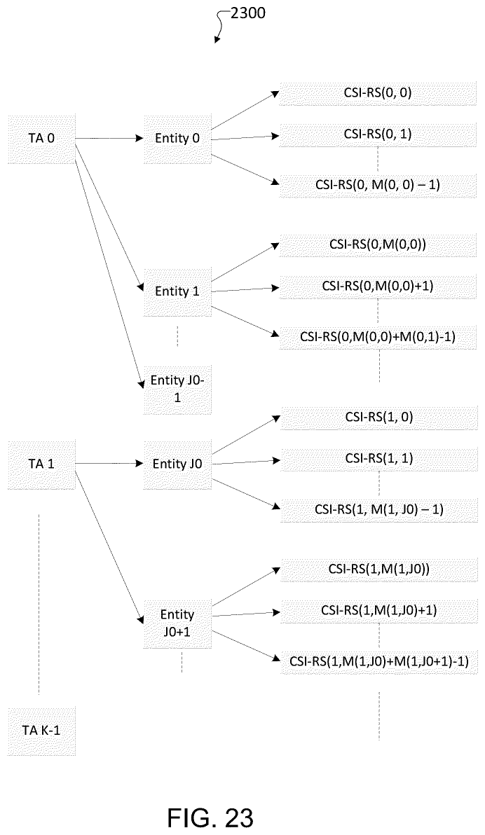

In a further example, illustrated in FIG. 23, there can be L entities, and K TA groups.

FIG. 23 illustrates an example 2300 of L entities, and K TA groups according to embodiments of the present disclosure. The embodiment of L entities, and K TA groups of FIG. 23 is for illustration only. Different embodiments of L entities, and K TA groups could be used without departing from the scope of this disclosure.

For example, an entity can be a TRP or a cell or panel on a TRP. A TA group i (or TA index i within a TA group) is associated with a set of Jⱼ entities. A set of M_{i,j} CSI-RS resources are associated entity j, wherein entity j is associated with TA group i (or TA index i within a TA group).

In one example, Σᵢ₌₀^{K-1} Jᵢ=L, where L is the number of entities across all TA groups (or TA indexes within a TA group). Jᵢ is the number of entities associated with TA group i or (TA index i with a TA group).

In one example, M_{i,j} can be different for each entity j and each TA group i (or TA index i within a TA group).

In one example, M_{i,j}=Mᵢ is the same value ML for any entity j associated with TA group i (or TA index i within a TA group). Where, ML is the number of SSB associated with any entity j associated with TA group i (or TA index i within a TA group).

In one example, M_{i,j}=M is the same value M for any entity j associated with any TA group i (or TA index i within a TA group). Where, M is the number of SSB associated with any entity j associated with any TA group i (or TA index i within a TA group).

Although FIG. 23 illustrates one example 2300 of L entities, and K TA groups, various changes may be made to FIG. 23. For example, various changes to the TAs, the entities, etc. could be made according to particular needs.

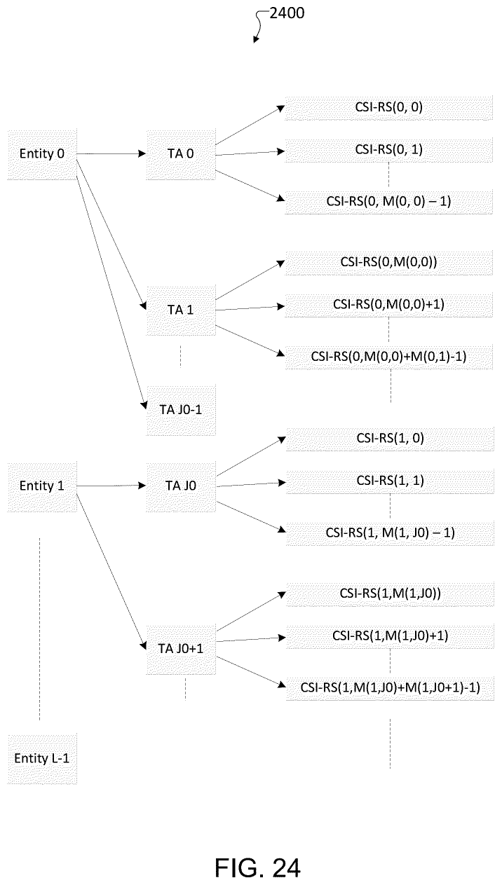

In a further example, illustrated in FIG. 24, there can be L entities, and K TA groups.

FIG. 24 illustrates an example 2400 of L entities, and K TA groups according to embodiments of the present disclosure. The embodiment of L entities, and K TA groups of FIG. 24 is for illustration only. Different embodiments of L entities, and K TA groups could be used without departing from the scope of this disclosure.

For example, an entity can be a TRP or a cell or panel on a TRP or a CORESETPOOLIndex. An entity i is associated with a set of Jⱼ TA groups (or TA indexes within a TA group). A set of M_{i,j} CSI-RS resources are associated TA group j (or TA index j within a TA group), wherein TA group j (or TA index j within a TA group) is associated with entity i.

In one example, Σᵢ₌₀^{K-1}Jᵢ=K, where K is the number of TA groups (or TA indexes in a TA group) across all entities. Jⱼ is the number of TA groups (or TA indexes within a TA group) associated with entity j.

In one example, M_{i,j} can be different for each TA group j (or TA index j within a TA group) and each entity i.

In one example, M_{i,j}=ML is the same value ML for any TA group j (or TA index j within a TA group) associated with entity i. Where, ML is the number of SSB associated with any TA group j (or TA index j within a TA group) associated with entity i.

In one example, M_{i,j}=M is the same value M for any TA group j (or TA index j within a TA group) associated with any entity i. Where, M is the number of SSB associated with any TA group j (or TA index j within a TA group) associated with any entity i.

Although FIG. 24 illustrates one example 2400 of L entities, and K TA groups, various changes may be made to FIG. 24. For example, various changes to the TAs, the entities, etc. could be made according to particular needs.

In one example, if a RACH procedure is triggered using a preamble and a PRACH Occasion (RO) associated with an SSB that is a QCL source (direct QCL or indirect QCL) for the CSI-RS and the SSB is associated with a TA group, the TA in the RAR response is for the corresponding TA group.

In one example, there is no threshold X configured, the UE measures the difference in DL propagation time (DL delta propagation delay) between RS1 and RS2, to determine if it exceeds a threshold Y and if it does, the UE triggers a random access procedure.

In one example, the UE operates with a single TA. If the difference in DL propagation time (DL delta propagation delay) between RS1 and RS2 exceeds a threshold Y, the UE triggers a random access procedure, when the random access procedure is successful, the UE switches to two TA mode. In one example, the UE is signaled two TA values in the RAR, a first TA value for channels/signals or TCI states or CORESETs associated with RS1 or a first TA group (or TA index) and a second TA value for channels/signals or TCI states or CORESETs associated with RS2 or a second TA group (or TA index). In one example, the UE is signaled a TA value in the RAR, the TA value is for channels/signals or TCI states or CORESETs associated with RS, or the TA group associated with the random access procedure.

In one example, the UE is signaled two TA values, a first TA value for channels/signals or TCI states or CORESETs associated with RS1 or a first TA group and a second TA value for channels/signals or TCI states or CORESETs associated with RS2 or a second TA group. In one example, a channel/signal or TCI state or CORESET is said to be associated with RS1 or first TA group, if the channel/signal or TCI state or CORESET is received (or transmitted) by the same entity (e.g., TRP or panel or cell or CORESETPOOLIndex) transmitting RS1 or the same entity (e.g., TRP or panel or cell or CORESETPOOLIndex) associated with the first TA group. In one example, a channel/signal or TCI state or CORESET is said to be associated with RS2 or second TA group, if the channel/signal or TCI state or CORESET is received (or transmitted) by the same entity (e.g., TRP or panel or cell or CORESETPOOLIndex) transmitting RS2 or the same entity (e.g., TRP or panel or cell or CORESETPOOLIndex) associated with the second TA group. In one example, a channel/signal is said to be associated with RS1, if the channel/signal is received (or transmitted) has a same quasi-co-location reference signal as RS1, in one example, the QCL is Type-D QCL, in another example the QCL is Type-A QCL, in another example the QCL is Type-B QCL, in another example the QCL is Type-C QCL. In one example, a channel/signal is said to be associated with RS2, if the channel/signal is received (or transmitted) has a same quasi-co-location reference signal as RS2, in one example, the QCL is Type-D QCL, in another example the QCL is Type-A QCL, in another example the QCL is Type-B QCL, in another example the QCL is Type-QCL. In one example, the RACH procedure is triggered by the UE.

In one example, random access procedure is a Type 1 contention-based random access procedure.

In one example, random access procedure is a Type 1 contention-free random access procedure.

In one example, random access procedure is a Type 2 contention-based random access procedure.

In one example, random access procedure is a Type 2 contention-free random access procedure.

In one embodiment, the network measures the time of arrival of an UL signal from the UE at TRP B relative to the reference time of, e.g., TRP B (e.g., TRP B's Rx reference time). In one example, the time of arrival can be based the first-in-time received or detected reference signal. In one example, the time of arrival can be based on the first-in-time received or detected reference signal that exceeds an RSRP threshold, wherein the RSRP threshold can be configured and/or updated by RRC signaling and/or MAC CE signaling and/or L1 control signaling. In one example, the time of arrival can be based the last-in-time received or detected reference signal. In one example, the time of arrival can be based the last-in-time received or detected reference signal that exceeds an RSRP threshold, wherein the RSRP threshold can be configured and/or updated by RRC signaling and/or MAC CE signaling and/or L1 control signaling. In one example, the time of arrival can be based on the strongest (e.g., largest RSRP or largest SINR or best signal quality). In one example, the time of arrival can be based on the strongest (e.g., largest RSRP or largest SINR or best signal quality) received or detected reference signal. In one example, the time of arrival can be an average of the received or detected reference signals. In one example, the time of arrival can be an average of the received or detected reference signals that exceed a RSRP threshold, wherein the RSRP threshold can be configured and/or updated by RRC signaling and/or MAC CE signaling and/or L1 control signaling. If the difference between the arrival time of the UL signal at TRP B and the reference time of TRP B (e.g., TRP B's Rx reference time), exceeds a threshold X, wherein X is configured/updated by RRC signaling and/or MAC CE signaling and/or L1 control (DCI) signaling, the network can trigger a PDCCH order for a random access procedure towards the UE for the UE to transmit PRACH preamble. In one example the threshold X can be specified in the system specifications, e.g., X equals half the cyclic prefix, or X equals quarter the cyclic prefix, or X equals the cyclic prefix. In one example, a value X specified in the system specifications (e.g., default value) can be used, unless a different value is configured. The network can measure the round trip delay between the UE and TRP. In one example, the RACH procedure is triggered by the network.

In one example, the PDCCH order triggers a Type 1 contention-based random access procedure.

In one example, the PDCCH order triggers a Type 1 contention-free random access procedure.

In one example, the PDCCH order triggers a Type 2 contention-based random access procedure.

In one example, the PDCCH order triggers a Type 2 contention-free random access procedure.

In one example, a PRACH transmission from a UE is in response to a detection of a PDCCH order by the UE that triggers a contention-free random access procedure DL RS that the DM-RS of the PDCCH order is quasi-collocated with can be SSB or CSI-RS.

If the DL RS of the DM-RS of the PDCCH is an SSB, the PRACH spatial domain transmission filter and power is determined based on the SSB (for example, the UE has beam correspondence). If the DL RS of the DM-RS of the PDCCH is an SSB, and the SSB is associated with a TA group (e.g., a first TA group or a second TA group), the TA in the RAR corresponds to the TA group associated with the SSB.

If the DL RS of the DM-RS of the PDCCH is a CSI-RS resource, the PRACH spatial domain transmission filter and power is determined based on the CSI-RS resource (for example, the UE has beam correspondence). If the DL RS of the DM-RS of the PDCCH is a CSI-RS resource, and the CSI-RS resource is associated with a TA group (e.g., a first TA group or a second TA group), the TA in the RAR corresponds to the TA group associated with the CSI-RS resource.

If the DL RS of the DM-RS of the PDCCH is a CSI-RS resource, and the CSI-RS resource is QCLed with an SSB and the SSB is associated with a TA group (e.g., a first TA group or a second TA group), the TA in the RAR corresponds to the TA group associated with the SSB that is a QCL source for the CSI-RS resource. In one example, the QCL is Type-D QCL. In another example the QCL is Type-A QCL. In another example the QCL is Type-B QCL. In another example the QCL is Type-C QCL. The QCL to the SSB can be direct QCL or indirect QCL.

In one example, the DCI of the PDCCH order includes an SSB. The SSB is associated with a TA group (e.g., a first TA group or a second TA group), the TA in the RAR corresponds to the TA group associated with the SSB.

In one example, the DCI of the PDCCH order includes flag. The flag indicates a TA group (e.g., a first TA group or a second TA group), the TA in the RAR corresponds to the TA group indicated by the flag.

In one example, the PDCCH order is triggered by an entity (e.g., TRP or cell or panel or CORESETPOOLIndex) for which the TA is to be calculated.

In one example, the PDCCH order can be triggered by an entity (e.g., TRP or cell or panel or CORESETPOOLIndex) different from the entity for which the TA is to be calculated, for example cross-TRP PDCCH order triggering of preamble. In one example the entity for which the TA is to be calculated can be indicated by an SSB in the PDCCH order wherein the SSB is associated with the entity for which the TA is being calculated. In one example the entity for which the TA is to be calculated can be indicated by a flag or parameter in the PDCCH order wherein the flag or parameter in the PDCCH order is for the entity for which the TA is being calculated.

In one example, the PDCCH order can trigger two preamble transmission; (1) a first preamble transmission for a first entity or TA group or TA index in a TA group, (2) a second preamble transmission for a second entity or TA group or TA index in a TA group. In one example, there can be one RAR for the two preambles. In another example, there can be two RARs one for each preamble. In one example, when there is one RAR for the two preambles, the RAR can be sent from the entity that triggered the PDCCH order.

In one example, the PDCCH order can trigger a contention-based random access procedure. In one example, the contention-based PDCCH order can be used for transmitting a preamble associated with a TRP different from the TRP that triggered the PDCCH order.

In one embodiment, the network measures the time of arrival of an UL signal from the UE at TRP B relative to the reference time of, e.g., TRP B (e.g., TRP B's Rx reference time). In one example, the time of arrival can be based the first-in-time received or detected reference signal. In one example, the time of arrival can be based the first-in-time received or detected reference signal that exceeds an RSRP threshold, wherein the RSRP threshold can be configured and/or updated by RRC signaling and/or MAC CE signaling and/or L1 control signaling. In one example, the time of arrival can be based the last-in-time received or detected reference signal. In one example, the time of arrival can be based the last-in-time received or detected reference signal that exceeds an RSRP threshold, wherein the RSRP threshold can be configured and/or updated by RRC signaling and/or MAC CE signaling and/or L1 control signaling. In one example, the time of arrival can be based the strongest (e.g., largest RSRP or largest SINR or best signal quality). In one example, the time of arrival can be based the strongest (e.g., largest RSRP or largest SINR or best signal quality) received or detected reference signal. In one example, the time of arrival can be an average of the received or detected reference signals. In one example, the time of arrival can be an average of the received or detected reference signals that exceed a RSRP threshold, wherein the RSRP threshold can be configured and/or updated by RRC signaling and/or MAC CE signaling and/or L1 control signaling. If the difference between the arrival time of the UL signal at TRP B and the reference time of TRP B (e.g., TRP B's Rx reference time), exceeds a threshold X, wherein X is configured/updated by RRC signaling and/or MAC CE signaling and/or L1 control (DCI) signaling, the network can trigger or configure the UE to transmit a sounding reference signal (SRS). In one example the threshold X can be specified in the system specifications, e.g., X equals half the cyclic prefix, or X equals quarter the cyclic prefix, or X equals the cyclic prefix. In one example, a value X specified in the system specifications (e.g., default value) can be used, unless a different value is configured. The network can measure the arrival time of the SRS transmitted by the UE at TRP B, and accordingly determine the TA value for transmissions towards TRP B.

In one example, the SRS configured is a periodic SRS.

In one example, the SRS activated is a semi-persistent SRS. The network activates the semi-persistent SRS when the threshold X is exceeded.

In one example, the SRS triggered is an aperiodic SRS. The network triggers the aperiodic SRS when the threshold X is exceeded.

In one embodiment, a UE is configured to measure the DL delta propagation delay of DL reference signals.

The UE is configured or determines a reference signal (RS1) to use for DL reference timing. For example, the reference signal can be a reference associated with a source RS (e.g., QCL Type A or QCL Type B or QCL Type C or QCL Type D or spatial relation source RS) of an indicated TCI state. The indicated TCI state can be a joint TCI state or an UL TCI state.

The UE detects a reference signal (RS2) with a signal quality (e.g., RSRP or SINR) that exceeds a threshold X, wherein X is configured/updated by RRC signaling and/or MAC CE signaling and/or L1 control (DCI) signaling.

The UE measures the “DL delta propagation delay” between RS1 and RS2. Ifthe “DL delta propagation delay” exceeds a threshold Y, wherein Y is configured/updated by RRC signaling and/or MAC CE signaling and/or L1 control (DCI) signaling, the UE triggers scheduling request. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. The scheduling request configures or activates or triggers a sounding reference signal (SRS) transmission from the UE for the network to measure the arrival time of the SRS transmitted by the UE at a TRP, and accordingly determine the TA value for transmissions towards the TRP.

In one example, the SRS configured is a periodic SRS.

In one example, the SRS activated is a semi-persistent SRS. The network activates the semi-persistent SRS when the threshold X is exceeded.

In one example, the SRS triggered is an aperiodic SRS. The network triggers the aperiodic SRS when the threshold X is exceeded.

In one example, the network can configure an SR (scheduling request) resource for each TRP. The UE can trigger the SR of the TRP for which it would like the network to measure timing information.

In one example, the network can configure one SR (scheduling request) resource. The UE can trigger the SR of a determined TRP (e.g., TRP B) for which the network measures timing information.

In one example, TAG or the TA value associated with an entity (e.g., a TRP or a panel or a cell a CORESETPOOLIndex) is sent from entity associated with the TAG or TA value.

In one example, TAG or the TA value associated with an entity (e.g., a TRP or a panel or a cell a CORESETPOOLIndex) can be sent from another entity not associated with the TAG or TA value.

In one example, two TAGs or the TA values can be sent from the same entity (e.g., a TRP or a panel or a cell a CORESETPOOLIndex). In one example two TAGs or the TA values can be sent from the same entity in a same transmission, e.g., a same MAC CE.

In some examples, the network triggers a random access (RACH) procedure from the UE (e.g., through a PDCCH order) towards a non-serving cell e.g., to acquire a TA before handover or cell switch to that non-serving cell (or target cell or candidate cell). The event to trigger this procedure can be based on signaling from the UE, or based on the gNB's implementation.

In one example, a UE is configured to provide a measurement report for reference signals, the UE is configured reference signals to measure. The reference signals can be:
Associated with different TRPs that belong to the same cell.
Associated with different cells, e.g., some reference signals are associated with a serving cell, while other reference signals are associated with a cell having a PCI different from the PCI of the serving cell (e.g., non-serving cell). There could also be other reference signals associated with other non-serving cells and so on.

The UE can be configured to provide a measurement report that includes at least K quantiles. Wherein, each quantity includes:
A reference signal ID (e.g., CSI-RS resource ID (CRI) or SSB resource ID SSBRI)
A metric quality associated with the corresponding reference signal, e.g., RSRP or SINR

In one example, if a reference signal provided in the measurement report is received with a timing difference that exceeds a threshold (e.g., the threshold is Y), the UE indicates in the measurement report that the timing of the reference signal exceeds a threshold. Wherein, the timing difference is a difference between the receive timing of the reference signal and receive timing of a reference signal of the serving cell (or a reference TRP, wherein the reference TRP can be indicated or configured to the UE). In one example, the network can indicate the reference signal of the serving cell (or the reference TRP) to be used for time difference measurement. In another example, it can be up to the UE to determine such reference signal for the serving cell (or the reference TRP). In one example, Y is configured/updated by RRC signaling and/or MAC CE signaling and/or L1 control (DCI) signaling. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured.

In one example, there is an indicator for each quantity of the K quantities in the measurement report. Wherein, each quantity includes:
A reference signal ID (e.g., CSI-RS resource ID (CRI) or SSB resource ID SSBRI)
A metric quality associated with the corresponding reference signal, e.g., RSRP or SINR
An indictor if the time difference to a reference RS exceeds a threshold. For example, the indicator can be “1” if the time difference exceeds a threshold or “0” otherwise, or vice versa.

In another example, the indicator is common to all K quantities in the measurement report. Wherein, the indicator is “1” if the time difference of any of the RSes in the measurement report to a reference RS exceeds a threshold, or “0” otherwise, or vice versa.

In another example, the measurement report includes reference signals for N entities. For example, the N entities can be one of:
N non-serving cells, in which case, the measurement report includes N indicators, one indicator for each non-serving cell. The order of the indicators can be based on the index of the non-serving cells with RSes in the measurement report, e.g., in ascending order or in descending order. Alternatively, the order of the indicators can be based on the order in which RSes of the corresponding non-serving cells appear in the measurement report. In one example, the indicator can be “1” if the time difference between all the RSes associated with the corresponding non-serving cell and the reference RS exceeds a threshold or “0” otherwise, or vice versa. In another example, the indicator can be “1” if the time difference between any RS associated with the corresponding non-serving cell and the reference RS exceeds a threshold or “0” otherwise, or vice versa. In another example, the indicator can be “1” if the average time difference between the RSes associated with the corresponding non-serving cell and the reference RS exceeds a threshold or “0” otherwise, or vice versa.
N−1 non-serving cells and one serving cell, in which case, the measurement report includes N−1 indicators, one indicator for each non-serving cell. The order of the indicators can be based on the index of the non-serving cells with RSes in the measurement report, e.g., in ascending order or in descending order. Alternatively, the order of the indicators can be based on the order in which RSes of the corresponding non-serving cells appear in the measurement report. In one example, the indicator can be “1” if the time difference between all the RSes associated with the corresponding non-serving cell and the reference RS exceeds a threshold or “0” otherwise, or vice versa. In another example, the indicator can be “1” if the time difference between any RS associated with the corresponding non-serving cell and the reference RS exceeds a threshold or “0” otherwise, or vice versa. In another example, the indicator can be “1” if the average time difference between the RSes associated with the corresponding non-serving cell and the reference RS exceeds a threshold or “0” otherwise, or vice versa.
N−1 non-serving cells and one serving cell in which case, the measurement report includes N indicators, one indicator for each non-serving cell and an indicator for the serving cell. The order of the indicators can be based on the index of the non-serving cells with RSes in the measurement report, e.g., in ascending order or in descending order. Alternatively, the order of the indicators can be based on the order in which RSes of the corresponding non-serving cells appear in the measurement report. In one example, the indicator can be “1” if the time difference between all the RSes associated with the corresponding non-serving cell and the reference RS exceeds a threshold or “0” otherwise, or vice versa. In another example, the indicator can be “1” if the time difference between any RS associated with the corresponding non-serving cell and the reference RS exceeds a threshold or “0” otherwise, or vice versa. In another example, the indicator can be “1” if the average time difference between the RSes associated with the corresponding non-serving cell and the reference RS exceeds a threshold or “0” otherwise, or vice versa. In one example, the indicator for the serving cell can always indicate that the time difference for the RSes of the serving cell is less than a threshold.

In one example, the indication of the time difference between an RS and the reference RS can be reported in a message separate from the beam measurement report.

In one example, the UE can report the actual time difference between an RS and reference RS. For example, the beam measurement report includes K quantities. Wherein, each quantity includes:
A reference signal ID (e.g., CSI-RS resource ID (CRI) or SSB resource ID SSBRI)
A metric quality associated with the corresponding reference signal, e.g., RSRP or SINR
The time difference between the RS and the reference RS. In one example, the time difference is always included. In another example, the time difference is included if it exceeds a threshold.

In one example, the reference RS is a virtual reference RS, corresponding to the timing of the TA signaled to the UE.

In one example, the UE is further configured with PRACH configuration information for the non-serving cell, e.g., RACH-ConfigCommon or RACH-ConfigCommonTwoStepRA of the non-serving cell, that includes information about the PRACH Occasions (RO) to use in the time and frequency domains as well as information about the RACH preamble signatures. The UE may further be configured information about dedicated preamble(s) to use in case of contention free random access in the non-serving cell. In one example, when the UE determines or is configured to send a preamble to a non-serving cell, the UE selects a preamble and RO based on the PRACH configuration of the non-serving cell and the corresponding selected reference signal (e.g., SSB) of the non-serving cell.

In one example, if a network receives a measurement report or other message that indicates that the time difference of a RS to a reference RS exceeds a threshold, the network triggers a RACH PDCCH order towards the non-serving cell with the RS that has a timing difference exceeding the threshold.

In one example, the network can trigger a RACH PDCCH order towards the non-serving cell based on its own implementation (e.g., regards of any timing difference indication it might receive from the network.

In other examples, the UE triggers a random access (RACH) procedure towards a non-serving cell to acquire a TA before handover or cell switch to that non-serving cell (or target cell or candidate cell). The event to trigger this procedure can be based on measurements performed by the UE (e.g., signal strength measurements and/or time difference measurements). The signal strength measurement (e.g., RSRP or SINR) can be that of an RS from the non-serving cell (e.g., exceeds a threshold or exceeds the signal strength of an RS from the serving cell by a threshold). The time difference measurement can be the difference in the time of arrival between an RS from the serving cell and that of the non-serving cell.

In one example, the UE is configured reference signals to measure as previously described. The UE is configured to provide a measurement report as previously described. If a UE provides a reference signal in measurement report and the timing difference between the RS and a reference RS (e.g., associated with the serving cell or reference TRP or the TA of the serving cell or reference TRP) exceeds a threshold Y as previously described. The UE triggers a random access (RACH) procedure towards the cell (or TRP) associated with the RS in the measurement report with a timing difference that exceeds the threshold Y, using the RACH configuration of the cell. The random access procedure can a contention based random access (CBRA) procedure, or a contention free random access (CFRA) procedure as previously described.

In one example, the UE is configured reference signals to measure as previously described. If an RS is configured as an RS for measurement and the timing difference between the RS and a reference RS (e.g., associated with the serving cell or reference TRP or the TA of the serving cell or reference TRP) exceeds a threshold Y as previously described. The UE triggers a random access (RACH) procedure towards the cell (or TRP) associated with the measurement RS with a timing difference that exceeds the threshold Y, using the RACH configuration of the cell. The random access procedure can a contention based random access (CBRA) procedure, or a contention free random access (CFRA) procedure as previously described.

In one example, the UE is configured a list of TCI states (e.g., DL_Joint TCI states or UL TCI states). The configured TCI states have associated source RS, wherein the source RS can be a source RS of QCL Type A or QCL Type B or QCL Type C or QCL Type D. The source RS can be:
Associated with different TRPs that belong to the same cell.
Associated with different cells, e.g., some source RS resources are associated with a serving cell, while other source RS resources are associated with a cell having a PCI different from the PCI of the serving cell (e.g., non-serving cell). There could also be other reference signals associated with other non-serving cells and so on.

The UE can be configured to measure the timing difference between the source RS of a TCI state in the list of configured TCIs and a reference RS (e.g., associated with the serving cell or reference TRP or the TA of the serving cell or reference TRP wherein the reference TRP can be indicated or configured to the UE). In one example, the network can indicate the reference RS of the serving cell (or the reference TRP) to be used for time difference measurement. In another example, it can be up to the UE to determine such reference RS for the serving cell (or the reference TRP).

In one example, if the timing difference exceeds a threshold (e.g., the threshold is Y), the UE triggers a random access (RACH) procedure towards the cell (or TRP) associated with the source RS with a timing difference that exceeds the threshold Y, using the RACH configuration of the cell. In one example, Y is configured/updated by RRC signaling and/or MAC CE signaling and/or L1 control (DCI) signaling. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. The random access procedure can a contention based random access (CBRA) procedure, or a contention free random access (CFRA) procedure as previously described.

In one example, if the timing difference exceeds a threshold (e.g., the threshold is Y), the UE indicates to the network that the timing difference exceeds a threshold. In one example, this indication can be a beam measurement. In another example this indication can be in message for timing difference indication. The UE can indicate to the network (in the beam measurement report or in the message for timing difference indication) one or more of the following, (1) the RS ID, (2) the cell ID associated with the RS, (3) the value of the timing difference, (4) an indication (implicit or explicit) that the timing difference exceed threshold Y. In one example, Y is configured/updated by RRC signaling and/or MAC CE signaling and/or L1 control (DCI) signaling. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. In response to the received messaged, the network can trigger a RACH PDCCH order towards the non-serving cell with the RS that has a timing difference exceeding the threshold.

In one example, the UE is configured a list of TCI states (e.g., DL_Joint TCI states or UL TCI states). The configured TCI states have associated source RS, wherein the source RS can be a source RS of QCL Type A or QCL Type B or QCL Type C or QCL Type D. The source RS can be:
Associated with different TRPs that belong to the same cell.
Associated with different cells, e.g., some source RS resources are associated with a serving cell, while other source RS resources are associated with a cell having a PCI different from the PCI of the serving cell (e.g., non-serving cell). There could also be other reference signals associated with other non-serving cells and so on.

The UE is further configured a set of activated TCI states from the list of configured TCI states. The activated TCI states have associated source RS, wherein the source RS can be a source RS of QCL Type A or QCL Type B or QCL Type C or QCL Type D. The source RS can be:
Associated with different TRPs that belong to the same cell.
Associated with different cells, e.g., some source RS resources are associated with a serving cell, while other source RS resources are associated with a cell having a PCI different from the PCI of the serving cell (e.g., non-serving cell). There could also be other reference signals associated with other non-serving cells and so on

The UE can be configured to measure the timing difference between the source RS of a TCI state in the set of activated TCIs and a reference RS (e.g., associated with the serving cell or reference TRP or the TA of the serving cell or reference TRP wherein the reference TRP can be indicated or configured to the UE). In one example, the network can indicate the reference RS of the serving cell (or the reference TRP) to be used for time difference measurement. In another example, it can be up to the UE to determine such reference RS for the serving cell (or the reference TRP).

In one example, if the timing difference exceeds a threshold (e.g., the threshold is Y), the UE triggers a random access (RACH) procedure towards the cell (or TRP) associated with the source RS with a timing difference that exceeds the threshold Y, using the RACH configuration of the cell. In one example, Y is configured/updated by RRC signaling and/or MAC CE signaling and/or L1 control (DCI) signaling. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. The random access procedure can a contention based random access (CBRA) procedure, or a contention free random access (CFRA) procedure as previously described.

In one example, if the timing difference exceeds a threshold (e.g., the threshold is Y), the UE indicates to the network that the timing difference exceed a threshold. In one example, this indication can be a beam measurement. In another example this indication can be in message for timing difference indication. The UE can indicate to the network (in the beam measurement report or in the message for timing difference indication) one or more of the following, (1) the RS ID, (2) the cell ID associated with the RS, (3) the value of the timing difference, (4) an indication (implicit or explicit) that the timing difference exceed threshold Y. In one example, Y is configured/updated by RRC signaling and/or MAC CE signaling and/or L1 control (DCI) signaling. In one example the threshold Y can be specified in the system specifications, e.g., Y equals half the cyclic prefix, or Y equals quarter the cyclic prefix, or Y equals the cyclic prefix. In one example, a value Y specified in the system specifications (e.g., default value) can be used, unless a different value is configured. In response to the received messaged, the network can trigger a RACH PDCCH order towards the non-serving cell with the RS that has a timing difference exceeding the threshold.

In one example, the network can configure a UE whether or not to perform a random access (RACH) procedure towards a non-serving cell, if the timing difference according to previous examples exceeds a threshold Y. Where, the timing difference is configured/determined as previously described and Y is configured/determined as previously described.

In one example, a PDCCH order triggers a contention-free random access procedure for an inter-cell multi-TRP scenario to determine a TA.

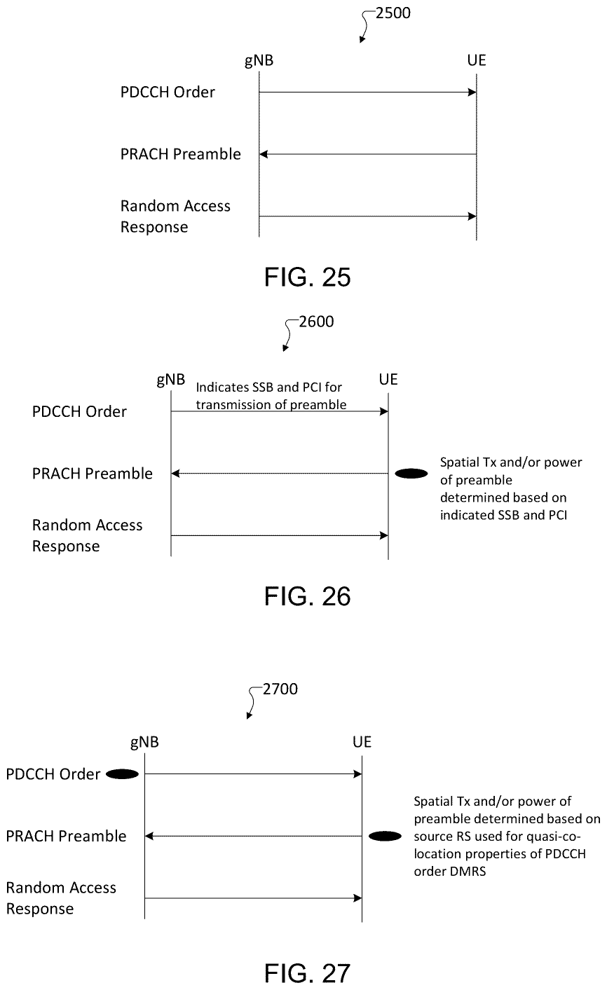

FIG. 25 illustrates an example 2500 of a PDCCH order triggered CFRA procedure according to embodiments of the present disclosure. The embodiment of a PDCCH order triggered CFRA procedure of FIG. 25 is for illustration only. Different embodiments of a PDCCH order triggered CFRA procedure could be used without departing from the scope of this disclosure.

In the example of FIG. 25, the following aspects are considered:
The TRP, beam and/or quasi-co-location properties used to transmit the PDCCH order.
The resource for the preamble transmission, wherein the resource includes the PRACH Occasion and the preamble index.
The spatial filter and/or transmit power used to transmit the preamble.
The quasi-co-location for the random access response.

In one example, the PDCCH order is transmitted from a TRP associated with the serving cell, e.g., the TCI state of the PDCCH order includes one or more source RS (e.g., of QCL TypeD and/or QCL TypeA) and the one or more source RS are associated (e.g., through QCL relation) with an SSB of the serving cell. In this example, the PDCCH order (transmitted from a TRP of the serving cell) triggers a preamble that is transmitted to a TRP of the serving cell or a TRP of a non-serving cell). The PDCCH order can trigger a preamble transmitted to a different TRP than that of the PDCCH order, e.g., the spatial filter and/or transmit power of the preamble can be based on an SSB of cell (or TRP) different from the cell (or TRP) of the PDCCH order. In one example, the PDCCH order includes a PCI of a cell on which the triggered RACH procedure is associated with, i.e., to which the preamble is transmitted to, the spatial transmit filter and/or power of the transmitted preamble is based on an SSB associated with the cell. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). In one example, the PCI field has a size of N-bits, wherein, N=┌log₂(maxNrofAdditionalPCI+1)┐. In one example, maxNrofAdditionalPCI=7, and N=3 bits. In one example, if the PCI field is 0, this indicates a serving cell, else the PCI indicates the additional PCI index of a non-serving cell. In another example, the PDCCH order includes a flag, that indicates whether the preamble is triggered for the serving cell, or another cell (e.g., one of the cells corresponding to additionalPCIIndex).

In one example, the SSB used to determine the transmit power of the preamble is configured or activated or indicated as a PL-RS before the transmission of the PDCCH order. In one example, the SSB is known to UE at the time of triggering of the PDCCH order. In example, the time between the configuration or activation or indication of the SSB as PL-RS and the time of the PDCCH is T. In one example, T is measured from the channel (start or end) conveying the configuration or activation or indication of the SSB as PL-RS, in a further example, the channel is positively acknowledged. In one example, T is measured from the channel (start or end) conveying a HARQ-ACK to the channel conveying the configuration or activation or indication of the SSB as PL-RS, in a further example, the HARQ-ACK is a positive acknowledgement (ACK), in a further example, the HARQ-ACK is a positive acknowledgement (ACK) or a negative acknowledgement (NACK).

In one example, e.g., T is measured from channel conveying HARQ-ACK:

$$T = 3 {N}_{slot}^{subframe , µ} + NM * ⌈ \frac{5 * {T}_{target \_ PL - RS} + 2 ms}{NR slot length} ⌉$$

In one example, e.g., T is measured from channel conveying configuration, activation or indication of SSB as PL-RS:

$$T = {T}_{HARQ} + 3 {N}_{slot}^{subframe , µ} + NM * ⌈ \frac{5 * {T}_{target \_ PL - RS} + 2 ms}{NR slot length} ⌉$$

Wherein,
Nₛₗₒₜ^{subframe,μ} is the number of slots per subframe for sub-carrier spacing.
If SSB configured as PL-RS is not maintained by UE, NM=1
Else NM=0. In one example, a SSB configured as PL-RS is considered as not being maintained. In one example, a SSB configured as PL-RS is considered as being maintained.
T_{target_PL-RS} is the periodicity of the SSB configured as PL-RS
T_{HARQ} is HARQ latency between sending a channel and getting the HARQ-ACK feedback.

In one example, the SSB being configured or activated or indicated as PL-RS is known at the time of configuration or activation or indication.

In one example, the SSB being configured or activated or indicated as PL-RS is not known at the time of configuration or activation or indication, an additional delay, T₁, is added to T for the SSB to be known. Where, T₁ includes additional Rx time for beam refinement.

The pathloss reference signal (e.g., SSB) is known if the following conditions are met during the period between the last transmission of the RS resource used for L1-RSRP measurement reporting and the completion of pathloss reference signal switch, where the RS resource is the target pathloss reference signal or QCLed (with Type D) to the target pathloss reference signal.
Pathloss reference signal switch command is received within 1280 ms upon the last transmission of the RS resource for beam reporting or measurement
The UE has sent at least 1 L1-RSRP report for the target pathloss reference signal before the pathloss reference signal switch command
The target pathloss reference signal remains detectable during the pathloss reference signal switching period
   SNR of the target pathloss reference signal≥−3 dB
The associated SSBs with the target pathloss reference signal remain detectable during the pathloss reference signal switching period
   SNR of the associated SSB≥−3 dB
      Otherwise, the pathloss reference signal is unknown.

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB.

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB. The cell with the PCI associated with the SSB can have no activated TCI states (e.g., inactive PCI or additional PCI).

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB. The cell with the PCI associated with the SSB has activated TCI states (e.g., active PCI or additional PCI).

In one example, when the UE measures an SSB (e.g., of a serving cell, or of a cell having a PCI different from the PCI of the serving), the UE can determine a pathloss associated with the SSB. The UE can transmit a PRACH preamble associated with the SSB using a transmit power determined based on the pathloss associated with the SSB. The SSB is associated with activated TCI states (e.g., the TCI state has a source RS that is directly or indirectly associated (e.g., QCLed) with the SSB).

In one example, a UE capability can determine whether the SSB used for the pathloss measurement is associated with a cell that is one of:
The cell has active TCI states (e.g., active PCI or additional PCI);
The cell can have no active TCI states.

In one example, if a UE can determine the pathloss from an SSB associated with a cell having a PCI, e.g., provided by additionalPCIIndex, and the cell has no active TCI state or TCI state codepoints, e.g., the additionalPCIIndex is inactive, then PRACH can be triggered to a cell with an inactive additionalPCIIndex. Else, if the UE can't determine the pathloss from an SSB associated with a cell having a PCI, e.g., provided by additionalPCIIndex, and the cell has no active TCI state or TCI state codepoints, e.g., the additionalPCIIndex is in inactive, then PRACH is triggered to a cell with an active additionalPCIIndex (e.g., with active TCI states or TCI state codepoints). In one example, this can be based on a UE capability.

In one example, the PDCCH order is transmitted from a TRP associated with the serving cell or with a cell of a configured additionalPCIIndex, e.g., the TCI state of the PDCCH order includes one or more source RS (e.g., of QCL TypeD and/or QCL TypeA) and the one or more source RS are associated with (e.g., through QCL relation) an SSB of the serving cell or an SSB of a cell of a configured additionalPCIIndex (e.g., inter-cell PDCCH order). In this example, the following sub-examples are possible.
In one sub-example, the PDCCH order is transmitted from a TRP of one cell, and it triggers a preamble that can be transmitted to a TRP of another cell, e.g., the spatial filter and/or transmit power of the preamble can be based on an SSB of cell (or TRP) different from the cell (or TRP) of the PDCCH order. In one example, the PDCCH order includes a PCI of a cell on which the triggered RACH procedure is associated with, i.e., to which the preamble is transmitted to, the spatial transmit filter and/or power of the transmitted preamble is based on an SSB associated with the cell. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). In one example, the PCI field has a size of N-bits, wherein, N=┌log₂(maxNrofAdditionalPCI+1)┐. In one example, maxNrofAdditionalPCI=7, and N=3 bits. In one example, if the PCI field is 0, this indicates a serving cell, else the PCI indicates the additional PCI index of a non-serving cell. In another example, the PDCCH order includes a flag (or indicator), that indicates whether the preamble is triggered for the serving cell, or another cell (e.g., one of the cells corresponding to additionalPCIIndex).
In one sub-example, the PDCCH order is transmitted from a TRP of a cell, and it triggers a preamble transmitted to a TRP (for example the same TRP used for the PDCCH order) of the same cell, e.g., the spatial filter and/or transmit power of the preamble can be based on an SSB of the cell (or TRP) of the PDCCH order.
In one sub-example, if the PDCCH order is triggered from a TRP associated with the serving cell (e.g., the TCI state of the PDCCH order is QCLed with a source RS of the serving cell directly or indirectly), the PRACH preamble can be sent to the serving cell or a non-serving cell as aforementioned. If the PDCCH order is triggered from a TRP associated with a cell having a PCI different from the PCI of the serving cell (e.g., the TCI state of the PDCCH order is QCLed with a source RS of the cell that has a PCI different from the PCI of the serving cell directly or indirectly), the PRACH preamble can be sent to the cell having a PCI different from the PCI of the serving cell.
In one sub-example, if the PDCCH order is triggered from a TRP associated with the serving cell (e.g., the TCI state of the PDCCH order is QCLed with a source RS of the serving cell directly or indirectly), the PRACH preamble can be sent to the serving cell or a non-serving cell as aforementioned. If the PDCCH order is triggered from a TRP associated with a cell having a PCI different from the PCI of the serving cell (e.g., the TCI state of the PDCCH order is QCLed with a source RS of the cell that has a PCI different from the PCI of the serving cell directly or indirectly) (e.g., inter-cell PDCCH order), the PRACH preamble can be sent to a cell having a PCI different from the PCI of the serving cell (e.g., to a non-serving cell).

In one example, the SSB used to determine the transmit power of the preamble is configured or activated or indicated as a PL-RS before the transmission of the PDCCH order, as described earlier in this disclosure.

The resource used for the preamble is determined by a PRACH Occasion and a preamble index within the PRACH Occasion. The preamble index can be indicated by the PDCCH order. The PRACH Occasion is determined based on an SSB or a CSI-RS resource to which the preamble is associated with, through an association pattern as described. In Rel-15 the association pattern is defined for the SSBs of the serving cell only. However, in case of inter-cell multi-TRP, there are SSBs associated with the serving cell as well as SSBs associated with cells corresponding to the additionalPCIIndex. Hence, one option is to define a new PRACH configuration to cover serving cell SSBs as well as SSBs on cells corresponding to the additionalPCIIndex.

In one example, the new PRACH configuration can be used for transmission of preambles associated with the serving cell and cells corresponding to the additionalPCIIndex.

In one example, the new PRACH configuration can be used for transmission of preambles associated with cells corresponding to the additionalPCIIndex. The PRACH configuration of NR release 15, can be used for transmission of preambles associated with the serving cell.

In one example, the new PRACH configuration can be used for transmission of preambles associated with cells corresponding to the additionalPCIIndex. A higher layer parameter (e.g., by RRC configuration and/or MAC CE configuration) can indicate whether the preambles associated with the serving cell are transmitted using (1) the new PRACH configuration or (2) the PRACH configuration of NR release 15.

In one example, the new PRACH configuration can be used for transmission of preambles associated with cells corresponding to the additionalPCIIndex. An indicator (e.g., a flag) in the PDCCH order can indicate whether the preambles associated with the serving cell are transmitted using (1) the new PRACH configuration or (2) the PRACH configuration of NR release 15.

In one example, a separate PRACH configuration is provided for each additionalPCIIndex. The PRACH configuration association with an additionalPCIIndex can be used for transmission of preambles associated with cells corresponding to the additionalPCIIndex. The PRACH configuration of NR release 15, can be used for transmission of preambles associated with the serving cell.

The following examples can be considered for the new PRACH configuration.
The association is based on PCI-SSB pairs, i.e., each PCI-SSB pair is associated with an RO
The association is based on SSBs, where the SSBs is a super set of SSB-indices configured across all cells as provided by ssb-PositionsInBurst. In one example, “all cells” includes serving cell and cells corresponding to additionalPCIIndex. In another example, “all cells” includes cells corresponding to additionalPCIIndex.

In one example, the SSBs for cells corresponding to the additionalPCIIndex are the configured additionalPCIIndex. There can be a maximum of 7 configured additionalPCIIndex determined by maxNrofAdditionalPCI-r17=7. In another example, the SSBs for cells corresponding to the additionalPCIIndex are cell(s) of additionalPCIIndex with active TCI states, wherein a cell is considered to have an active TCI state if the source RS of the active TCI state is associated through a quasi-co-location with an SSB of the cell. Active TCI states are the TCI states activated by MAC CE as described in TS 38.321 clause 5.18.23 and 6.1.3.47. In one example, active TCI states (or TCI state codepoints or active spatial relations) can be associated with serving cell and one other cell corresponding to additionalPCIIndex. In example, active TCI states (or TCI state codepoints or active spatial relations) can be associated with serving cell and one or more other cell corresponding to additionalPCIIndex. Therefore, the following examples are considered for associated between PRACH Occasions and SSBs for the new RACH configuration
The association is based on SSBs of serving cell and SSBs of cells corresponding to the configured additionalPCIIndex.
The association is based on SSBs of serving cell and SSBs of cells with MAC CE activated TCI states corresponding to the configured additionalPCIIndex(s).
The association is based on SSBs of cells corresponding to the configured additionalPCIIndex.
The association is based on SSBs of cells with MAC CE activated TCI states corresponding to the configured additionalPCIIndex(s).

In one example, a UE is configured with a new PRACH configuration. For example, a new RACH-ConfigGeneric and/or RACH-ConfigDedicated e.g., to be used for inter-cell multi-TRP.

The UE is configured additional PCIs and SSBs associated with the additional PCIs. For example, the UE can be configured with CSI-SSB-ResourceSet that includes a list of additional PCI indices given by servingAdditionalPCIList.

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF |

```
  SSB-Index,
  ...,
  [[
    servingAdditionalPCIList-r17 SEQUENCE (SIZE(1..maxNrofCSI-SSB-ResourcePerSet))
    OF ServingAdditionalPCIIndex-r17 OPTIONAL -- Need R
  ]]
}
```

Wherein, maxNrofCSI-SSB-ResourcePerSet is 64.

And wherein, servingAdditionalPCIList indicates the physical cell IDs (PCI) of the SSBs in the csi-SSB-ResourceList. If present, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. For each entry, the following applies:
If the value is zero, the PCI is the PCI of the serving cell in which this CSI-SSB-ResourceSet is defined;
otherwise, the value is additionalPCIIndex-r17 of an SSB-MTC-AdditionalPCI-r17 in the additionalPCIList-r17 in ServingCellConfig, and the PCI is the additionalPCI-r17 in this SSB-MTC-AdditionalPCI-r17.

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, |

spare2, spare1 },

| | |
|---|---|
| ssb-PositionsInBurst-r17 | CHOICE { |
| | shortBitmap BIT STRING (SIZE (4)), |
| | mediumBitmap BIT STRING (SIZE (8)), |
| | longBitmap BIT STRING (SIZE (64)) |

},

| | |
|---|---|
| ss-PBCH-BlockPower-r17 | INTEGER (−60..50) |

}

Wherein, AdditionalPCIIndex-r17::=INTEGER(1..maxNrofAdditionalPCI-r17), and maxNrofAdditionalPCI is 7.

Wherein, ssb-PositionsInBurst indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

For association SSBs with ROs for the new PRACH configuration, the number of SSBs to be associated with ROs is given by of the following examples:
In one example, the number of SSBs to be associated with ROs is obtained from CSI-SSB-ResourceSet, based on SSB indices in the list csi-SSB-ResourceList that are associated with an additional PCI as given by servingAdditionalPCIList, (i.e., SSBs associated with the serving cell (having a value of zero in the corresponding entry in servingAdditionalPCIList) are excluded). The association order of SSBs to ROs can be based on the order of SSBs in csi-SSB-ResourceList associated with an additional PCI. In a variant of this example, only SSBs of cells with MAC CE activated TCI states are considered.

In one example, the number of SSBs to be associated with ROs is the sum of the number of SSBs configured for each AdditionalPCIIndex obtained from the corresponding ssb-PositionsInBurst. Let, N_{Tx-total}^{SSB} be the total number of SSBs to be associated with PRACH Occasions,

$${N}_{Tx - Total}^{SSB} = {\sum }_{Configured AdditionalPCIIndex} {N}_{Tx}^{SSB} ( AdditionalPCIIndex )$$

Where,
N_{Tx}^{SSB} (AdditionalPCIIndex) can be obtained from ssb-PositionsInBurst corresponding to SSB-MTC-AdditionalPCI, for example, the number bits in the bitmap with value equal to 1. The association order of SSBs to ROs can be based on:
   First, the order of the SSBs in the corresponding ssb-PositionsInBurst bit map.
   The order of the configured AdditionalPCIIndex, for example as provided in ServingCellConfig
ServingCellConfig->mimoParam-r17->additionalPCI-ToAddModList-r17 SEQUENCE (SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example the number of SSBs to be associated with ROs is obtained from CSI-SSB-ResourceSet, based on SSB indices in the list csi-SSB-ResourceList that are associated with the serving cell PCI, or an additional PCI as given by servingAdditionalPCIList. The association order of SSBs to ROs can be based on the order of SSBs in csi-SSB-ResourceList. In a variant of this example, only SSBs of cells with MAC CE activated TCI states are considered.

In one example, the number of SSBs to be associated with ROs is the sum of the number of SSBs configured for the serving cell, obtained from ssb-PositionsInBurst in SIB1 or in ServingCellConfigCommon, and for each AdditionalPCIIndex, obtained from the corresponding ssb-PositionsInBurst. Let, N_{Tx-Total}^{SBB} be the total number of SSBs to be associated with PRACH Occasions,

$${N}_{Tx - Total}^{SSB} = {\sum }_{Seving cell and Configured AdditionalPCIIndex} \text{} {N}_{Tx}^{SSB} \text{} ( Serving cell or AdditionalPCIIndex )$$

Where,
N_{Tx}^{SSB}(ServingCell) can be obtained from ssb-PositionsInBurst in SIB1 or in ServingCellConfigCommon.
N_{Tx}^{SSB}(AdditionalPCIIndex) can be obtained from ssb-PositionsInBurst corresponding to SSB-MTC-AdditionalPCI, for example, the number bits in the bitmap with value equal to 1. The association order of SSBs to ROs can be based on:
   First, the order of the SSBs in the corresponding ssb-PositionsInBurst bit map.
   Second, SSBs of serving cell followed by the order of the configured AdditionalPCIIndex, for example as provided in ServingCellConfig
ServingCellConfig->mimoParam-r17->additionalPCI-ToAddModList-r17 SEQUENCE (SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with the serving cell, the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example, each AdditionalPCIIndex has an associated ssb-PositionsInBurst as provided by SSB-MTC-AdditionalPCI, the bit maps of ssb-PositionsInBurst for the cells corresponding to AdditionalPCIIndex are ORed together, i.e., creating a super set of the union of the SSBs used in the cells corresponding to AdditionalPCIIndex. N_{Tx-Total}^{SBB} can be obtained from the resulting super set (the result of the aforementioned OR operation). The association order of SSBs to ROs can be based on the order of the SSBs in the resulting super set of SSBs. In a variant of this example, only SSBs of cells with MAC CE activated TCI states are considered.

In one example, each AdditionalPCIIndex has an associated ssb-PositionsInBurst as provided by SSB-MTC-AdditionalPCI, the bit maps of (1) ssb-PositionsInBurst for the cells corresponding to AdditionalPCIIndex, as well the bit map of (2) ssb-PositionsInBurst of the serving cell included in SIB1 or in ServingCellConfigCommon are ORed together, i.e., creating a super set of the union of the SSBs used in the cells corresponding to AdditionalPCIIndex and the serving cell. N_{Tx-Total}^{SBB} can be obtained from the resulting super set (the result of the aforementioned OR operation). The association order of SSBs to ROs can be based on the order of the SSBs in the resulting super set of SSBs. In a variant of this example, only SSBs of cells with MAC CE activated TCI states are considered.

In one example, ssb-PositionsInBurst of the serving cell included in SIB1 or in ServingCellConfigCommon are considered for N_{Tx-Total}^{SBB}. The association order of SSBs to ROs can be based on the order of the SSBs in ssb-PositionsInBurst of the serving cell. For a RACH preamble triggered by a PDCCH order, the PDCCH provides the resource (i.e., preamble index and PRACH Occasion) to use for transmitting the preamble. The PRACH occasion can be based on the SSB of the serving cell. The SSB used to determine the spatial filter and/or power of the preamble can be determined based on additional indication in the PDCCH order or the SSB used for quasi-co-location properties of DMRS of the PDCCH order.

In one example, the SSB used to determine the transmit power of the preamble is configured or activated or indicated as a PL-RS before the transmission of the PDCCH order, as described earlier in this disclosure.

In one example, there is no new PRACH configuration, the PRACH configuration of Rel-15 can be used for sending the PDCCH order trigger preamble transmitted to a serving cell or a cell associated with the additionalPCIIndex. For a RACH preamble triggered by a PDCCH order, the PDCCH provides the resource (i.e., preamble index and PRACH Occasion) to use for transmitting the preamble. The PRACH occasion can be based on the SSB of the serving cell. The SSB used to determine the spatial filter and/or power of the preamble can be determined based on additional indication in the PDCCH order or the SSB used for quasi-co-location properties of DMRS of the PDCCH order.

In one example, the SSB used to determine the transmit power of the preamble is configured or activated or indicated as a PL-RS before the transmission of the PDCCH order, as described earlier in this disclosure.

In one example, the PDCCH order includes at least (1) Random Access Preamble index, (2) SS/PBCH index, (3) PRACH Mask index, and (4) PCIIndex or PCI Flag, which can identify the PRACH preamble and the PRACH occasion to be used for the preamble transmission.

In one example, the PCIIndex can be:
With a value of zero, then the PCI is the PCI of the serving cell in which this CSI-SSB-ResourceSet is defined. In this example, a PCI determines the PRACH Occasion for the transmission of the preamble.
With another value corresponding to the additionalPCIIndex-r17 of an SSB-MTC-AdditionalPCI-r17 in the additionalPCIList-r17 in ServingCellConfig, then the PCI is the additionalPCI-r17 in this SSB-MTC-AdditionalPCI-r17. In this example, a PCI determines the PRACH Occasion for the transmission of the preamble.
The PCIIndex is not included in the PDCCH order, in which case the determined PRACH Occasion for the transmission of the preamble is agnostic of the PCIIndex.

In another example, the PCIIndex can be:
With a value corresponding to the additionalPCIIndex-r17 of an SSB-MTC-AdditionalPCI-r17 in the additionalPCIList-r17 in ServingCellConfig, then the PCI is the additionalPCI-r17 in this SSB-MTC-AdditionalPCI-r17. In this example, a PCI determines the PRACH Occasion for the transmission of the preamble. In one example, if the PCIIndex is 0, this corresponds to the cell that triggered by the PDCCH order. In one example, if the PCIIndex is 0, this corresponds to the serving cell.
The PCIIndex is not included in the PDCCH order, in which case the determined PRACH Occasion for the transmission of the preamble is agnostic of the PCIIndex.

In one example, the PCI Flag can be:
With a value of zero, then the PCI is the PCI of the serving cell in which this CSI-SSB-ResourceSet is defined. This for example can correspond to a first TAG ID (e.g., TAG ID 0).
With a value of one, then the UE selects a PCI corresponding to the additionalPCIIndex-r17 of an SSB-MTC-AdditionalPCI-r17 in the additionalPCIList-r17 in ServingCellConfig. For example, the selection can be based on the cell with active TCI states (or TCI state codepoints or active spatial relations). In another example, the selection can be based RRC configuration and/or MAC CE signaling and/or L1 control signaling, e.g., the network can signal the UE the additionalPCIIndex corresponding to a PCI flag with value 1. This for example can correspond to a second TAG ID (e.g., TAG ID 1).

In one example, PCI Flag can be:
With a value of zero for a first RRC configured and/or MAC CE signaled and/or L1 control signaled additionalPCIIndex. This for example can correspond to a first TAG ID (e.g., TAG ID 0).
With a value of one for a second RRC configured and/or MAC CE signaled and/or L1 control signaled additionalPCIIndex. This for example can correspond to a second TAG ID (e.g., TAG ID 1).

In one example, if PCIflag is zero, or the PCIIndex is zero, the PDCCH order follows the legacy PDCCH order behavior as described in TABLE 1.

In one example, the PDCCH order has a PDCCH format as shown in TABLE 2.

TABLE 2

| Field | Size | | Description |
|---|---|---|---|
| Identifier for DCI formats | 1 | | The value of this bit field |
| | | | is set to 1, indicating a |
| | | | DL DCI format |
| Frequency domain resource | ┌log₂(N_{RB}^{DL, BWP}(N_{RB}^{DL, BWP} + | | Set to all ones |
| assignment | 1)/2)┐ | | |
| Random Access Preamble index | 6 | bits | See description A |
| UL/SUL indicator | 1 | bit | |
| SS/PBCH index | 6 | bits | See description B |
| PRACH Mask index | 4 | bits | See description C |
| PCI Flag | 1 | bit | See description D |

| | |
|---|---|
| Reserved bits | 11 bits or 9 bits |

In one example, the PDCCH order has a PDCCH format as shown in TABLE 3.

TABLE 3

| Field | Size | | Description |
|---|---|---|---|
| Identifier for DCI formats | 1 | | The value of this bit field |
| | | | is set to 1, indicating a |
| | | | DL DCI format |
| Frequency domain resource | ┌log₂(N_{RB}^{DL, BWP}(N_{RB}^{DL, BWP} + | | Set to all ones |
| assignment | 1)/2)┐ | | |
| Random Access Preamble index | 6 | bits | See description A |
| UL/SUL indicator | 1 | bit | |
| SS/PBCH index | 6 | bits | See description B |
| PRACH Mask index | 4 | bits | See description C |
| PCI Index | 3 | bits | See description E |

| | |
|---|---|
| Reserved bits | 9 bits or 7 bits |

### Description A

In one example, if PCI Index or PCI Flag is zero
If “Random Access Preamble index” is non-zero, this field indicates the preamble index to be transmitted for a CFRA-based PDCCH order.
If “Random Access Preamble index” is zero, this field indicates a CBRA-based PDCCH order.

In one example, if PCI Index or PCI Flag is non-zero
If “Random Access Preamble index” is non-zero, this field indicates the preamble index to be transmitted for a CFRA-based PDCCH order.
If “Random Access Preamble index” is zero, this field indicates a CBRA-based PDCCH order.

In one example, if PCI Index or PCI Flag is non-zero
Field “Random Access Preamble index” indicates the preamble index to be transmitted for a CFRA-based PDCCH order.

In one example, if PCI Index or PCI Flag is non-zero
If “Random Access Preamble index” is non-zero, this field indicates the preamble index to be transmitted for a CFRA-based PDCCH order.
Field “Random Access Preamble index” having a value of zero is reserved or not supported.

### Description B

In one example, if PCI Index or PCI Flag is zero
If “Random Access Preamble index” is not zero, “SS/PBCH index” indicates SSB index used for RO association, else “SS/PBCH index” is reserved.

In one example, if PCI Index or PCI Flag is non-zero
If “Random Access Preamble index” is not zero “SS/PBCH index” indicates SSB index used for RO association and to determine the preamble transmit power and possibly preamble spatial filter, else “SS/PBCH index” is reserved.

In one example, if PCI Index or PCI Flag is non-zero
“SS/PBCH index” indicates SSB index used for RO association and to determine the preamble transmit power and possibly preamble spatial filter.

### Description C

In one example, if PCI Index or PCI Flag is zero
If “Random Access Preamble index” is not zero, “PRACH Mask index” indicates RO used, else “PRACH Mask index” is reserved.

In one example, if PCI Index or PCI Flag is non-zero
If “Random Access Preamble index” is not zero “PRACH Mask index” indicates RO used, else “PRACH Mask index” is reserved.

In one example, if PCI Index or PCI Flag is non-zero
“PRACH Mask index” indicates RO used.

### Description D

In one example, if PCI flag is 0, the PRACH transmission is transmitted towards the same TRP that transmits the PDCCH order.

In one example, if PCI flag is 0, the PRACH transmission is transmitted towards the serving cell.

In one example, PDCCH order with a PCI flag with a value 0 is transmitted from the serving cell.

In one example, PDCCH order with a PCI flag with a value 0 can be transmitted from the serving cell or a non-serving cell (e.g., inter-cell PDCCH order).

In one example, the PCI flag can be a TAG ID flag.

In one example, the network can signal by RRC configuration and/or MAC CE signaling and/or L1 control signaling the additionalPCIIndex of the a TRP corresponding to a PCI flag with value 1.

In one example, the network can signal by RRC configuration and/or MAC CE signaling and/or L1 control signaling a first additionalPCIIndex of a TRP corresponding to a PCI flag with value 0 and a second additionalPCIIndex of a TRP corresponding to a PCI flag with value 1.

In one example, a second TRP for a PCI flag with value 1, can be associated with a cell with active TCI states (or TCI state codepoints or active spatial relations).

In one example, if the PCI flag is 0, the legacy behavior of TABLE 1 is followed.

### Description E

In one example, if PCI index is 0, the PRACH transmission is transmitted towards the same TRP that transmits the PDCCH order.

In one example, if PCI Index is 0, the PRACH transmission is transmitted towards the serving cell.

In one example, PDCCH order with a PCI index with a value 0 is transmitted from the serving cell.

In one example, PDCCH order with a PCI index with a value 0 can be transmitted from the serving cell or a non-serving cell (e.g., inter-cell PDCCH order).

In one example, if the PDCCH order is from the serving cell:
If PCI index is 0, the PRACH transmission is transmitted towards the serving cell (e.g., following the legacy behavior, where the SSB to determine the PRACH transmit power is that used for QCL of the PDCCH order, or the SSB to determine the PRACH transmit is that indicated in the PDCCH order).
If the PCI index is non-zero (e.g., indicating cell A), the PRACH transmission is transmitted towards cell A, (e.g., the SSB to determine the PRACH transmit power is that indicated in the PDCCH order for cell A).

In one example, if the PDCCH order is from a cell A having a PCI different from the PCI of the serving cell (e.g., inter-cell PDCCH order):
If PCI index is 0, the PRACH transmission is transmitted towards the serving cell (e.g., where the SSB to determine the PRACH transmit power is that used for QCL of the PDCCH order, or the SSB to determine the PRACH transmit is that indicated in the PDCCH order).
If the PCI index indicates cell A, then one of:
   The PRACH transmission is transmitted towards cell A, and the SSB to determine the PRACH transmit power is that indicated in the PDCCH order for cell A.
   The PRACH transmission is transmitted towards cell A, and the SSB to determine the PRACH transmit power is that used for QCL of the PDCCH order.
If the PCI index is non-zero and different from that of cell A, e.g., indicating cell B, The PRACH transmission is transmitted towards cell A, and the SSB to determine the PRACH transmit power is that indicated in the PDCCH order for cell B.

In one example, if the PDCCH order is from a cell A having a PCI different from the PCI of the serving cell (e.g., inter-cell PDCCH order):
PCI index is 0, the PRACH transmission is transmitted towards cell A. In one example, the SSB to determine the PRACH transmit power is that used for QCL of the PDCCH order (e.g., like legacy PDCCH order). In one example, the SSB to determine the PRACH transmit power is that indicated in the PDCCH order for cell A.
In this example, a PDCCH order from a serving cell can trigger a PRACH transmission towards the serving cell, or a cell with a PCI different from the PCI of the serving cell. A PDCCH order from a cell A having a PCI different from the PCI of the serving cell can trigger a PRACH transmission towards cell A.

In one example, if the PDCCH order is from a cell A having a PCI different from the PCI of the serving cell:
PCI index is that of cell A, the PRACH transmission is transmitted towards cell A. In one example, the SSB to determine the PRACH transmit power is that used for QCL of the PDCCH order (e.g., like legacy PDCCH order). In one example, the SSB to determine the PRACH transmit power is that indicated in the PDCCH order for cell A.
In this example, a PDCCH order from a serving cell can trigger a PRACH transmission towards the serving cell, or a cell with a PCI different from the PCI of the serving cell. A PDCCH order from a cell A having a PCI different from the PCI of the serving cell can trigger a PRACH transmission towards cell A.

In one example, the PCI index 0 can correspond to a first TAG ID (e.g., TAG ID 0) and a PCI index that is non-zero can correspond to a second TAG ID (e.g., TAG ID 1).

In one example, a first PCI index can correspond to a first TAG ID (e.g., TAG ID 0) and a second PCI index can correspond to a second TAG ID (e.g., TAG ID 1). In one example, the network can configure by RRC configuration and/or MAC CE signaling and/or L1 control signaling the first PCI index and/or the second PCI index.

In one example, the PCI field has a size of N-bits, wherein, N=┌log₂(maxNrofAdditionalPCI+1)┐. In one example, maxNrofAdditionalPCI=7, and N=3 bits. In one example, if the PCI field is 0, this indicates a serving cell, else the PCI indicates the additional PCI index of a non-serving cell.

In one example, if the PCI Index is 0, the legacy behavior of TABLE 1 is followed.

In one example, a new flag can be added to the PDCCH order.
If the flag is “0”, follow legacy PDCCH order behavior as described in TABLE 1.
If the flag is “1”, follow new behavior. For example:
   A PCI Index or PCI Flag is included in the PDCCH order.
   If “Random Access Preamble index” is not zero “SS/PBCH index” indicates SSB index used for RO association and to determine the preamble transmit power and possibly preamble spatial filter, else “SS/PBCH index” is reserved. Alternatively, “SS/PBCH index” indicates SSB index used for RO association and to determine the preamble transmit power and possibly preamble spatial filter.
   If “Random Access Preamble index” is not zero “PRACH Mask index” indicates RO used, else “PRACH Mask index” is reserved. Alternatively, “PRACH Mask index” indicates RO used.

In one example, the SSB used to determine the transmit power of the preamble is configured or activated or indicated as a PL-RS before the transmission of the PDCCH order, as described earlier in this disclosure.

Although FIG. 25 illustrates one example 2500 of a PDCCH order triggered CFRA procedure, various changes may be made to FIG. 25. For example, while shown as a series of steps, various steps in FIG. 25 could overlap, occur in parallel, occur in a different order, or occur any number of times.

In one example, as illustrated in FIG. 26, the preamble is transmitted using a spatial filter and/or a power determined based on (1) SS/PBCH index, and (2) PCIIndex included in (or indicated by) the PDCCH order.

FIG. 26 illustrates an example 2600 of preamble transmission according to embodiments of the present disclosure. The embodiment of preamble transmission of FIG. 26 is for illustration only. Different embodiments of preamble transmission could be used without departing from the scope of this disclosure.

In the example of FIG. 26, the following variants can be considered:
Variant 1: the same SS/PBCH index is used to (1) determine the PRACH Occasion used to transmit the preamble and (2) determine the spatial filter and/or a power of the preamble. For example, as in TABLE 3.
Variant 2: the PDCCH order includes 2 SS/PBCH indices; (1) One is used to determine the PRACH Occasion used to transmit the preamble and (2) the other is used to determine the spatial filter and/or a power of the preamble. For example, as in TABLE 4.

TABLE 4

| Field | Size | | Description |
|---|---|---|---|
| Identifier for DCI formats | 1 | | The value of this bit field |
| | | | is set to 1, indicating a |
| | | | DL DCI format |
| Frequency domain resource | ┌log₂(N_{RB}^{DL, BWP}(N_{RB}^{DL, BWP} + | | Set to all ones |
| assignment | 1)/2)┐ | | |
| Random Access Preamble index | 6 | bits | See description A |
| UL/SUL indicator | 1 | bit | |
| SS/PBCH index | 6 | bits | See description F |
| PRACH Mask index | 4 | bits | See description C |
| PCI Index | 3 | bits | See description E |
| SS/PBCH index2 | 6 | bits | See description G |

| | |
|---|---|
| Reserved bits | 3 bits or 1 bit |

### Description F

In one example, if PCI Index or PCI Flag is zero
If “Random Access Preamble index” is not zero, “SS/PBCH index” indicates SSB index used for RO association, else “SS/PBCH index” is reserved.

In one example, if PCI Index or PCI Flag is non-zero
If “Random Access Preamble index” is not zero “SS/PBCH index” indicates SSB index used for RO association, else “SS/PBCH index” is reserved.

In one example, if PCI Index or PCI Flag is non-zero
“SS/PBCH index” indicates SSB index used for RO association.

### Description G

In one example, if PCI Index or PCI Flag is zero
Field “SS/PBCH index2” is reserved.

In one example, if PCI Index or PCI Flag is non-zero
If “Random Access Preamble index” is not zero “SS/PBCH index2” indicates SSB index used to determine the preamble transmit power and possibly preamble spatial filter, else “SS/PBCH index” is reserved.

In one example, if PCI Index or PCI Flag is non-zero
“SS/PBCH index” indicates SSB index used for to determine the preamble transmit power and possibly preamble spatial filter.

In one example, a new flag can be added to the PDCCH order.
If the flag is “0”, follow legacy PDCCH order behavior as described in TABLE 1.
If the flag is “1”, follow new behavior. For example:
   A PCI Index or PCI Flag is included in the PDCCH order
   If “Random Access Preamble index” is not zero “SS/PBCH index” indicates SSB index used for RO association, else “SS/PBCH index” is reserved. Alternatively, “SS/PBCH index” indicates SSB index used for RO association.
   A new field “SS/PBCH index2” is added to the PDCCH order. If “Random Access Preamble index” is not zero “SS/PBCH index2” indicates SSB index used to determine the preamble transmit power and possibly preamble spatial filter, else “SS/PBCH index” is reserved. Alternatively, “SS/PBCH index” indicates SSB index used for to determine the preamble transmit power and possibly preamble spatial filter.
   If “Random Access Preamble index” is not zero “PRACH Mask index” indicates RO used, else “PRACH Mask index” is reserved. Alternatively, “PRACH Mask index” indicates RO used.

In one example, the SSB used to determine the transmit power of the preamble is configured or activated or indicated as a PL-RS before the transmission of the PDCCH order, as described earlier in this disclosure.

In one example, as illustrated in FIG. 26, the preamble is transmitted using a spatial filter and/or a power determined based on (1) SS/PBCH index, and (2) PCI Hag included in (or indicated by) the PDCCH order. The following variants can be considered for this example:
Variant 1: the same SS/PBCH index is used to (1) determine the PRACH Occasion used to transmit the preamble and (2) determine the spatial filter and/or a power of the preamble. For example, as in TABLE 2.
Variant 2: the PDCCH order includes 2 SS/PBCH indices; (1) One is used to determine the PRACH Occasion used to transmit the preamble and (2) the other is used to determine the spatial filter and/or a power of the preamble. For example, as in TABLE 5.

In one example, the SSB used to determine the transmit power of the preamble is configured or activated or indicated as a PL-RS before the transmission of the PDCCH order, as described earlier in this disclosure.

TABLE 5

| Field | Size | | Description |
|---|---|---|---|
| Identifier for DCI formats | 1 | | The value of this bit field |
| | | | is set to 1, indicating a |
| | | | DL DCI format |
| Frequency domain resource | ┌log₂(N_{RB}^{DL, BWP}(N_{RB}^{DL, BWP} + | | Set to all ones |
| assignment | 1)/2)┐ | | |
| Random Access Preamble index | 6 | bits | See description A |
| UL/SUL indicator | 1 | bit | |
| SS/PBCH index | 6 | bits | See description F |
| PRACH Mask index | 4 | bits | See description C |
| PCI Flag | 1 | bit | See description D |
| SS/PBCH index2 | 6 | bits | See description G |

| | |
|---|---|
| Reserved bits | 5 bits or 3 bits |

In one example, the PCI Flag can be:
With a value of zero, then the PCI is the PCI of the serving cell in which this CSI-SSB-ResourceSet is defined.
With a value of one, then the UE selects a PCI corresponding to the additionalPCIIndex-r17 of an SSB-MTC-AdditionalPCI-r17 in the additionalPCIList-r17 in ServingCellConfig. For example, the selection can be based on the cell with active TCI states (or TCI state codepoints or active spatial relations).

Although FIG. 26 illustrates one example 2600 of preamble transmission, various changes may be made to FIG. 26. For example, while shown as a series of steps, various steps in FIG. 26 could overlap, occur in parallel, occur in a different order, or occur any number of times.

In one example, as illustrated in FIG. 27, the preamble is transmitted using a spatial filter and/or a power determined based on an SSB or a CSI-RS resource that is the source RS or that is quasi-co-located with the source RS of the PDCCH DM-RS of the PDCCH order.

FIG. 27 illustrates an example 2700 of preamble transmission according to embodiments of the present disclosure. The embodiment of preamble transmission of FIG. 27 is for illustration only. Different embodiments of preamble transmission could be used without departing from the scope of this disclosure.

The SSB or the CSI-RS can be associated with the serving cell or associated with a cell corresponding to an additionalPCIIndex.

In one example, the SSB or CSI-RS used to determine the transmit power of the preamble is configured or activated or indicated as a PL-RS before the transmission of the PDCCH order, as described earlier in this disclosure.

In one example, as illustrated in FIG. 27, the preamble is transmitted using a spatial filter and/or a power determined based on an SSB or a CSI-RS resource that is the source RS or that is quasi-co-located with the source RS of the PDCCH DM-RS of the PDCCH order. The SSB or the CSI-RS can be associated with a cell corresponding to an additionalPCIIndex.

In one example, the SSB or CSI-RS used to determine the transmit power of the preamble is configured or activated or indicated as a PL-RS before the transmission of the PDCCH order, as described earlier in this disclosure.

Although FIG. 27 illustrates one example 2700 of preamble transmission, various changes may be made to FIG. 27. For example, while shown as a series of steps, various steps in FIG. 27 could overlap, occur in parallel, occur in a different order, or occur any number of times.

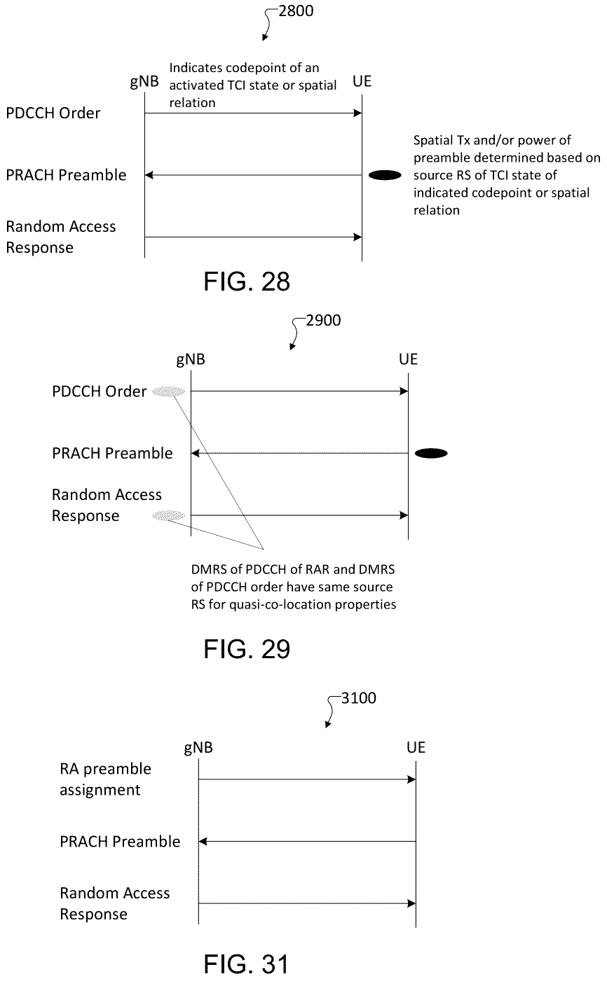

In one example, as illustrated in FIG. 28 the preamble is transmitted using a spatial filter and/or a power determined based on an SS/PBCH index or CSI-RS resource.

FIG. 28 illustrates an example 2800 of preamble transmission according to embodiments of the present disclosure. The embodiment of preamble transmission of FIG. 28 is for illustration only. Different embodiments of preamble transmission could be used without departing from the scope of this disclosure.

In the example of FIG. 28 the preamble is transmitted using a spatial filter and/or a power determined based on an SS/PBCH index or CSI-RS resource, wherein the SS/PBCH index or CSI-RS resource is the source RS for quasi-co-location (e.g., TypeD QCL or TypeA QCL) of a MAC CE activated TCI state, wherein, the activated MAC CE TCI state codepoint (or TCI state or TCI state ID) is included in (or indicated by) the PDCCH order. Active TCI state code points correspond to TCI states activated by MAC CE. In a variant example, an SSB index is used to determine the spatial filter and/or a power of the transmitted preamble, wherein, the SSB index is root source RS of a TCI state codepoint (or TCI state or TCI state ID) included in (or indicated by) the PDCCH order. The root source RS is a direct or indirect RS for QCL information or spatial relation information of the TCI state codepoint (or TCI state or TCI state ID). A direct RS is when the RS is the source RS of the TCI state codepoint (or TCI state or TCI state ID), an indirect RS, is when the RS provides QCL information or spatial relation information for the source RS of the TCI state codepoint (or TCI state or TCI state ID).

In one example, the SSB or CSI-RS used to determine the transmit power of the preamble is configured or activated or indicated as a PL-RS before the transmission of the PDCCH order, as described earlier in this disclosure.

In one example, as illustrated in FIG. 28 the preamble is transmitted using a spatial filter and/or a power determined based on an SS/PBCH index or CSI-RS resource, wherein the SS/PBCH index or CSI-RS resource is the source RS for spatial relation of a MAC CE activated spatial relation, wherein, the activated MAC CE spatial relation (or spatial relation codepoint or spatial relation ID) is included in (or indicated by) the PDCCH order. In a variant example, an SSB index is used to determine the spatial filter and/or a power of the transmitted preamble, wherein, the SSB index is root source RS of a spatial relation (or spatial relation codepoint or spatial relation ID) included in (or indicated by) the PDCCH order. The root source RS is a direct or indirect RS for QCL information or spatial relation information of the spatial relation (or spatial relation codepoint or spatial relation ID). A direct RS is when the RS is the source RS of the spatial relation (or spatial relation codepoint or spatial relation ID), an indirect RS, is when the RS provides QCL information or spatial relation information for the source RS of the spatial relation (or spatial relation codepoint or spatial relation ID).

In one example, the SSB or CSI-RS used to determine the transmit power of the preamble is configured or activated or indicated as a PL-RS before the transmission of the PDCCH order, as described earlier in this disclosure.

Although FIG. 28 illustrates one example 2800 of preamble transmission, various changes may be made to FIG. 28. For example, while shown as a series of steps, various steps in FIG. 28 could overlap, occur in parallel, occur in a different order, or occur any number of times.

In one example, the random access response for the preamble is transmitted in a PDCCH with a CRC that is scrambled by RA-RNTI.

In one example, as illustrated in FIG. 29, the DMRS antenna port of the PDCCH of the RAR has the same antenna port quasi co-location properties as the DMRS antenna port of the PDCCH of the PDCCH order.

FIG. 29 illustrates an example 2900 of a DMRS antenna port of a PDCCH of a RAR having the same antenna port quasi co-location properties as the DMRS antenna port of a PDCCH of a PDCCH order according to embodiments of the present disclosure. The embodiment of DMRS antenna ports having the same quasi co-location properties of FIG. 29 is for illustration only. Different embodiments of DMRS antenna ports having the same quasi co-location properties could be used without departing from the scope of this disclosure.

Although FIG. 29 illustrates one example 2900 of DMRS antenna ports having the same quasi co-location properties, various changes may be made to FIG. 29. For example, while shown as a series of steps, various steps in FIG. 29 could overlap, occur in parallel, occur in a different order, or occur any number of times.

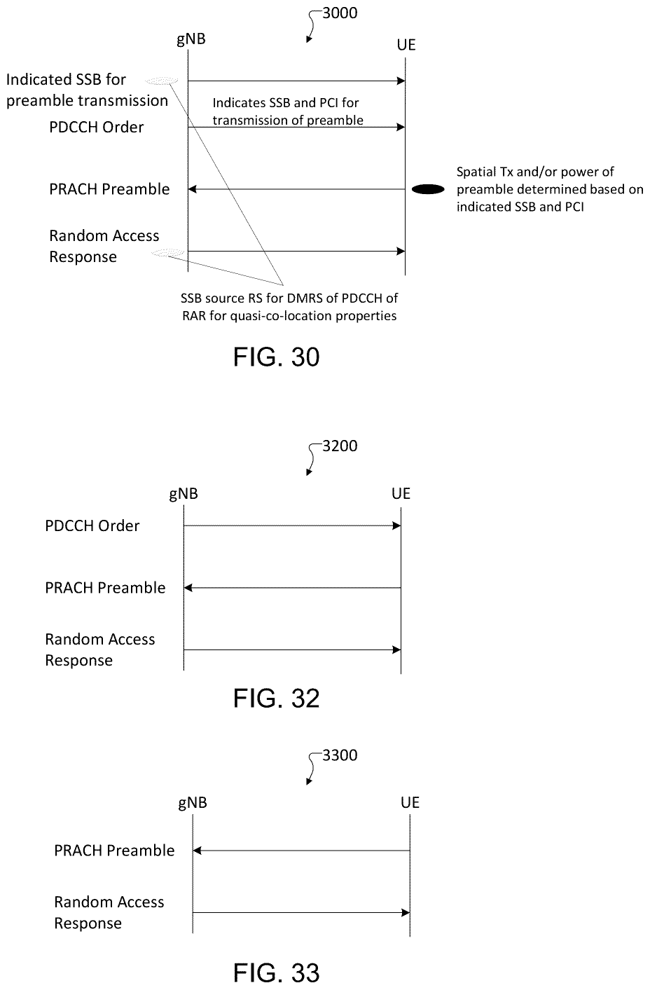

In one example, as illustrated in FIG. 30, the DMRS antenna port of the PDCCH of the RAR is quasi-co-located with the SSB and CSI-RS resource used to determine the spatial filter and/or power of the preamble transmission.

FIG. 30 illustrates an example 3000 where a DMRS antenna port of a PDCCH of a RAR is quasi-co-located with an SSB according to embodiments of the present disclosure. The embodiment of quasi co-location of FIG. 30 is for illustration only. Different embodiments of quasi co-location could be used without departing from the scope of this disclosure.

In one example the DMRS antenna port of the PDCCH of the RAR is quasi-co-located with the SSB and CSI-RS resource used to determine the association of the preamble transmission to ROs.

In one example the DMRS antenna port of the PDCCH of the RAR is quasi-co-located with the SSB indicated in the PDCCH order by “SS/PBCH index”.

In one example the DMRS antenna port of the PDCCH of the RAR is quasi-co-located with the SSB indicated in the PDCCH order by “SS/PBCH index” and PCI Flag or PCI Index.

In one example the DMRS antenna port of the PDCCH of the RAR is quasi-co-located with the SSB indicated in the PDCCH order by “SS/PBCH index2”.

In one example the DMRS antenna port of the PDCCH of the RAR is quasi-co-located with the SSB indicated in the PDCCH order by “SS/PBCH index2” and PCI Flag or PCI Index.

In one example, the DMRS antenna port of the PDCCH of the RAR is quasi-co-located with a CORESET (e.g., based on source RS of TCI state of the CORESET) associated with Type1-PDCCH Common Search Space (CSS) set.

In one example, if the PDCCH order is associated with (e.g., transmitted from) a cell that has PCI different from the PCI of the serving cell (e.g., the TCI state of the PDCCH order is associated with a cell or SSB that has PCI different from the PCI of the serving cell), the DMRS antenna port of the PDCCH of the RAR is quasi-co-located with a CORESET (e.g., based on source RS of TCI state of the CORESET) associated with Type1-PDCCH Common Search Space (CSS) set. If the PDCCH order is associated with (e.g., transmitted from) the serving cell (e.g., the TCI state of the PDCCH order is associated with the serving cell or a SSB of the serving cell) the DMRS antenna port of the PDCCH of the RAR has the same antenna port quasi co-location properties as the DMRS antenna port of the PDCCH of the PDCCH order.

In one example, the DMRS antenna port of the PDCCH of the RAR is quasi-co-located with a CORESET (e.g., based on source RS of TCI state of the CORESET) associated with UE-specific Search Space (USS) set.

In one example, the PDCCH of the RAR is transmitted in a Type1-PDCCH CSS set associated with the serving cell.

In one example the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with multiple Type1-PDCCH CSS sets for the serving cell and the cells of the additionalPCIIndex.

In one example the PDCCH is transmitted in a Type1-PDCCH CSS set associated with a cell, wherein the cell is that associated with the preamble transmission. The cell can be the serving cell or the cell of an additionalPCIndex. In this example, the UE can be configured with two Type1-PDCCH CSS sets a first Type1-PDCCH CSS for the serving cell and a second Type1-PDCCH CSS for any cell of the additionalPCIIndex.

In one example, the PDCCH of the RAR is transmitted in a USS set.

In one example, the PDCCH of the RAR is transmitted in the same search space set as that of the PDCCH order.

In one example, if a PCI Flag or PCI index or TAG ID/Index in a PDCCH order is 0 or flag is added in PDCCH order to indicated new behavior and flag is set to 0, the DMRS antenna port of the PDCCH of the RAR has the same antenna port quasi co-location properties as the DMRS antenna port of the PDCCH of the PDCCH order, else (a PCI Flag or PCI index or TAG ID/Index in a PDCCH order is non-zero), the DMRS antenna port of the PDCCH of the RAR is quasi-co-located with the SSB and CSI-RS resource used to determine the spatial filter and/or power of the preamble transmission.

In one example, if a PCI Flag or PCI index or TAG ID/Index in a PDCCH order is 0 or flag is added in PDCCH order to indicated new behavior and flag is set to 0, the DMRS antenna port of the PDCCH of the RAR has the same antenna port quasi co-location properties as the DMRS antenna port of the PDCCH of the PDCCH order, else (a PCI Flag or PCI index or TAG ID/Index in a PDCCH order is non-zero), the DMRS antenna port of the PDCCH of the RAR is quasi-co-located with the SSB indicated by one of:
SS/PBCH index”.
SS/PBCH index” and PCI Flag or PCI Index.
SS/PBCH index2”.
SS/PBCH index2” and PCI Flag or PCI Index.

In one example, the DMRS antenna port of the PDSCH of the RAR has the same antenna port quasi co-location properties as the DMRS antenna port of the PDCCH of the RAR. The antenna port quasi co-location properties as the DMRS antenna port of the PDCCH of the RAR can be according to the previous examples.

In one example, the DCI Format of the PDCCH of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the MAC CE of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the Timing Advanced conveyed by the RAR or MsgB can be determined based on the PDCCH order (e.g., a PCI flag or index in the PDCCH order, or the cell the PDCCH order is transmitted in, or the cell which the PDCCH order triggers the transmission of the preamble in) that triggered the PRACH preamble transmission associated with the RAR.

In one example, the Timing Advanced conveyed by the RAR or MsgB can be determined based on the SSB or CSI-RS used for the transmission of the PRACH preamble (e.g., one set of SSB or CSI-RS is associated with a first TAG ID and a second set of SSB or CSI-RS is associated with a second TAG ID).

In one example, the Timing Advanced conveyed by the RAR or MsgB can be determined based on the SSB or CSI-RS used for determining the RO of the PRACH preamble (e.g., one set of SSB or CSI-RS is associated with a first TAG ID and a second set of SSB or CSI-RS is associated with a second TAG ID).

In one example, the SSB or CSI-RS in the aforementioned examples used to determine the transmit power of the preamble is configured or activated or indicated as a PL-RS before the transmission of the PDCCH order, as described earlier in this disclosure.

In one example, in case of cross-TRP triggering, the preamble is sent towards a TRP of a cell other than the cell that sent the PDCCH order. In this case, additional signaling is need to determine the TRP towards which the PRACH is sent. A new field can be included in the PDCCH order for that purpose. This new field can be:
A one-bit flag (e.g., PCI Flag) that indicates whether the PRACH of the PDCCH order is sent towards serving cell or another non-serving cell. The non-serving cell, for example, can be the cell with active TCI states.
A 3-bit field that indicates the cell ID (e.g., PCI index), for example identifying, AdditionalPCIlndex-r17 (a value from 1 to 7) included in SSB-MTC-AdditionalPCI-r17. Value 0 can indicate the serving cell.

In one example, for multi-DCI based inter-cell Multi-TRP operation with two TA enhancement, for CFRA PDCCH order, include an additional flag or field in the PDCCH order to identify the cell towards which the PRACH of the PDCCH order is transmitted.

In one example, if the value of the PCI flag or the field that indicates the PDCCH order is 0, the operation of the PDCCH order follows the legacy behavior as aforementioned. If the value of the PCI flag in the PDCCH order is non-zero, this indicates a PDCCH order with a PRACH transmitted towards a cell other than the cell triggering the PDCCH order. In this case,
The “Random Access Preamble index” field indicates the preamble of the PRACH transmission towards the other cell.
The “UL/SUL indicator” field indicates whether the PRACH preamble is sent in the UL carrier or the SUL carrier of the other cell.
The “SS/PBCH index” field indicates the SSB index a cell determined based on the PCI Flag/PCI Index to determine the RO used for PRACH preamble transmission towards the cell. The indicated SSB index of the cell can also be used to determine the PRACH preamble transmission power. i.e., this field is used for PRACH RO association and transmission power.
The “PRACH Mask index” field determines the RO to use for PRACH preamble transmission towards the cell indicated by the PCI Flag/PCI Index.

In one example, for multi-DCI based inter-cell Multi-TRP operation with two TA enhancement, for CFRA PDCCH order,
if the PCI field PCI flag or field is all zeros, the PDCCH order follows the legacy behavior.
if the PCI field PCI flag or field indicates a PRACH transmission towards a cell other than the cell triggering the PDCCH order, the remaining fields in the PDCCH order are used to determine the preamble index and the RO of the PRACH preamble transmitted towards other cell. The “SS/PBCH index” field is used to determine the transmission power of the PRACH preamble towards the other cell.

In one example, the QCL of the PDCCH DMRS of the RAR and the corresponding PDSCH can follow the QCL of the PDCCH DMRS of the PDCCH order. Type1-PDCCH CSS (common search space) set configured for the serving cell can be used for PDCCH monitoring occasions of the RAR.

In one example, the QCL of the PDCCH DMRS of the RAR can be determined based on the SSB used for preamble transmission. The Type1-PDCCH CSS set configured for the serving cell can be used for PDCCH monitoring occasions of the RAR in this case also.

The TAG ID can be determined based on the PCI flag or PCI index of the PDCCH order. For example, if the PCI flag or field is zero, this can correspond to one TAG-ID, if the PCI flag is non-zero this can correspond to the other TAG-ID.

In one example, for inter-cell multi-DCI based multi-TRP operation with two TA enhancement, for CFRA PDCCH order, Type1-PDCCH CSS configured for the serving cell can be used for PDCCH monitoring occasions of the RAR.
If the PDCCH order is transmitted towards the serving cell, the UE may assume that the PDCCH that includes the DCI format 1_0 of the RAR as well as corresponding PDSCH and the PDCCH order have same DM-RS antenna port quasi co-location properties.
If the PDCCH order is transmitted towards a non-serving cell, the UE may assume that the PDCCH that includes the DCI format 1_0 of the RAR as well as corresponding PDSCH have the same antenna port quasi co-location properties as the SSB used for the PRACH preamble transmission.

In one example, for inter-cell multi-DCI based multi-TRP operation with two TA enhancement, for a CFRA PDCCH order, TAG ID is determined based on the PCI flag or PCI index of the PDCCH order. In one example, for intra-cell multi-DCI based multi-TRP operation with two TA enhancement, a CFRA PDCCH order sent by one TRP triggers RACH procedure towards the same TRP.
The preamble is transmitted using a spatial filter and power determined based on an SSB resource that is the source RS of the PDCCH DM-RS of the PDCCH order.

In one example, for intra-cell multi-DCI based multi-TRP operation with two TA enhancement, for a CFRA PDCCH order, TAG ID is determined based on the TCI state of PDCCH order or TRP from which the PDCCH order is transmitted.

In one example, for intra-cell scenarios, the RAR is sent from the TRP sending the PDCCH order. The QCL of the PDCCH of the RAR and the corresponding PDSCH can follow the QCL of the PDCCH order. Type1-PDCCH CSS configured for the serving cell can be used for PDCCH monitoring occasions of the RAR.

In one example, for inter-cell multi-DCI based multi-TRP operation with two TA enhancement, for CFRA PDCCH order, Type1-PDCCH CSS configured for the serving cell can be used for PDCCH monitoring occasions of the RAR. The UE may assume that the PDCCH that includes the DCI format 1_0 of the RAR as well as corresponding PDSCH and the PDCCH order have same DM-RS antenna port quasi co-location properties.

In one example, if the PDCCH order is associated with (e.g., transmitted from) a cell that has PCI different from the PCI of the serving cell (e.g., the TCI state of the PDCCH order is associated with a cell or SSB that has PCI different from the PCI of the serving cell—e.g., inter-cell PDCCH order), the DMRS antenna port of the PDCCH and/or PDSCH of the RAR are quasi-co-located with a CORESET (e.g., based on source RS of TCI state of the CORESET) associated with Type1-PDCCH Common Search Space (CSS) set. If the PDCCH order is associated with (e.g., transmitted from) the serving cell (e.g., the TCI state of the PDCCH order is associated with the serving cell or a SSB of the serving cell) the DMRS antenna port of the PDCCH and/or PDSCH of the RAR have the same antenna port quasi co-location properties as the DMRS antenna port of the PDCCH of the PDCCH order.

In one example, the SSB or CSI-RS used to determine the transmit power of the preamble, in the aforementioned examples, is configured or activated or indicated as a PL-RS before the transmission of the PDCCH order, as described earlier in this disclosure.

Although FIG. 30 illustrates one example 3000 of quasi co-location, various changes may be made to FIG. 30. For example, while shown as a series of steps, various steps in FIG. 30 could overlap, occur in parallel, occur in a different order, or occur any number of times.

In one example, higher layers trigger a contention-free random (CFRA) access procedure for an inter-cell multi-TRP scenario to determine a TA.

FIG. 31 illustrates an example 3100 of a higher-layer triggered CFRA procedure according to embodiments of the present disclosure. The embodiment of a higher-layer triggered CFRA procedure of FIG. 31 is for illustration only. Different embodiments of a higher-layer triggered CFRA procedure could be used without departing from the scope of this disclosure.

In the example of FIG. 31, the following aspects are considered:
The resource for the preamble transmission, wherein the resource includes the PRACH Occasion and the preamble index.
The spatial filter and/or transmit power used to transmit the preamble.
The quasi-co-location for the random access response.

The resource used for the preamble is determined by a PRACH Occasion and a preamble index within the PRACH Occasion. The preamble index can be indicated by higher layers (e.g., RA preamble assignment in FIG. 31). The PRACH Occasion is determined based on an SSB or a CSI-RS resource to which the preamble is associated with, through an association pattern as described. In Rel-15 the association pattern is defined for the SSBs of the serving cell only. However, in case of inter-cell multi-TRP, there are SSBs associated with the serving cell as well as SSBs associated with cells corresponding to the additionalPCIIndex. Hence, one option is to define a new PRACH configuration to cover serving cell SSBs as well as SSBs on cells corresponding to the additionalPCIIndex.

In one example, the new PRACH configuration can be used for transmission of preambles associated with the serving cell and cells corresponding to the additionalPCIIndex.

In one example, the new PRACH configuration can be used for transmission of preambles associated with cells corresponding to the additionalPCIIndex. The PRACH configuration of NR release 15, can be used for transmission of preambles associated with the serving cell.

In one example, the new PRACH configuration can be used for transmission of preambles associated with cells corresponding to the additionalPCIIndex. A higher layer parameter (e.g., by RRC configuration and/or MAC CE configuration) can indicate whether the preambles associated with the serving cell are transmitted using (1) the new PRACH configuration or (2) the PRACH configuration of NR release 15.

In one example, a separate PRACH configuration is provided for each additionalPCIIndex. The PRACH configuration association with an additionalPCIIndex can be used for transmission of preambles associated with cells corresponding to the additionalPCIIndex. The PRACH configuration of NR release 15, can be used for transmission of preambles associated with the serving cell.

The following examples can be considered for the new PRACH configuration.
The association is based on PCI-SSB pairs, i.e., each PCI-SSB pair is associated with an RO
The association is based on SSBs of the additionalPCIIndex, wherein the SSBs are provided by ssb-PositionsInBurst of SSB-MTC-AdditionalPCI-r17.

In one example, the UE determines the PCI and/or the SSB to use for sending the contention-free random access preamble. For example, the PCI can be determined based on the activated TCI state codepoints (or TCI states or TCI state IDs) and/or the activated spatial relations. In one example, let X1 be the set of PCIs associated with the MAC CE activated TCI state codepoints e.g., as described in TS 38.321 clause 5.18.23 and 6.1.3.47, the UE selects (or determines) a PCI Y1 from set X1, the UE further selects (or determines) an SSB index Z1 associated with PCI Y1, the UE uses SSB index Z1 to determine the spatial filter and/or power of the preamble transmission. In one example, let X2 be the set of PCIs associated with the MAC CE activated spatial relation information, the UE selects (or determines) a PCI Y2 from set X2, the UE further selects (or determines) an SSB index Z2 associated with PCI Y2, the UE uses SSB index Z2 to determine the spatial filter and/or power of the preamble transmission. The UE transmits the higher layer indicated preamble in a PRACH Occasion corresponding to Z1/Y1 or Z2/Y2.

In one example, active TCI states (or TCI state codepoints or active spatial relations) can be associated with serving cell and one other cell corresponding to additionalPCIIndex. In one example, active TCI states (or TCI state codepoints or active spatial relations) can be associated with serving cell and one or more other cell corresponding to additionalPCIIndex.

In one example, the SSB or CSI-RS used to determine the transmit power of the preamble is configured or activated or indicated as a PL-RS before the transmission of the PDCCH order, as described earlier in this disclosure.

In one example, a UE is configured with a new PRACH configuration. For example, a new RACH-ConfigGeneric and/or RACH-ConfigDedicated e.g., to be used for inter-cell multi-TRP.

The UE is configured additional PCIs and SSBs associated with the additional PCIs. For example, the UE can be configured with CSI-SSB-ResourceSet that includes a list of additional PCI indices given by servingAdditionalPCIList.

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF |

```
  SSB-Index,
  ...,
  [[
    servingAdditionalPCIList-r17 SEQUENCE (SIZE(1..maxNrofCSI-SSB-ResourcePerSet))
    OF ServingAdditionalPCIIndex-r17 OPTIONAL -- Need R
  ]]
}
```

Wherein, maxNrofCSI-SSB-ResourcePerSet is 64.

And wherein, servingAdditionalPCIList indicates the physical cell IDs (PCI) of the SSBs in the csi-SSB-ResourceList. If present, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. For each entry, the following applies:
If the value is zero, the PCI is the PCI of the serving cell in which this CSI-SSB-ResourceSet is defined;
otherwise, the value is additionalPCIIndex-r17 of an SSB-MTC-AdditionalPCI-r17 in the additionalPCIList-r17 in ServingCellConfig, and the PCI is the additionalPCI-r17 in this SSB-MTC-AdditionalPCI-r17.

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, |

spare2, spare1 },

| | |
|---|---|
| ssb-PositionsInBurst-r17 | CHOICE { |
| | shortBitmap BIT STRING (SIZE (4)), |
| | mediumBitmap BIT STRING (SIZE (8)), |
| | longBitmap BIT STRING (SIZE (64)) |

},

| | |
|---|---|
| ss-PBCH-BlockPower-r17 | INTEGER (−60..50) |

}

Wherein, AdditionalPCIIndex-r17::=INTEGER(1..maxNrofAdditionalPCI-r17), and maxNrofAdditionalPCI is 7.

Wherein, ssb-PositionsInBurst indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

For association of SSBs with ROs for the new PRACH configuration, the number of SSBs to be associated with ROs is given by of the following examples:

In one example, the number of SSBs to be associated with ROs is obtained from CSI-SSB-ResourceSet, based on SSB indices in the list csi-SSB-ResourceList that are associated with an additional PCI as given by servingAdditionalPCIList, (i.e., SSBs associated with the serving cell (having a value of zero in the corresponding entry in servingAdditionalPCIList) are excluded). The association order of SSBs to ROs can be based on the order of SSBs in csi-SSB-ResourceList associated with an additional PCI. In a variant of this example, only SSBs of cells with MAC CE activated TCI states are considered.

In one example, the number of SSBs to be associated with ROs is the sum of the number of SSBs configured for each AdditionalPCIIndex obtained from the corresponding ssb-PositionsInBurst. Let, NT Total be the total number of SSBs to be associated with PRACH Occasions,

$${N}_{Tx - Total}^{SSB} = {\sum }_{Configured AdditionalPCIIndex} {N}_{Tx}^{SSB} ( AdditionalPCIIndex )$$

Where,
N_{Tx}^{SSB}(AdditionalPCIIndex) can be obtained from ssb-PositionsInBurst corresponding to SSB-MTC-AdditionalPCI, for example, the number of bits in the bitmap with value equal to 1. The association order of SSBs to ROs can be based on:
   First, the order of the SSBs in the corresponding ssb-PositionsInBurst bit map.
   The order of the configured AdditionalPCIIndex, for example as provided in ServingCellConfig ServingCellConfig->mimoParam-r17->additionalPCI-ToAddModList-r17 SEQUENCE (SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example, the number of SSBs to be associated with ROs is obtained from CSI-SSB-ResourceSet, based on SSB indices in the list csi-SSB-ResourceList that are associated with the serving cell PCI, or an additional PCI as given by servingAdditionalPCIList. The association order of SSBs to ROs can be based on the order of SSBs in csi-SSB-ResourceList. In a variant of this example, only SSBs of cells with MAC CE activated TCI states are considered.

In one example, the number of SSBs to be associated with ROs is the sum of the number of SSBs configured for the serving cell, obtained from ssb-PositionsInBurst in SIB1 or in ServingCellConfigCommon, and for each AdditionalPCIIndex, obtained from the corresponding ssb-PositionsInBurst. Let, N_{Tx-Total}^{SBB} be the total number of SSBs to be associated with PRACH Occasions,

$${N}_{Tx - Total}^{SSB} = {\sum }_{Seving cell and Configured AdditionalPCIIndex} \text{} {N}_{Tx}^{SSB} \text{} ( Serving cell or AdditionalPCIIndex )$$

Where,
N_{Tx}^{SSB}(ServingCell) can be obtained from ssb-PositionsInBurst in SIB1 or in ServingCellConfigCommon.
N_{Tx}^{SSB}(AdditionalPCIIndex) can be obtained from ssb-PositionsInBurst corresponding to SSB-MTC-AdditionalPCI, for example, the number bits in the bitmap with value equal to 1. The association order of SSBs to ROs can be based on:
   First, the order of the SSBs in the corresponding ssb-PositionsInBurst bit map.
   Second, SSBs of serving cell followed by the order of the configured AdditionalPCIIndex, for example as provided in ServingCellConfig
ServingCellConfig->mimoParam-r17->additionalPCI-ToAddModList-r17 SEQUENCE (SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with the serving cell, the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example, the preamble is transmitted using a spatial filter and/or a power determined based on a PCI and a SSB index. The RO for the CFRA preamble transmission can also be determined based on the PCI and the SSB index as aforementioned.

In one example, the SSB used to determine the transmit power of the preamble is configured or activated or indicated as a PL-RS before the transmission of the PDCCH order, as described earlier in this disclosure.

In one example, the random access response for the preamble is transmitted in a PDCCH with a CRC that is scrambled by RA-RNTI.

In one example the PDCCH of the RAR is transmitted in a Type1-PDCCH Common Search Space (CSS) set associated with the serving cell.

In one example the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with multiple Type1-PDCCH CSS sets for the serving cell and the cells of the additionalPCIIndex.

In one example the PDCCH is transmitted in a Type1-PDCCH CSS set associated with a cell, wherein the cell is that associated with the preamble transmission. The cell can be the serving cell or the cell of an additionalPCIndex. In this example, the UE can be configured with two Type1-PDCCH CSS sets a first Type1-PDCCH CSS for the serving cell and a second Type1-PDCCH CSS for any cell of the additionalPCIIndex.

In one example, the PDCCH of the RAR is transmitted in a USS set.

In one example, the DMRS antenna port of the PDCCH of the RAR is quasi-co-located with the SSB or CSI-RS resource used to determine the spatial filter and/or power of the preamble transmission.

In one example, the DMRS antenna port of the PDCCH of the RAR is quasi-co-located with the SSB or CSI-RS resource used to determine the association of the preamble transmission to ROs.

In one example, the DMRS antenna port of the PDCCH of the RAR is quasi-co-located with a CORESET (e.g., based on source RS of TCI state of the CORESET) associated with Type1-PDCCH CSS set.

In one example, if the PDCCH order is associated with (e.g., transmitted from) a cell that has PCI different from the PCI of the serving cell (e.g., the TCI state of the PDCCH order is associated with a cell or SSB that has PCI different from the PCI of the serving cell), the DMRS antenna port of the PDCCH of the RAR is quasi-co-located with a CORESET (e.g., based on source RS of TCI state of the CORESET) associated with Type1-PDCCH Common Search Space (CSS) set. If the PDCCH order is associated (e.g., transmitted from) with the serving cell (e.g., the TCI state of the PDCCH order is associated with the serving cell or a SSB of the serving cell) the DMRS antenna port of the PDCCH of the RAR has the same antenna port quasi co-location properties as the DMRS antenna port of the PDCCH of the PDCCH order.

In one example, the DMRS antenna port of the PDCCH of the RAR is quasi-co-located with a CORESET (e.g., based on source RS of TCI state of the CORESET) associated with USS set.

In example, the DMRS antenna port of the PDSCH of the RAR has the same antenna port quasi co-location properties as the DMRS antenna port of the PDCCH of the RAR. The antenna port quasi co-location properties as the DMRS antenna port of the PDCCH of the RAR can be according to the previous examples.

In example, the DCI Format of the PDCCH of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the MAC CE of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the Timing Advanced conveyed by the RAR or MsgB can be determined based on the SSB or CSI-RS used for the transmission of the PRACH preamble (e.g., one set of SSB or CSI-RS is associated with a first TAG ID and a second set of SSB or CSI-RS is associated with a second TAG ID).

In one example, the Timing Advanced conveyed by the RAR or MsgB can be determined based on the SSB or CSI-RS used for determining the RO of the PRACH preamble (e.g., one set of SSB or CSI-RS is associated with a first TAG ID and a second set of SSB or CSI-RS is associated with a second TAG ID).

In one example, the SSB or CSI-RS used to determine the transmit power of the preamble, in the aforementioned examples, is configured or activated or indicated as a PL-RS before the transmission of the PDCCH order, as described earlier in this disclosure.

Although FIG. 31 illustrates one example 3100 of a higher-layer triggered CFRA procedure, various changes may be made to FIG. 31. For example, while shown as a series of steps, various steps in FIG. 31 could overlap, occur in parallel, occur in a different order, or occur any number of times.

In one a PDCCH order triggers a contention-based random access (CBRA) procedure for an inter-cell multi-TRP scenario to determine a TA. A CBRA procedure is triggered by a PDCCH order when the “random access preamble index” field of the PDCCH order is set to all zeros.

FIG. 32 illustrates an example 3200 of a PDCCH order triggered CBRA procedure according to embodiments of the present disclosure. The embodiment of a PDCCH order triggered CBRA procedure of FIG. 32 is for illustration only. Different embodiments of a PDCCH order triggered CBRA procedure could be used without departing from the scope of this disclosure.

In the example of FIG. 32, the following aspects are considered:
The TRP, beam and/or quasi-co-location properties used to transmit the PDCCH order.
The resource for the preamble transmission, wherein the resource includes the PRACH Occasion and the preamble index.
The spatial filter and/or transmit power used to transmit the preamble.
The quasi-co-location for the random access response.

In one example, the PDCCH order is transmitted from a TRP associated with the serving cell, e.g., the TCI state of the PDCCH order includes one or more source RS (e.g., of QCL TypeD and/or QCL TypeA) and the one or more source RS are associated (e.g., through QCL relation) with an SSB of the serving cell. In this example, the PDCCH order (transmitted from a TRP of the serving cell) triggers a preamble that is transmitted to a TRP of the serving cell or a TRP of a non-serving cell). The PDCCH order can trigger a preamble transmitted to a different TRP than that of the PDCCH order, e.g., the spatial filter and/or transmit power of the preamble can be based on an SSB of cell (or TRP) different from the cell (or TRP) of the PDCCH order. In one example, the PDCCH order includes a PCI of a cell on which the triggered RACH procedure is associated with, i.e., to which the preamble is transmitted to, the spatial transmit filter and/or power of the transmitted preamble is based on an SSB associated with the cell. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). In one example, the PCI field has a size of N-bits, wherein, N=[log₂(maxNrofAdditionalPCI+1)]. In one example, maxNrofAdditionalPCI=7, and N=3 bits. In one example, if the PCI field is 0, this indicates a serving cell, else the PCI indicates the additional PCI index of a non-serving cell. In another example, the PDCCH order includes a flag, that indicates whether the preamble is triggered for the serving cell, or another cell (e.g., one of the cells corresponding to additionalPCIIndex).

In one example, the SSB used to determine the transmit power of the preamble is configured or activated or indicated as a PL-RS before the transmission of the PDCCH order, as described earlier in this disclosure.

In one example, the PDCCH order is transmitted from a TRP associated with the serving cell or with a cell of a configured additionalPCIIndex, e.g., the TCI state of the PDCCH order includes one or more source RS (e.g., of QCL TypeD and/or QCL TypeA) and the one or more source RS are associated with (e.g., through QCL relation) an SSB of the serving cell or an SSB of a cell of a configured additionalPCIIndex. In this example, the following sub-examples are possible.
In one sub-example, the PDCCH order is transmitted from a TRP of one cell, and it triggers a preamble that can be transmitted to a TRP of another cell, e.g., the spatial filter and/or transmit power of the preamble can be based on an SSB of cell (or TRP) different from the cell (or TRP) of the PDCCH order. In one example, the PDCCH order includes a PCI of a cell on which the triggered RACH procedure is associated with, i.e., to which the preamble is transmitted to, the spatial transmit filter and/or power of the transmitted preamble is based on an SSB associated with the cell. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). In one example, the PCI field has a size of N-bits, wherein, N=[log₂(maxNrofAdditionalPCI+1)]. In one example, maxNrofAdditionalPCI=7, and N=3 bits. In one example, if the PCI field is 0, this indicates a serving cell, else the PCI indicates the additional PCI index of a non-serving cell. In another example, the PDCCH order includes a flag (or indicator), that indicates whether the preamble is triggered for the serving cell, or another cell (e.g., one of the cells corresponding to additionalPCIIndex).
In one sub-example, the PDCCH order is transmitted from a TRP of a cell, and it triggers a preamble transmitted to a TRP (for example the same TRP used for the PDCCH order) of the same cell, e.g., the spatial filter and/or transmit power of the preamble can be based on an SSB of the cell (or TRP) of the PDCCH order.

The resource used for the preamble is determined by a PRACH Occasion and a preamble index within the PRACH Occasion. For CBRA triggered by a PDCCH order, the “random access preamble index” field is all zeros as aforementioned. In this case, UE can randomly select a preamble from the contention based preambles associated with the selected SSB. The PRACH Occasion is determined based on an SSB or a CSI-RS resource to which the preamble is associated with, through an association pattern as described. In Rel-15 the association pattern is defined for the SSBs of the serving cell only. However, in case of inter-cell multi-TRP, there are SSBs associated with the serving cell as well as SSBs associated with cells corresponding to the additionalPCIIndex. Hence, one option is to define a new PRACH configuration to cover serving cell SSBs as well as SSBs on cells corresponding to the additionalPCIIndex.

In one example, the SSB or CSI-RS used to determine the transmit power of the preamble is configured or activated or indicated as a PL-RS before the transmission of the PDCCH order, as described earlier in this disclosure.

In one example, the new PRACH configuration can be used for transmission of preambles associated with the serving cell and cells corresponding to the additionalPCIIndex.

In one example, the new PRACH configuration can be used for transmission of preambles associated with cells corresponding to the additionalPCIIndex. The PRACH configuration of NR release 15, can be used for transmission of preambles associated with the serving cell.

In one example, the new PRACH configuration can be used for transmission of preambles associated with cells corresponding to the additionalPCIIndex. A higher layer parameter (e.g., by RRC configuration and/or MAC CE configuration) can indicate whether the preambles associated with the serving cell are transmitted using (1) the new PRACH configuration or (2) the PRACH configuration of NR release 15.

In one example, the new PRACH configuration can be used for transmission of preambles associated with cells corresponding to the additionalPCIIndex. An indicator (e.g., a flag) in the PDCCH order can indicate whether the preambles associated with the serving cell are transmitted using (1) the new PRACH configuration or (2) the PRACH configuration of NR release 15.

In one example, a separate PRACH configuration is provided for each additionalPCIIndex. The PRACH configuration association with an additionalPCIIndex can be used for transmission of preambles associated with cells corresponding to the additionalPCIIndex. The PRACH configuration of NR release 15, can be used for transmission of preambles associated with the serving cell.

For determination of the SSB and PCI to use for the transmission of the preamble, the following examples can be considered.

In one example, the UE determines (or selects) the SSB and PCI used for the preamble transmission. In one example, the determined (or selected) SSB and PCI determine the resource (e.g., PRACH Occasion) used for the preamble transmission. In one example, the determined (or selected) SSB and PCI determine the spatial filter and/or power of the preamble transmission.

In one example, the UE is signaled a PCI index in the PDCCH order. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). The UE determines (or selects) the SSB used for the preamble transmission. In one example, the determined (or selected) SSB and the signaled PCI determine the resource (e.g., PRACH Occasion) used for the preamble transmission. In one example, the determined (or selected) SSB determines the resource (e.g., PRACH Occasion) used for the preamble transmission. In one example, the determined (or selected) SSB and the signaled PCI determine the spatial filter and/or power of the preamble transmission.

In one example, the UE is signaled a PCI flag (or indicator) in the PDCCH order that indicates whether the preamble is triggered for the serving cell, or another cell (e.g., one of the cells corresponding to additionalPCIIndex). If the flag indicates serving cell, the UE determines (or selects) a serving cell SSB for the preamble transmission. If the flag indicates another cell (e.g., one of the cells corresponding to additionalPCIIndex), the UE determines (or selects) a PCI corresponding to additionalPCIIndex and the UE determines or selected a corresponding SSB for the preamble transmission. In one example, the determined (or selected) SSB and the signaled or determined (or selected) PCI determine the resource (e.g., PRACH Occasion) used for the preamble transmission. In one example, the determined (or selected) SSB and the signaled determined (or selected) PCI determine the spatial filter and/or power of the preamble transmission.

In one example, the UE is signaled a PCI index and SSB index in the PDCCH order. The PCI of the cell can be (1) that of the serving cell (for example when the PCI index in the PDCCH order is 0), or (2) an additionalPCIIndex of another cell (e.g., based on the value of additionalPCIIndex-r17 of an SSB-MTC-AdditionalPCI-r17). In one example, the signaled SSB and PCI determine the resource (e.g., PRACH Occasion) used for the preamble transmission. In one example, the signaled SSB determines the resource (e.g., PRACH Occasion) used for the preamble transmission. In one example, the signaled SSB and PCI determine the spatial filter and/or power of the preamble transmission.

In one example, the UE is signaled a PCI flag (or indicator) in the PDCCH order that indicates whether the preamble is triggered for the serving cell, or another cell (e.g., one of the cells corresponding to additionalPCIIndex). The UE is signaled an SSB index in the PDCCH order. In one example, if the flag indicates serving cell, the UE determines (or selects) a serving cell SSB for the preamble transmission. In another example, if the flag indicates serving cell, the UE uses the signaled SSB for preamble transmission. In one example, if the flag indicates another cell (e.g., one of the cells corresponding to additionalPCIIndex), the UE determines (or selects) a PCI corresponding to additionalPCIIndex and the UE determines or selected a corresponding SSB for the preamble transmission. In another example, if the flag indicates another cell (e.g., one of the cells corresponding to additionalPCIIndex), the UE uses the signaled SSB for preamble transmission. In one example, the signaled or determined (or selected) SSB and PCI determine the resource (e.g., PRACH Occasion) used for the preamble transmission. In one example, the signaled or determined (or selected) SSB and PCI determine the spatial filter and/or power of the preamble transmission.

In one example, the UE is signaled a SSB index in the PDCCH order. The UE determines (or selects) PCI used for the preamble transmission. In one example, the signaled SSB and the determined (or selected) PCI determine the resource (e.g., PRACH Occasion) used for the preamble transmission. In one example, the signaled SSB and the determined (or selected) PCI determine the spatial filter and/or power of the preamble transmission.

In one example, the SSB or CSI-RS used to determine the transmit power of the preamble, in the aforementioned examples, is configured or activated or indicated as a PL-RS before the transmission of the PDCCH order, as described earlier in this disclosure.

The following examples can be considered for the new PRACH configuration.
The association is based on PCI-SSB pairs, i.e., each PCI-SSB pair is associated with an RO
The association is based on SSBs, where the SSBs is a super set of SSB-indices configured across all cells as provided by ssb-PositionsInBurst. In one example, “all cells” includes serving cell and cells corresponding to additionalPCIIndex. In another example, “all cells” includes cells corresponding to additionalPCIIndex.

In one example, the SSBs for cells corresponding to the additionalPCIIndex are the configured additionalPCIIndex. There can be a maximum of 7 configured additionalPCIIndex determined by maxNrofAdditionalPCI-r17=7. In another example, the SSBs for cells corresponding to the additionalPCIIndex are cell(s) of additionalPCIIndex with active TCI states, wherein a cell is considered to have an active TCI state if the source RS of the active TCI state is associated through a quasi-co-location with an SSB of the cell. Active TCI states are the TCI states activated by MAC CE as described in TS 38.321 clause 5.18.23 and 6.1.3.47. In example, active TCI states (or TCI state codepoints or active spatial relations) can be associated with serving cell and one other cell corresponding to additionalPCIIndex. In example, active TCI states (or TCI state codepoints or active spatial relations) can be associated with serving cell and one or more other cell corresponding to additionalPCIIndex. Therefore, the following examples are considered for associated between PRACH Occasions and SSBs for the new RACH configuration
The association is based on SSBs of serving cell and SSBs of cells corresponding to the configured additionalPCIIndex.
The association is based on SSBs of serving cell and SSBs of cells with MAC CE activated TCI states corresponding to the configured additionalPCIIndex(s).
The association is based on SSBs of cells corresponding to the configured additionalPCIIndex.
The association is based on SSBs of cells with MAC CE activated TCI states corresponding to the configured additionalPCIIndex(s).

In one example, a UE is configured with a new PRACH configuration. For example, a new RACH-ConfigGeneric and/or RACH-ConfigCommon and/or RACH-ConfigCommonTwoStepRA-r16 e.g., to be used for inter-cell multi-TRP.

The UE is configured additional PCIs and SSBs associated with the additional PCIs. For example, the UE can be configured with CSI-SSB-ResourceSet that includes a list of additional PCI indices given by servingAdditionalPCIList.

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF |

```
  SSB-Index,
  ...,
  [[
    servingAdditionalPCIList-r17 SEQUENCE (SIZE(1..maxNrofCSI-SSB-ResourcePerSet))
    OF ServingAdditionalPCIIndex-r17 OPTIONAL -- Need R
  ]]
}
```

Wherein, maxNrofCSI-SSB-ResourcePerSet is 64.

And wherein, servingAdditionalPCIList indicates the physical cell IDs (PCI) of the SSBs in the csi-SSB-ResourceList. If present, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. For each entry, the following applies:
If the value is zero, the PCI is the PCI of the serving cell in which this CSI-SSB-ResourceSet is defined;
otherwise, the value is additionalPCIIndex-r17 of an SSB-MTC-AdditionalPCI-r17 in the additionalPCIList-r17 in ServingCellConfig, and the PCI is the additionalPCI-r17 in this SSB-MTC-AdditionalPCI-r17.

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, |

spare2, spare1 },

| | |
|---|---|
| ssb-PositionsInBurst-r17 | CHOICE { |
| | shortBitmap BIT STRING (SIZE (4)), |
| | mediumBitmap BIT STRING (SIZE (8)), |
| | longBitmap BIT STRING (SIZE (64)) |

},

| | |
|---|---|
| ss-PBCH-BlockPower-r17 | INTEGER (−60..50) |

}

Wherein, AdditionalPCIIndex-r17::=INTEGER(1..maxNrofAdditionalPCI-r17), and maxNrofAdditionalPCI is 7.

Wherein, ssb-PositionsInBurst indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

For association SSBs with ROs for the new PRACH configuration, the number of SSBs to be associated with ROs is given by of the following examples:
In one example, the number of SSBs to be associated with ROs is obtained from CSI-SSB-ResourceSet, based on SSB indices in the list csi-SSB-ResourceList that are associated with an additional PCI as given by servingAdditionalPCIList, (i.e., SSBs associated with the serving cell (having a value of zero in the corresponding entry in servingAdditionalPCIList) are excluded). The association order of SSBs to ROs can be based on the order of SSBs in csi-SSB-ResourceList associated with an additional PCI. In a variant of this example, only SSBs of cells with MAC CE activated TCI states are considered.

In one example, the number of SSBs to be associated with ROs is the sum of the number of SSBs configured for each AdditionalPCIIndex obtained from the corresponding ssb-PositionsInBurst. Let, N_{Tx-Total}^{SBB} be the total number of SSBs to be associated with PRACH Occasions,

$${N}_{Tx - Total}^{SSB} = {\sum }_{Configured AdditionalPCIIndex} {N}_{Tx}^{SSB} ( AdditionalPCIIndex )$$

Where,
N_{Tx}^{SSB}(AdditionalPCIIndex) can be obtained from ssb-PositionsInBurst corresponding to SSB-MTC-AdditionalPCI, for example, the number bits in the bitmap with value equal to 1. The association order of SSBs to ROs can be based on:
   First, the order of the SSBs in the corresponding ssb-PositionsInBurst bit map.
   The order of the configured AdditionalPCIIndex, for example as provided in ServingCellConfig
ServingCellConfig->mimoParam-r17->additionalPCI-ToAddModList-r17 SEQUENCE (SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example, the number of SSBs to be associated with ROs is obtained from CSI-SSB-ResourceSet, based on SSB indices in the list csi-SSB-ResourceList that are associated with the serving cell PCI, or an additional PCI as given by servingAdditionalPCIList. The association order of SSBs to ROs can be based on the order of SSBs in csi-SSB-ResourceList. In a variant of this example, only SSBs of cells with MAC CE activated TCI states are considered.

In one example, the number of SSBs to be associated with ROs is the sum of the number of SSBs configured for the serving cell, obtained from ssb-PositionsInBurst in SIB1 or in ServingCellConfigCommon, and for each AdditionalPCIIndex, obtained from the corresponding ssb-PositionsInBurst. Let, N_{Tx-Total}^{SBB} be the total number of SSBs to be associated with PRACH Occasions,

$${N}_{Tx - Total}^{SSB} = {\sum }_{Seving cell and Configured AdditionalPCIIndex} \text{} {N}_{Tx}^{SSB} \text{} ( Serving cell or AdditionalPCIIndex )$$

Where,
N_{Tx}^{SSB}(ServingCell) can be obtained from ssb-PositionsInBurst in SIB1 or in ServingCellConfigCommon.
N_{Tx}^{SSB}(AdditionalPCIIndex) can be obtained from ssb-PositionsInBurst corresponding to SSB-MTC-AdditionalPCI, for example, the number bits in the bitmap with value equal to 1. The association order of SSBs to ROs can be based on:
First, the order of the SSBs in the corresponding ssb-PositionsInBurst bit map.
Second, SSBs of serving cell followed by the order of the configured AdditionalPCIIndex, for example as provided in ServingCellConfig ServingCellConfig->mimoParam-r17->additionalPCI-ToAddModList-r17 SEQUENCE (SIZE(1..maxNrofAdditionalPCI-r17)) OF SSB-MTC-AdditionalPCI-r17 Alternatively, the order of the AdditionalPCIIndex can be in increasing (or decreasing) order of AdditionalPCIIndex. E.g., first the SSBs associated with the serving cell, the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example, each AdditionalPCIIndex has an associated ssb-PositionsInBurst as provided by SSB-MTC-AdditionalPCI, the bit maps of ssb-PositionsInBurst for the cells corresponding to AdditionalPCIIndex are ORed together, i.e., creating a super set of the union of the SSBs used in the cells corresponding to AdditionalPCIIndex. N_{Tx-Total}^{SBB} can be obtained from the resulting super set (the result of the aforementioned OR operation). The association order of SSBs to ROs can be based on the order of the SSBs in the resulting super set of SSBs. In a variant of this example, only SSBs of cells with MAC CE activated TCI states are considered.

In one example, each AdditionalPCIIndex has an associated ssb-PositionsInBurst as provided by SSB-MTC-AdditionalPCI, the bit maps of (1) ssb-PositionsInBurst for the cells corresponding to AdditionalPCIIndex, as well the bit map of (2) ssb-PositionsInBurst of the serving cell included in SIB1 or in ServingCellConfigCommon are ORed together, i.e., creating a super set of the union of the SSBs used in the cells corresponding to AdditionalPCIIndex and the serving cell. N_{Tx-Total}^{SBB} can be obtained from the resulting super set (the result of the aforementioned OR operation). The association order of SSBs to ROs can be based on the order of the SSBs in the resulting super set of SSBs. In a variant of this example, only SSBs of cells with MAC CE activated TCI states are considered.

In one example, ssb-PositionsInBurst of the serving cell included in SIB1 or in ServingCellConfigCommon are considered for N_{Tx-Total}^{SBB}. The association order of SSBs to ROs can be based on the order of the SSBs in ssb-PositionsInBurst of the serving cell. For a RACH preamble triggered by a PDCCH order, the PDCCH provides the resource (i.e., preamble index and PRACH Occasion) to use for transmitting the preamble. The PRACH occasion can be based on the SSB of the serving cell. The SSB used to determine the spatial filter and/or power of the preamble can be determined based on additional indication in the PDCCH order or the SSB used for quasi-co-location properties of DMRS of the PDCCH order.

In one example, there is no new PRACH configuration, the PRACH configuration of Rel-15 can be used for sending the PDCCH order trigger preamble transmitted to a serving cell or a cell associated with the additionalPCIIndex. For a RACH preamble triggered by a PDCCH order, the PDCCH provides the resource (i.e., preamble index and PRACH Occasion) to use for transmitting the preamble. The PRACH occasion can be based on the SSB of the serving cell. The SSB used to determine the spatial filter and/or power of the preamble can be determined based on additional indication in the PDCCH order or the SSB used for quasi-co-location properties of DMRS of the PDCCH order.

In one example, the PDCCH order includes at least (1) Random Access Preamble index which is all zeros, (2) SS/PBCH index, in one example SS/PBCH index is reserved (not used), in another example SS/PBCH index is used according to the aforementioned examples, (3) PRACH Mask index, in one example PRACH Mask index is reserved (not used), in another example SS/PBPRACH Mask index is used according to the aforementioned examples, and (4) PCIIndex or PCIFlag, which can identify the PRACH preamble and the PRACH occasion to be used for the preamble transmission.

In one example, the PCIIndex can be:
With a value of zero, then the PCI is the PCI of the serving cell in which this CSI-SSB-ResourceSet is defined. In this example, a PCI determines the PRACH Occasion for the transmission of the preamble.
With another value corresponding to the additionalPCIIndex-r17 of an SSB-MTC-AdditionalPCI-r17 in the additionalPCIList-r17 in ServingCellConfig, then the PCI is the additionalPCI-r17 in this SSB-MTC-AdditionalPCI-r17. In this example, a PCI determines the PRACH Occasion for the transmission of the preamble.
The PCIIndex is not included in the PDCCH order, in which case the determined PRACH Occasion for the transmission of the preamble is agnostic of the PCIIndex or the PCI of a cell is selected by the UE.

In another example, the PCIIndex can be:
With a value corresponding to the additionalPCIIndex-r17 of an SSB-MTC-AdditionalPCI-r17 in the additionalPCIList-r17 in ServingCellConfig, then the PCI is the additionalPCI-r17 in this SSB-MTC-AdditionalPCI-r17. In this example, a PCI determines the PRACH Occasion for the transmission of the preamble. In one example, if the PCIIndex is 0, this corresponds to the cell that triggered by the PDCCH order. In one example, if the PCIIndex is 0, this corresponds to the serving cell.
The PCIIndex is not included in the PDCCH order, in which case the determined PRACH Occasion for the transmission of the preamble is agnostic of the PCIIndex or the PCI of a cell is selected by the UE.

In one example, the PCI Flag can be:
With a value of zero, then the PCI is the PCI of the serving cell in which this CSI-SSB-ResourceSet is defined. This for example can correspond to a first TAG ID (e.g., TAG ID 0).
With a value of one, then the UE selects a PCI corresponding to the additionalPCIIndex-r17 of an SSB-MTC-AdditionalPCI-r17 in the additionalPCIList-r17 in ServingCellConfig. For example, the selection can be based on the cell with active TCI states (or TCI state codepoints or active spatial relations). In another example, the selection can be based RRC configuration and/or MAC CE signaling and/or L1 control signaling, e.g., the network can signal the UE the additionalPCIIndex corresponding to a PCI flag with value 1. This for example can correspond to a second TAG ID (e.g., TAG ID 1).

In one example, PCI Flag can be:
With a value of zero for a first RRC configured and/or MAC CE signaled and/or L1 control signaled additionalPCIIndex. This for example can correspond to a first TAG ID (e.g., TAG ID 0).
With a value of one for a second RRC configured and/or MAC CE signaled and/or L1 control signaled additionalPCIIndex. This for example can correspond to a second TAG ID (e.g., TAG ID 1).

In one example, if PCIflag is zero, or the PCIIndex is zero, the PDCCH order follows the legacy PDCCH order behavior as described in TABLE 1.

In one example, the PDCCH order has a PDCCH format as shown in TABLE 2.

In one example, the PDCCH order has a PDCCH format as shown in TABLE 3.

In one example, a new flag can be added to the PDCCH order.
If the flag is “0”, follow legacy PDCCH order behavior as described in TABLE 1.
If the flag is “1”, follow new behavior. For example:
   A PCI Index or PCI Hag is included in the PDCCH order. Preamble is transmitted towards the cell indicated by the PCI Flag or PCI Index.

Spatial filter and/or power for transmission power is based on SS/PBCH index and associated PCI.

In one example, the preamble is transmitted using a spatial filter and/or a power determined based on (1) SS/PBCH index, and (2) PCI Index included in (or indicated by) the PDCCH order. The following variants can be considered for this example:
Variant 1: the same SS/PBCH index is used to (1) determine the PRACH Occasion used to transmit the preamble and (2) determine the spatial filter and/or a power of the preamble. For example, as in TABLE 3.
Variant 2: the PDCCH order includes 2 SS/PBCH indices; (1) One is used to determine the PRACH Occasion used to transmit the preamble and (2) the other is used to determine the spatial filter and/or a power of the preamble. For example, as in TABLE 4.
Variant 3: the same PCI index is used to (1) determine the PRACH Occasion used to transmit the preamble and (2) determine the spatial filter and/or a power of the preamble.
Variant 4: the PDCCH order includes 2 PCI indices; (1) One is used to determine the PRACH Occasion used to transmit the preamble and (2) the other is used to determine the spatial filter and/or a power of the preamble.

In one example, the preamble is transmitted using a spatial filter and/or a power determined based on (1) SS/PBCH index, and (2) PCI Flag (or indicator) included in (or indicated by) the PDCCH order. The PCI Flag (or indicator) indicates whether the preamble is triggered for the serving cell, or another cell (e.g., one of the cells corresponding to additionalPCIIndex). If the flag indicates another cell (e.g., one of the cells corresponding to additionalPCIIndex), the UE determines (or selects) a PCI corresponding to additionalPCIIndex. The following variants can be considered for this example:
Variant 1: the same SS/PBCH index is used to (1) determine the PRACH Occasion used to transmit the preamble and (2) determine the spatial filter and/or a power of the preamble. For example, as in TABLE 2.
Variant 2: the PDCCH order includes 2 SS/PBCH indices; (1) One is used to determine the PRACH Occasion used to transmit the preamble and (2) the other is used to determine the spatial filter and/or a power of the preamble. For example, as in TABLE 5.
Variant 3: the same PCI Flag, with UE selection of additionalPCIIndex is used to (1) determine the PRACH Occasion used to transmit the preamble and (2) determine the spatial filter and/or a power of the preamble.
Variant 4: the PDCCH order includes PCI Flag and PCI Index; (1) PCI Index is used to determine the PRACH Occasion used to transmit the preamble and (2) PCI Flag is used to determine the spatial filter and/or a power of the preamble.

In one example, the preamble is transmitted using a spatial filter and/or a power determined based on PCI Index included in (or indicated by) the PDCCH order. The UE determines (or selects) an SS/PBCH index to be used for the preamble transmission. The following variants can be considered for this example:
Variant 1: the same PCI index is used to (1) determine the PRACH Occasion used to transmit the preamble and (2) determine the spatial filter and/or a power of the preamble.
Variant 2: the PDCCH order includes 2 PCI indices; (1) One is used to determine the PRACH Occasion used to transmit the preamble and (2) the other is used to determine the spatial filter and/or a power of the preamble.

In one example, the preamble is transmitted using a spatial filter and/or a power determined based on PCI Flag (or indicator) included in (or indicated by) the PDCCH order. The PCI Flag (or indicator) indicates whether the preamble is triggered for the serving cell, or another cell (e.g., one of the cells corresponding to additionalPCIIndex). If the flag indicates another cell (e.g., one of the cells corresponding to additionalPCIIndex), the UE determines (or selects) a PCI corresponding to additionalPCIIndex. The UE determines (or selects) an SS/PBCH index to be used for the preamble transmission. The following variants can be considered for this example:
Variant 1: the same PCI Flag, with UE selection of additionalPCIIndex is used to (1) determine the PRACH Occasion used to transmit the preamble and (2) determine the spatial filter and/or a power of the preamble.
Variant 2: the PDCCH order includes PCI Flag and PCI Index; (1) PCI Index is used to determine the PRACH Occasion used to transmit the preamble and (2) PCI Flag is used to determine the spatial filter and/or a power of the preamble.

In one example, the preamble is transmitted using a spatial filter and/or a power determined based on an SSB or a CSI-RS resource that is the source RS or that is quasi-co-located with the source RS of the PDCCH DM-RS of the PDCCH order. The SSB or the CSI-RS can be associated with the serving cell or associated with a cell corresponding to an additionalPCIIndex.

In one example, the preamble is transmitted using a spatial filter and/or a power determined based on an SSB or a CSI-RS resource. The UE determines (or selects) the SSB or CSI-RS resource such that the SSB or the CSI-RS resource is in the cell as the one of:
a source RS of the PDCCH DM-RS of the PDCCH order or
a source RS that is quasi-co-located with the source RS of the PDCCH DM-RS of the PDCCH order. The SSB or the CSI-RS can be associated with the serving cell or associated with a cell corresponding to an additionalPCIIndex.

In one example, the preamble is transmitted using a spatial filter and/or a power determined based on an SSB or a CSI-RS resource that is the source RS or that is quasi-co-located with the source RS of the PDCCH DM-RS of the PDCCH order. The SSB or the CSI-RS can be associated with a cell corresponding to an additionalPCIIndex.

In one example, the preamble is transmitted using a spatial filter and/or a power determined based on an SSB or a CSI-RS resource. The UE determines (or selects) the SSB or CSI-RS resource such that the SSB or the CSI-RS resource is in the cell as the one of:
a source RS of the PDCCH DM-RS of the PDCCH order or
a source RS that is quasi-co-located with the source RS of the PDCCH DM-RS of the PDCCH order. The SSB or the CSI-RS can be associated with a cell corresponding to an additionalPCIIndex.

In one example, the preamble is transmitted using a spatial filter and/or a power determined based on an SS/PBCH index or CSI-RS resource, wherein the SS/PBCH index or CSI-RS resource is the source RS for quasi-co-location (e.g., TypeD QCL or TypeA QCL) of a MAC CE activated TCI state, wherein, the activated MAC CE TCI state codepoint (or TCI state or TCI state ID) is included in (or indicated by) the PDCCH order. Active TCI state code points correspond to TCI states activated by MAC CE as described in TS 38.321 clause 5.18.23 and 6.1.3.47. In a variant example, an SSB index is used to determine the spatial filter and/or a power of the transmitted preamble, wherein, the SSB index is root source RS of a TCI state codepoint (or TCI state or TCI state ID) included in (or indicated by) the PDCCH order. The root source RS is a direct or indirect RS for QCL information or spatial relation information of the TCI state codepoint (or TCI state or TCI state ID). A direct RS is when the RS is the source RS of the TCI state codepoint (or TCI state or TCI state ID), an indirect RS, is when the RS provides QCL information or spatial relation information for the source RS of the TCI state codepoint (or TCI state or TCI state ID).

In one example, the preamble is transmitted using a spatial filter and/or a power determined based on an SS/PBCH index or CSI-RS resource, wherein the SS/PBCH index or CSI-RS resource is selected by the UE and belongs to (or associated with) the same cell as the source RS for quasi-co-location (e.g., TypeD QCL or TypeA QCL) of a MAC CE activated TCI state, wherein, the activated MAC CE TCI state codepoint (or TCI state or TCI state ID) is included in (or indicated by) the PDCCH order. Active TCI state code points correspond to TCI states activated by MAC CE as described in TS 38.321 clause 5.18.23 and 6.1.3.47. In a variant example, an SSB index is used to determine the spatial filter and/or a power of the transmitted preamble, wherein, the SSB index is selected by the UE and belongs to (or associated with) the same cell as the root source SSB index of a TCI state codepoint (or TCI state or TCI state ID) included in (or indicated by) the PDCCH order. The root source SSB is a direct or indirect RS for QCL information or spatial relation information of the TCI state codepoint (or TCI state or TCI state ID). A direct RS is when the RS is the source RS of the TCI state codepoint (or TCI state or TCI state ID), an indirect RS, is when the RS provides QCL information or spatial relation information for the source RS of the TCI state codepoint (or TCI state or TCI state ID).

In one example, the preamble is transmitted using a spatial filter and/or a power determined based on an SS/PBCH index or CSI-RS resource, wherein the SS/PBCH index or CSI-RS resource is the source RS for spatial relation of a MAC CE activated spatial relation, wherein, the activated MAC CE spatial relation (or spatial relation codepoint or spatial relation ID) is included in (or indicated by) the PDCCH order. In a variant example, an SSB index is used to determine the spatial filter and/or a power of the transmitted preamble, wherein, the SSB index is root source RS of a spatial relation (or spatial relation codepoint or spatial relation ID) included in (or indicated by) the PDCCH order. The root source RS is a direct or indirect RS for QCL information or spatial relation information of the spatial relation (or spatial relation codepoint or spatial relation ID). A direct RS is when the RS is the source RS of the spatial relation (or spatial relation codepoint or spatial relation ID), an indirect RS, is when the RS provides QCL information or spatial relation information for the source RS of the spatial relation (or spatial relation codepoint or spatial relation ID).

In one example, the preamble is transmitted using a spatial filter and/or a power determined based on an SS/PBCH index or CSI-RS resource, wherein the SS/PBCH index or CSI-RS resource is selected by the UE and belongs to (or associated with) the same cell as the source RS for spatial relation of a MAC CE activated spatial relation, wherein, the activated MAC CE spatial relation (or spatial relation codepoint or spatial relation ID) is included in (or indicated by) the PDCCH order. In a variant example, an SSB index is used to determine the spatial filter and/or a power of the transmitted preamble, wherein, the SSB index is selected by the UE and belongs to (or associated with) the same cell as the root source SSB index of a spatial relation (or spatial relation codepoint or spatial relation ID) included in (or indicated by) the PDCCH order. The root source SSB is a direct or indirect RS for QCL information or spatial relation information of the spatial relation (or spatial relation codepoint or spatial relation ID). A direct RS is when the RS is the source RS of the spatial relation (or spatial relation codepoint or spatial relation ID), an indirect RS, is when the RS provides QCL information or spatial relation information for the source RS of the spatial relation (or spatial relation codepoint or spatial relation ID).

In one example, the random access response for the preamble is transmitted in a PDCCH with a CRC that is scrambled by RA-RNTI.

In one example, the DMRS antenna port of the PDCCH of the RAR has the same antenna port quasi co-location properties as the DMRS of the PDCCH antenna port of the PDCCH order.

In one example, the DMRS antenna port of the PDCCH of the RAR is quasi-co-located with the SSB and CSI-RS resource used to determine the spatial filter and/or power of the preamble transmission and/or to determine the association of the preamble transmission to ROs.

In one example, the DMRS antenna port of the PDCCH of the RAR is quasi-co-located with the SSB indicated in the PDCCH order by “SS/PBCH index”.

In one example, the DMRS antenna port of the PDCCH of the RAR is quasi-co-located with the SSB indicated in the PDCCH order by “SS/PBCH index” and PCI Flag or PCI Index.

In one example, the DMRS antenna port of the PDCCH of the RAR is quasi-co-located with the SSB indicated in the PDCCH order by “SS/PBCH index2”.

In one example, the DMRS antenna port of the PDCCH of the RAR is quasi-co-located with the SSB indicated in the PDCCH order by “SS/PBCH index2” and PCI Flag or PCI Index

In one example, the DMRS antenna port of the PDCCH of the RAR is quasi-co-located with a CORESET (e.g., based on source RS of TCI state of the CORESET) associated with Type1-PDCCH Common Search Space (CSS) set.

In one example, the PDCCH of the RAR is transmitted in a Type1-PDCCH Common Search Space (CSS) set associated with the serving cell.

In one example, the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with multiple Type1-PDCCH CSS sets for the serving cell and the cells of the additionalPCIIndex.

In one example, the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with two Type1-PDCCH CSS sets a first Type1-PDCCH CSS for the serving cell and a second Type1-PDCCH CSS for any cell of the additionalPCIIndex.

In one example, the PDCCH of the RAR is transmitted in the same search space set as that of the PDCCH order.

In one example, if a PCI Flag or PCI index or TAG ID/Index in a PDCCH order is 0 or flag is added in PDCCH order to indicated new behavior and flag is set to 0, the DMRS antenna port of the PDCCH of the RAR is determined based on the existing behavior in NR Rel-15 to NR Rel-17, else follow a new behavior as described in aforementioned examples.

In one example, the DMRS antenna port of the PDSCH of the RAR has the same antenna port quasi co-location properties as the DMRS antenna port of the PDCCH of the RAR. The antenna port quasi co-location properties as the DMRS antenna port of the PDCCH of the RAR can be according to the previous examples.

In one example, the DCI Format of the PDCCH of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the MAC CE of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the Timing Advanced conveyed by the RAR or MsgB can be determined based on the PDCCH order (e.g., a PCI flag or index in the PDCCH order, or the cell the PDCCH order is transmitted in or the cell which the PDCCH order triggers the transmission of the preamble in) that triggered the PRACH preamble transmission associated with the RAR.

In one example, the Timing Advanced conveyed by the RAR or MsgB can be determined based on the SSB or CSI-RS used for the transmission of the PRACH preamble (e.g., one set of SSB or CSI-RS is associated with a first TAG ID and a second set of SSB or CSI-RS is associated with a second TAG ID).

In one example, the Timing Advanced conveyed by the RAR or MsgB can be determined based on the SSB or CSI-RS used for determining the RO of the PRACH preamble (e.g., one set of SSB or CSI-RS is associated with a first TAG ID and a second set of SSB or CSI-RS is associated with a second TAG ID).

In one example, the SSB or CSI-RS used to determine the transmit power of the preamble, as describe is configured or activated or indicated as a PL-RS before the transmission of the PDCCH order, as described earlier in this disclosure.

Although FIG. 32 illustrates one example 3200 of a PDCCH order triggered CBRA procedure, various changes may be made to FIG. 32. For example, while shown as a series of steps, various steps in FIG. 32 could overlap, occur in parallel, occur in a different order, or occur any number of times.

In one example, higher layers trigger a contention-based random access (CBRA) procedure for an inter-cell multi-TRP scenario to determine a TA.

FIG. 33 illustrates an example 3300 of a higher-layer triggered CBRA procedure according to embodiments of the present disclosure. The embodiment of a higher-layer triggered CBRA procedure of FIG. 33 is for illustration only. Different embodiments of a higher-layer triggered CBRA procedure could be used without departing from the scope of this disclosure.

In the example of FIG. 33, the following aspects are considered:
The resource for the preamble transmission, wherein the resource includes the PRACH Occasion and the preamble index.
The spatial filter and/or transmit power used to transmit the preamble.
The quasi-co-location for the random access response.

The resource used for the preamble is determined by a PRACH Occasion and a preamble index within the PRACH Occasion. For higher layer triggered CBRA procedure, the UE can randomly select a preamble from the contention based preambles associated with the selected SSB. The PRACH Occasion is determined based on an SSB or a CSI-RS resource to which the preamble is associated with, through an association pattern as described. In Rel-15 the association pattern is defined for the SSBs of the serving cell only. However, in case of inter-cell multi-TRP, there are SSBs associated with the serving cell as well as SSBs associated with cells corresponding to the additionalPCIIndex. Hence, one option is to define a new PRACH configuration to cover serving cell SSBs as well as SSBs on cells corresponding to the additionalPCIIndex.

In one example, the new PRACH configuration can be used for transmission of preambles associated with the serving cell and cells corresponding to the additionalPCIIndex.

In one example, the new PRACH configuration can be used for transmission of preambles associated with cells corresponding to the additionalPCIIndex. The PRACH configuration of NR release 15, can be used for transmission of preambles associated with the serving cell.

In one example, the new PRACH configuration can be used for transmission of preambles associated with cells corresponding to the additionalPCIIndex. A higher layer parameter (e.g., by RRC configuration and/or MAC CE configuration) can indicate whether the preambles associated with the serving cell are transmitted using (1) the new PRACH configuration or (2) the PRACH configuration of NR release 15.

In one example, a separate PRACH configuration is provided for each additionalPCIIndex. The PRACH configuration association with an additionalPCIIndex can be used for transmission of preambles associated with cells corresponding to the additionalPCIIndex. The PRACH configuration of NR release 15, can be used for transmission of preambles associated with the serving cell.

The following examples can be considered for the new PRACH configuration.
The association is based on PCI-SSB pairs, i.e., each PCI-SSB pair is associated with an RO
The association is based on SSBs of the additionalPCIIndex, wherein the SSBs are provided by ssb-PositionsInBurst of SSB-MTC-AdditionalPCI-r17.

In one example, the UE determines the PCI and/or the SSB to use for sending the contention-based random access preamble. For example, the PCI can be determined based on the activated TCI state codepoints (or TCI states or TCI state IDs) and/or the activated spatial relations. In one example, let X1 be the set of PCIs associated with the MAC CE activated TCI state codepoints e.g., as described in TS 38.321 clause 5.18.23 and 6.1.3.47, the UE selects (or determines) a PCI Y1 from set X1, the UE further selects (or determines) an SSB index Z1 associated with PCI Y1, the UE uses SSB index Z1 to determine the spatial filter and/or power of the preamble transmission. In one example, let X2 be the set of PCIs associated with the MAC CE activated spatial relation information, the UE selects (or determines) a PCI Y2 from set X2, the UE further selects (or determines) an SSB index Z2 associated with PCI Y2, the UE uses SSB index Z2 to determine the spatial filter and/or power of the preamble transmission. The UE randomly selects a preamble in a set of preambles for contention-based random access and a PRACH Occasion corresponding to Z1/Y1 or Z2/Y2.

In one example, active TCI states (or TCI state codepoints or active spatial relations) can be associated with serving cell and one other cell corresponding to additionalPCIIndex. In one example, active TCI states (or TCI state codepoints or active spatial relations) can be associated with serving cell and one or more other cell corresponding to additionalPCIIndex.

In one example, a UE is configured with a new PRACH configuration. For example, a new RACH-ConfigGeneric and/or RACH-ConfigCommon and/or RACH-ConfigCommonTwoStepRA-r16 e.g., to be used for inter-cell multi-TRP.

The UE is configured additional PCIs and SSBs associated with the additional PCIs. For example, the UE can be configured with CSI-SSB-ResourceSet that includes a list of additional PCI indices given by servingAdditionalPCIList.

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF |

```
  SSB-Index,
  ...,
  [[
    servingAdditionalPCIList-r17 SEQUENCE (SIZE(1..maxNrofCSI-SSB-ResourcePerSet))
    OF ServingAdditionalPCIIndex-r17 OPTIONAL -- Need R
  ]]
}
```

Wherein, maxNrofCSI-SSB-ResourcePerSet is 64.

And wherein, servingAdditionalPCIList indicates the physical cell IDs (PCI) of the SSBs in the csi-SSB-ResourceList. If present, the list has the same number of entries as csi-SSB-ResourceList. The first entry of the list indicates the value of the PCI for the first entry of csi-SSB-ResourceList, the second entry of this list indicates the value of the PCI for the second entry of csi-SSB-ResourceList, and so on. For each entry, the following applies:
If the value is zero, the PCI is the PCI of the serving cell in which this CSI-SSB-ResourceSet is defined;
otherwise, the value is additionalPCIIndex-r17 of an SSB-MTC-AdditionalPCI-r17 in the additionalPCIList-r17 in ServingCellConfig, and the PCI is the additionalPCI-r17 in this SSB-MTC-AdditionalPCI-r17.

| | |
|---|---|
| SSB-MTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, |

spare2, spare1 },

| | |
|---|---|
| ssb-PositionsInBurst-r17 | CHOICE { |
| | shortBitmap BIT STRING (SIZE (4)), |
| | mediumBitmap BIT STRING (SIZE (8)), |
| | longBitmap BIT STRING (SIZE (64)) |

},

| | |
|---|---|
| ss-PBCH-BlockPower-r17 | INTEGER (−60..50) |

}

Wherein, AdditionalPCIIndex-r17::=INTEGER(1..maxNrofAdditionalPCI-r17), and maxNrofAdditionalPCI is 7.

Wherein, ssb-PositionsInBurst indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted.

For association SSBs with ROs for the new PRACH configuration, the number of SSBs to be associated with ROs is given by of the following examples:
In one example, the number of SSBs to be associated with ROs is obtained from CSI-SSB-ResourceSet, based on SSB indices in the list csi-SSB-ResourceList that are associated with an additional PCI as given by servingAdditionalPCIList, (i.e., SSBs associated with the serving cell (having a value of zero in the corresponding entry in servingAdditionalPCIList) are excluded). The association order of SSBs to ROs can be based on the order of SSBs in csi-SSB-ResourceList associated with an additional PCI. In a variant of this example, only SSBs of cells with MAC CE activated TCI states are considered.

In one example, the number of SSBs to be associated with ROs is the sum of the number of SSBs configured for each AdditionalPCIIndex obtained from the corresponding ssb-PositionsInBurst. Let, NT Total be the total number of SSBs to be associated with PRACH Occasions,

$${N}_{Tx - Total}^{SSB} = {\sum }_{Configured AdditionalPCIIndex} {N}_{Tx}^{SSB} ( AdditionalPCIIndex )$$

Where,
N_{Tx}^{SSB}(AdditionalPCIIndex) can be obtained from ssb-PositionsInBurst corresponding to SSB-MTC-AdditionalPCI, for example, the number bits in the bitmap with value equal to 1. The association order of SSBs to ROs can be based on:
   First, the order of the SSBs in the corresponding ssb-PositionsInBurst bit map.
   The order of the configured AdditionalPCIIndex, for example as provided in ServingCellConfig
ServingCellConfig->mimoParam-r17->additionalPCI-ToAddModList-r17 SEQUENCE (SIZE(1..maxNrofAdditionalPCI-r17)) OF SSB-MTC-AdditionalPCI-r17

Alternatively, the order of the AdditionalPCIIndex can be in increasing (or decreasing) order of AdditionalPCIIndex. E.g., first the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example, the number of SSBs to be associated with ROs is obtained from CSI-SSB-ResourceSet, based on SSB indices in the list csi-SSB-ResourceList that are associated with the serving cell PCI, or an additional PCI as given by servingAdditionalPCIList. The association order of SSBs to ROs can be based on the order of SSBs in csi-SSB-ResourceList. In a variant of this example, only SSBs of cells with MAC CE activated TCI states are considered.

In one example, the number of SSBs to be associated with ROs is the sum of the number of SSBs configured for the serving cell, obtained from ssb-PositionsInBurst in SIB1 or in ServingCellConfigCommon, and for each AdditionalPCIIndex, obtained from the corresponding ssb-PositionsInBurst. Let, N_{Tx-Total}^{SBB} be the total number of SSBs to be associated with PRACH Occasions,

$${N}_{Tx - Total}^{SSB} = {\sum }_{Seving cell and Configured AdditionalPCIIndex} \text{} {N}_{Tx}^{SSB} \text{} ( Serving cell or AdditionalPCIIndex )$$

Where,
N_{Tx}^{SSB}(ServingCell) can be obtained from ssb-PositionsInBurst in SIB1 or in ServingCellConfigCommon.
N_{Tx}^{SSB}(AdditionalPCIIndex) can be obtained from ssb-PositionsInBurst corresponding to SSB-MTC-AdditionalPCI, for example, the number bits in the bitmap with value equal to 1. The association order of SSBs to ROs can be based on:
First, the order of the SSBs in the corresponding ssb-PositionsInBurst bit map.
Second, SSBs of serving cell followed by the order of the configured AdditionalPCIIndex, for example as provided in ServingCellConfig ServingCellConfig->mimoParam-r17->additionalPCI-ToAddModList-r17 SEQUENCE (SIZE(1..maxNrofAdditionalPCI-r17)) OF SSB-MTC-AdditionalPCI-r17 Alternatively, the order of the AdditionalPCIIndex can be in increasing (or decreasing) order of AdditionalPCIIndex. E.g., first the SSBs associated with the serving cell, then the SSBs associated with AdditionalPCIIndex 1 if configured, then the SSBs associated with AdditionalPCIIndex 2 if configured, etc. In a variant of this example, only SSBs of cells with MAC CE activated TCI states are considered.

In one example, the preamble is transmitted using a spatial filter and/or a power determined based on a PCI and a SSB index. The RO for the CBRA preamble transmission can also be determined based on the PCI and the SSB index as aforementioned. The UE randomly selects a preamble in a set of preambles for contention-based random access and a PRACH Occasion corresponding to the determined (or selected) PCI index and SSB index.

In one example, the random access response for the preamble is transmitted in a PDCCH with a CRC that is scrambled by RA-RNTI.

In one example, the PDCCH of the RAR is transmitted in a Type1-PDCCH Common Search Space (CSS) set associated with the serving cell.

In one example, the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with multiple Type1-PDCCH CSS sets for the serving cell and the cells of the additionalPCIIndex.

In one example, the PDCCH of the RAR is transmitted in a Type1-PDCCH CSS set associated with a cell, wherein the cell is that associated with the preamble transmission. The cell can be the serving cell or the cell of an additionalPCIndex. In this example, the UE can be configured with two Type1-PDCCH CSS sets a first Type1-PDCCH CSS for the serving cell and a second Type1-PDCCH CSS for any cell of the additionalPCIIndex.

In one example, the DMRS antenna port of the PDCCH of the RAR is quasi-co-located with the SSB or CSI-RS resource used to determine the spatial filter and/or power of the preamble transmission and/or to determine the association of the preamble transmission to ROs.

In one example, the DMRS antenna port of the PDCCH of the RAR is quasi-co-located with a CORESET (e.g., based on source RS of TCI state of the CORESET) associated with Type1-PDCCH CSS set.

In one example, the DMRS antenna port of the PDSCH of the RAR has the same antenna port quasi co-location properties as the DMRS antenna port of the PDCCH of the RAR. The antenna port quasi co-location properties of the DMRS antenna port of the PDCCH of the RAR can be according to the previous examples.

In one example, the DCI Format of the PDCCH of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the MAC CE of the RAR or MsgB includes a TAG ID or a TAG Flag. For example, this can be a 1-bit flag, with “0” for a first TAG ID and “1” for a second TAG ID. The TAG ID can be that of the Timing Advanced conveyed by the RAR or MsgB.

In one example, the Timing Advanced conveyed by the RAR or MsgB can be determined based on the SSB or CSI-RS used for the transmission of the PRACH preamble (e.g., one set of SSB or CSI-RS is associated with a first TAG ID and a second set of SSB or CSI-RS is associated with a second TAG ID).

In one example, the Timing Advanced conveyed by the RAR or MsgB can be determined based on the SSB or CSI-RS used for determining the RO of the PRACH preamble (e.g., one set of SSB or CSI-RS is associated with a first TAG ID and a second set of SSB or CSI-RS is associated with a second TAG ID)

In one example, the SSB or CSI-RS used to determine the transmit power of the preamble, as described in the aforementioned examples, is configured or activated or indicated as a PL-RS before the transmission of the PDCCH order, as described earlier in this disclosure.

In the following, a PRACH transmission can be one or more of the following:
A PRACH transmission for a Type1 random access procedure (e.g., 4-step RACH).
A PRACH transmission for a Type2 random access procedure (e.g., 2-step RACH).
A PRACH transmission for contention based random access (CBRA).
A PRACH transmission for contention free random access (CFRA).
A PRACH transmission triggered by a PDCCH order.
A PRACH transmission triggered by higher layers.
A UE initiated PRACH transmission.

In the above examples, when a UE is configured or provided with one (or more) TAG IDs, the UE is provided two (or more) TA offsets (N_{TA,Offset}:
A first N_{TA,Offset} for the first TAG ID. For a PRACH transmission associated with the first TAG ID, the PRACH transmission time can be determined based on a DL reference time (e.g., a first DL reference time associated with the first TAG ID), and the first N_{TA,Offset}.
A second N_{TA,Offset} for the second TAG ID. For a PRACH transmission associated with the second TAG ID, the PRACH transmission time can be determined based on a DL reference time (e.g., a second DL reference time associated with the second TAG ID), and the second N_{TA,Offset}.

In one example, if the second N_{TA,Offset} is not configured, the second N_{TA,Offset} is set to equal the first N_{TA,Offset}. In one example, if the second N_{TA,Offset} is not configured, the first N_{TA,Offset} is used for the second N_{TA,Offset}.

A first DL reference time can be determined based on (e.g., by receiving and/or measuring the time of arrival of) one or more first DL reference signal(s) (e.g., SSB(s) and/or CSI-RS resource(s)) associated with first TAG ID.

A second DL reference time can be determined based on (e.g., by receiving and/or measuring the time of arrival of) one or more second DL reference signal(s) (e.g., SSB(s) and/or CS-RS resource(s)) associated with second TAG ID.

In one example, the SS/PBCH blocks (SSBs) are grouped into two (or more) groups. The first group of SSBs is associated with a first TAG ID and the second group of SSBs is associated with a second TAG ID, if there are additional SSB groups and additional TAG IDs, the third group of SSBs is associated with a third TAG ID, . . . . The grouping of SSBs can be by RRC configuration and/or MAC CE signaling and/or L1 control signaling.

In one example, a UE is configured with a set of SSBs provided by, for example:

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) OF SSB-Index, |

```
  ...,
  [[
```

| | |
|---|---|
| servingAdditionalPCIList-r17 | SEQUENCE (SIZE(1..maxNrofCSI-SSB-ResourcePerSet)) OF |

ServingAdditionalPCIIndex-r17 OPTIONAL -- Need R
]]
}

In the following description a TAG ID for an SSB Index, determines one or more of the following:
The timing group of the SSB-Index.
N_{TA,Offset} for a PRACH transmission associated with or corresponding to the SSB-Index.

In one example, a parameter that indicates TAG ID for SSB-Index to use for PRACH transmission can be included in the CSI-SSB-ResourceSet, for example, this new parameter can be a sequence of TAG IDs with each TAG ID associated with an SSB-Index such as:
tagIDList SEQUENCE (SIZE(1..maxNrofCSI-SSB-ResourcePerSet)) OF tagID

For an SSB-Index, the UE can determine the corresponding tagID, and determine the corresponding N_{TA,Offset} to use for example for a PRACH transmission associated with the SSB index.

In one example, the tagID can be 0 or 1.

In one example, the SSB index can be that of a serving cell. In one example, the SSB index can be that of a cell with a PCI different from the PCI of the serving cell (e.g., a non-serving cell). In one example, the SSB index can be that of a serving cell or a cell with a PCI different from the PCI of the serving cell (e.g., a non-serving cell).

In one example, a UE can be configured (e.g., by RRC signaling and/or MAC CE signaling and/or L1 control signaling) an association between a PCI and a TAG ID. In one sub-example, the PCI is an additionalPCIIndex. In one sub-example, the PCI is an additionalPCIIndex or a PCI of the serving cell.

In one example, a UE can determine a TAG ID for an SSB-Index to use for PRACH transmissions based on a TCI state.

In one example, the TAG ID is determined based on the TAG ID of a TCI state used for the PDCCH order.

In one example, a flag in the PDCCH order indicates a TAG ID.

In one example, a flag in the PDCCH order indicates whether the TAG ID of the PRACH transmission, is the same as the TAG ID of a TCI state used for the PDCCH order, or is different from the TAG ID of a TCI state used for the PDCCH order.

In one example, a UE is a configured a list of TCI states, wherein the TCI states can be UL TCI states or Joint TCI states (Joint/DL TCI states). A TCI state can include a TAG ID. A TCI state can be associated with an SSB-Index. The association between the TCI state and SSB-Index can be (1) direct association, i.e., the SSB is the direct source reference signal (e.g., of QCL Type-D or UL spatial relation) of the TCI state, or (2) indirect association, e.g., the SSB is an indirect source RS, wherein the TCI state includes a source reference signal that has the SSB as its source RS. In one sub-example, a UE expects that all TCI states configured with a same SSB index through direct association or indirect association to have the same TAG ID. In one sub-example, a UE expects that all TCI states configured with an SSB index of an additionalPCIIndex, through direct association or indirect association to have the same TAG ID, i.e., a TCI states of a same additionalPCIIndex have the same TAG ID. In further example, a UE can determine a TAG ID to use for an SSB index, or for an additionalPCIIndex, for PRACH transmission based on the TAG ID associated with the corresponding configured TCI states.

In one sub-example, a UE can determine TAG ID associated with an SSB-Index for PRACH transmission based on the TAG ID of the configured TCI state with the smallest index that is associated directly or indirectly with the SSB-Index, wherein the association is as aforementioned. In one sub-example, a UE can determine TAG ID associated with an SSB-Index for PRACH transmission based on the TAG ID of the configured TCI state with the smallest index that is associated directly or indirectly with the an additionalPCIIndex, e.g., the SSB-Index belongs to the additionalPCIIndex, wherein the association is as aforementioned. When determining the smallest index of TCI state associated directly or indirectly with the SSB-Index or the additionalPICIIndex, the following examples can be considered:
First consider UL TCI states, if configured, then Joint TCI states if configured.
First consider Joint TCI states if configured, then the UL TCI states if configured.
If joint beam indication is configured, Joint TCI states are used to find smallest index, else (separate beam indication) UL TCI states are used to find smallest index.
Consider smallest index among both lists (UL TCI states and Joint TCI states), if two TCI states with the same smallest index are found one from each list, consider UL TCI state.
Consider smallest index among both lists (UL TCI states and Joint TCI states), if two TCI states with the same smallest index are found one from each list, consider Joint TCI state.

In one example, a UE is activated a list of TCI states, wherein the TCI states codepoints of UL, DL or Joint TCI state. A TCI state (UL or Joint) can include a TAG ID. A TCI state can be associated with an SSB-Index. The association between the TCI state and SSB-Index can be (1) direct association, i.e., the SSB is the direct source reference signal (e.g., of QCL Type-D or UL spatial relation) of the TCI state, or (2) indirect association, e.g., the SSB is an indirect source RS, wherein the TCI state includes a source reference signal that has the SSB as its source RS. In one sub-example, a UE expects that all TCI states activated with a same SSB index through direct association or indirect association to have the same TAG ID. In one sub-example, a UE expects that all TCI states activated with an SSB index of an additionalPCIIndex, through direct association or indirect association to have the same TAG ID, i.e., a TCI states of a same additionalPCIIndex have the same TAG ID. In further example, a UE can determine a TAG ID to use for an SSB index, or for an additionalPCIIndex, for PRACH transmission based on the TAG ID associated with the corresponding activated TCI states.

In one sub-example, a UE can determine TAG associated with an SSB-Index based on the TAG ID of the activated TCI state codepoint with the smallest index that is associated directly or indirectly with the SSB-Index, wherein the association is as aforementioned. In one sub-example, a UE can determine TAG associated with an SSB-Index based on the TAG ID of the activated TCI state codepoint with the smallest index that is associated directly or indirectly with the an additionalPCIIndex, and the SSB-Index belongs to the additionalPCIIndex, wherein the association is as aforementioned.

In one example, the UE is activated a list of TCI states for a first CORESETPOOLIndex and a list of TCI states for a second CORESETPOOLIndex. The UE can expect, or can be configured to expect, or can indicate that it expects (e.g., based on a UE capability), to have the same TAG ID for the TCI state of a CORESETPOOLIndex. The UE can determine the TAG ID for an SSB Index based on the TAG ID of the TCI state or the CORESETPOOLIndex of the activated TCI state, wherein the SSB Index is associated directly or indirectly with the TCI state.

In one example, a PRACH transmission is associated with an SSB index. The association can be based on one or more of:
SSB determines the PRACH transmission power.
SSB determines the PRACH spatial relation (or spatial domain transmission filter).
SSB determines the PRACH occasion and/or PRACH preamble.

In one example, the PRACH transmission time is determined based on a DL reference time associated with a TAG ID associated with (1) the SSB group of the SSB index or (2) the SSB index.

In one example, the PRACH transmission time is determined based on the TA offset, N_{TA,Offset}, associated with TAG ID associated with (1) the SSB group of the SSB index or (2) the SSB index.

In one example, a PRACH transmission is associated with CSI-RS index, and the CSI-RS can be associated with an SSB index, e.g., through a quasi-co-location. The association between the PRACH transmission and the CSI-RS can be based on one or more of:
CSI-RS resources and/or the SSB determines the PRACH transmission power.
CSI-RS resource and/or the SSB determines the PRACH spatial relation (or spatial domain transmission filter).
CSI-RS resource and/or SSB determines the PRACH occasion and/or PRACH preamble.

In one example, the PRACH transmission time is determined based on a DL reference time associated with a TAG ID associated with (1) the SSB group of the SSB index or (2) the SSB index or (3) the CSI-RS resource index.

In one example, the PRACH transmission time is determined based on the TA offset, N_{TA,Offset}, associated with TAG ID associated with (1) the SSB group of the SSB index or (2) the SSB index or (3) the CSI-RS resource index.

In one example, the CSI-RS resources are grouped into two (or more) groups. The first group of CSI-RS resources is associated with a first TAG ID and the second group of CSI-RS resources is associated with a second TAG ID, if there are additional CSI-RS resource groups and additional TAG IDs, the third group of CSI-RS resources is associated with a third TAG ID, . . . . The grouping of CSI-RS resources can be by RRC configuration and/or MAC CE signaling and/or L1 control signaling.

In one example, a PRACH transmission is associated with CSI-RS resource index. The association can be based on one or more of:
CSI-RS resource determines the PRACH transmission power.
CSI-RS resource determines the PRACH spatial relation (or spatial domain transmission filter).
CSI-RS resource determines the PRACH occasion and/or PRACH preamble.

In one example, the PRACH transmission time is determined based on a DL reference time associated with a TAG ID associated with (1) the CSI-RS resource group of the CSI-RS resource index or (2) the CSI-RS resource index.

In one example, the PRACH transmission time is determined based on the TA offset, N_{TA,Offset}, associated with TAG ID associated with (1) the CSI-RS resource group of the CSI-RS resource index or (2) the CSI-RS resource index.

In one example, the SS/PBCH blocks (SSBs) and/or CSI-RS resources are grouped into two (or more) groups. The first group of SSBs and/or CSI-RS resources is associated with a first TAG ID and the second group of SSBs and/or CSI-RS resources is associated with a second TAG ID, if there are additional SSB and/or CSI-RS resource groups and additional TAG IDs, the third group of SSBs and/or CSI-RS resources is associated with a third TAG ID, . . . . The grouping of SSBs and/or CSI-RS resources can be by RRC configuration and/or MAC CE signaling and/or L1 control signaling.

In one example, a PRACH transmission is associated with an SSB and/or CSI-RS resource index. The association can be based on one or more of:
SSB and/or CSI-RS resource determines the PRACH transmission power.
SSB and/or CSI-RS resource determines the PRACH spatial relation (or spatial domain transmission filter).
SSB and/or CSI-RS resource determines the PRACH occasion and/or PRACH preamble.

In one example, the PRACH transmission time is determined based on a DL reference time associated with a TAG ID associated with (1) the SSB group and/or CSI-RS resource of the SSB and/or CSI-RS resource index or (2) SSB and/or CSI-RS resource index.

In one example, the PRACH transmission time is determined based on the TA offset, N_{TA,Offset}, associated with TAG ID associated with the SSB and/or CSI-RS resource group of the SSB and/or CSI-RS resource index or (2) SSB and/or CSI-RS resource index.

Although FIG. 33 illustrates one example 3300 of a higher-layer triggered CBRA procedure, various changes may be made to FIG. 33. For example, while shown as a series of steps, various steps in FIG. 33 could overlap, occur in parallel, occur in a different order, or occur any number of times.

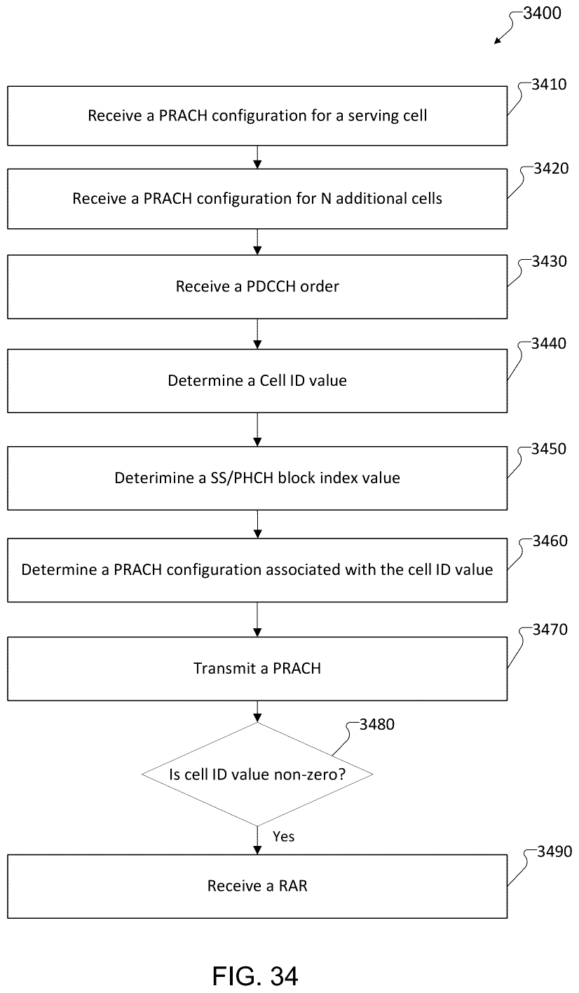

FIG. 34 illustrates a method 3400 for random access procedures based on PDCCH order according to embodiments of the present disclosure. An embodiment of the method illustrated in FIG. 34 is for illustration only. One or more of the components illustrated in FIG. 34 may be implemented in specialized circuitry configured to perform the noted functions or one or more of the components may be implemented by one or more processors executing instructions to perform the noted functions. Other embodiments of L1 triggered TA measurement could be used without departing from the scope of this disclosure.

As illustrated in FIG. 34, the method 3400 begins at step 3410. At step 3410, a UE receives a physical random access channel (PRACH) configuration for a serving cell. At step 3420, the UE receives a PRACH configuration for N additional cells. At step 3430 the UE receives physical downlink control channel (PDCCH) order. The PDCCH order includes a cell identifier (ID) field, and a synchronization signal/physical broadcast channel (SS/PBCH) block index field. At step 3440, UE determines a cell ID value of the cell ID field in the PDCCH order. The SS/PBCH block index value corresponds to the cell ID value. At step 3450, the UE determines a SS/PBCH block index value of the SS/PBCH block index field in the PDCCH order. At step 3460, the UE determines a PRACH configuration associated with the cell ID value. At step 3470, the UE transmits a PRACH in a PRACH occasion (RO) associated with the SS/PBCH block index value and the corresponding cell ID value. At step 3480, if the cell ID value is a non-zero value, the method proceeds to step 3490. Finally, at step 3490, the UE determines a PRACH transmission power based on the pathloss calculated using a SS/PBCH block corresponding to the SS/PBCH block index value and the corresponding cell ID value.

Although FIG. 34 illustrates one example of a method 3400 of random access procedures based on PDCCH order, various changes may be made to FIG. 34. For example, while shown as a series of steps, various steps in FIG. 34 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE), comprising:
a transceiver configured to:
receive a physical random access channel (PRACH) configuration for a serving cell;
receive a PRACH configuration for N additional cells; and
receive a physical downlink control channel (PDCCH) order, wherein the PDCCH order includes a field for a cell identifier (ID), and a field for a synchronization signal/physical broadcast channel (SS/PBCH) block index corresponding to the cell ID, and
a processor operably coupled to the transceiver, the processor configured to:
determine a value of the cell ID field in the PDCCH order, and
determine a PRACH configuration associated with the cell ID,
wherein the transceiver is further configured to:
transmit a PRACH in a PRACH occasion (RO) associated with the SS/PBCH block index and the cell ID,
wherein, if the value of the cell ID field is non-zero, the processor is further configured to determine a PRACH transmission power based on a SS/PBCH block associated with the SS/PBCH block index and the corresponding cell ID included in the PDCCH order.

2. The UE of claim 1, wherein a size of the cell ID field is given by [log₂(N+1)] bits.

3. The UE of claim 1, wherein a size of the cell ID field is 3 bits.

4. The UE of claim 1, wherein, if the PDCCH order is associated with a serving cell, the transceiver is further configured to:
receive a PDCCH of a random access response (RAR) using quasi-colocation (QCL) properties of the PDCCH order, and
receive a physical downlink shared channel (PDSCH) of the RAR using the QCL properties of the PDCCH of the RAR.

5. The UE of claim 1, wherein, if the PDCCH order is associated with a cell having a physical cell identity (PCI) different from a PCI of the serving cell, the transceiver is further configured to:
receive a PDCCH of a random access response (RAR) in a Type1-PDCCH control search space (CSS) set using quasi-colocation (QCL) properties of a CORESET associated with the Type1-PDCCH CSS set, and
receive a physical downlink shared channel (PDSCH) of the RAR using the QCL properties of the PDCCH of the RAR.

6. The UE of claim 4, wherein:
a medium access control channel element (MAC CE) of the RAR comprises a 1-bit flag associated with a TAG ID,
a flag value of zero indicates a first TAG ID, and
a flag value of one indicates a second TAG ID.

7. The UE of claim 1, wherein the cell ID identifies a cell associated with activated transmission configuration indicator (TCI) states.

8. A base station (BS), comprising:
a transceiver configured to:
transmit a physical random access channel (PRACH) configuration for a serving cell;
transmit a PRACH configuration for N additional cells; and
transmit a physical downlink control channel (PDCCH) order, wherein the PDCCH order includes a field for a cell identifier (ID), and a field for a synchronization signal/physical broadcast channel (SS/PBCH) block index corresponding to the cell ID, and
a processor operably coupled to the transceiver, the processor configured to:
determine a value of the cell ID field in the PDCCH order, and
determine a PRACH configuration associated with the cell ID,
wherein the transceiver is further configured to:
receive a PRACH in a PRACH occasion (RO) associated with a SS/PBCH index and the corresponding cell ID, and
wherein if the value of the cell ID field is non-zero, a PRACH transmission power is based on a SS/PBCH block associated with the SS/PBCH block index and the corresponding cell ID included in the PDCCH order.

9. The BS of claim 8, wherein a size of the cell ID field is given by ┌log₂(N+1)┐ bits.

10. The BS of claim 8, wherein a size of the cell ID field is 3 bits.

11. The BS of claim 8, wherein, if the PDCCH order is associated with the serving cell, the transceiver is further configured to:
transmit a PDCCH of a random access response (RAR) using quasi-colocation (QCL) properties of the PDCCH order, and
transmit a physical downlink shared channel (PDSCH) of the RAR using the QCL properties of the PDCCH of the RAR.

12. The BS of claim 8, wherein, if the PDCCH order is associated with a cell having a physical cell identity (PCI) different from a PCI of the serving cell, the transceiver is further configured to:
transmit a PDCCH of a random access response (RAR) in a Type1-PDCCH control search space (CSS) set using quasi-colocation (QCL) properties of a CORESET associated with the Type1-PDCCH CSS set, and
transmit a physical downlink shared channel (PDSCH) of the RAR using the QCL properties of the PDCCH of the RAR.

13. The BS of claim 11, wherein:
a medium access control channel element (MAC CE) of the RAR includes a 1-bit flag associated with a TAG ID,
a flag value of zero indicates a first TAG ID, and
a flag value of one indicates a second TAG ID.

14. The BS of claim 8, wherein the cell ID identifies a cell associated with activated transmission configuration indicator (TCI) states.

15. A method of operating a user equipment (UE), the method comprising:
receiving a physical random access channel (PRACH) configuration for a serving cell;
receiving a PRACH configuration for N additional cells;
receiving a physical downlink control channel (PDCCH) order, wherein the PDCCH order includes a field for a cell identifier (ID), and a field for a synchronization signal/physical broadcast channel (SS/PBCH) block index corresponding to the cell ID;
determining a value of the cell ID field in the PDCCH order;
determining a PRACH configuration associated with the cell ID; and
transmitting a PRACH in a PRACH occasion (RO) associated with the SS/PBCH block index and the corresponding cell ID,
wherein based on the value of the cell ID field being non-zero, the method further comprises:
determining a PRACH transmission power based on a SS/PBCH block associated with the SS/PBCH block index and the corresponding cell ID included in the PDCCH order.

16. The method of claim 15, wherein a size of the cell ID field is given by ┌log₂(N+1)┐ bits.

17. The method of claim 15, wherein based on the PDCCH order being associated with the serving cell, the method further comprises:
receiving a PDCCH of a random access response (RAR) using quasi-colocation (QCL) properties of the PDCCH order, and
receiving a physical downlink shared channel (PDSCH) of the RAR using QCL properties of the PDCCH of the RAR.

18. The method of claim 15, further comprising:
based on the PDCCH order being associated with a cell having a physical cell identity (PCI) different from a PCI of the serving cell,
receiving a PDCCH of a random access response (RAR) in a Type1-PDCCH control search space (CSS) set using quasi-colocation (QCL) properties of a CORESET associated with the Type1-PDCCH CSS set, and
receiving a physical downlink shared channel (PDSCH) of the RAR using the QCL properties of the PDCCH of the RAR.

19. The method of claim 17, wherein:
a medium access control channel element (MAC CE) of the RAR comprises a 1-bit flag associated with a TAG ID,
a flag value of zero indicates a first TAG ID, and
a flag value of one indicate a second TAG ID.

20. The method of claim 15, wherein the cell ID identifies a cell associated with activated transmission configuration indicator (TCI) states.
